(19) United States
(12) Patent Application Publication
(10) Pub. No.: US 2021/0298310 A1
(43) Pub. Date: Sep. 30, 2021

(54) MICROBIAL COMPOSITIONS AND METHODS OF MAKING AND USING THE SAME

(71) Applicant: MOgene Green Chemicals LLC, St. Louis, MO (US)

(72) Inventors: Abhay K. Singh, Chesterfield, MO (US); Himadri B. Pakrasi, St. Louis, MO (US); Ganesh M. Kishore, Creve Coeur, MO (US)

(21) Appl. No.: 17/194,045

(22) Filed: Mar. 5, 2021

Related U.S. Application Data
(60) Provisional application No. 62/986,497, filed on Mar. 6, 2020.
(60) Provisional application No. 63/069,496, filed on Aug. 24, 2020.
(60) Provisional application No. 63/069,540, filed on Aug. 24, 2020.

(51) Int. Cl. A01N 63/20; A01N 63/30; C05F 11/08; C05G 3/90; C05G 3/60

(52) U.S. Cl. CPC A01N 63/20; A01N 63/30; C05G 3/60; C05G 3/90; C05F 11/08

(57) ABSTRACT

Provided herein are microbial compositions that include: one or more photosynthetic microorganism(s); and one or more agricultural adjuvant(s); wherein the microbial composition has one or more of any of the following activities: produces one or more carbon species; produces one or more nitrogen species; produces one or more molecule(s) containing carbon and nitrogen; increases soil organic matter; improves soil water-holding capacity; demonstrates growth in different soil types with or without vegetation; protects vegetation against plant pathogens; protects vegetation against pests; promotes growth of vegetation; produces molecules having one or more of insecticidal, herbicidal, anti-fungal, weed controlling, and seed germination activity; promotes root growth of vegetation; and inhibits denitrification.

### CROSS-REFERENCE TO RELATED APPLICATIONS

This application claims priority to U.S. Provisional Patent Application No. 62/986,497, filed Mar. 6, 2020, U.S. Provisional Patent Application No. 63/069,496, filed Aug. 24, 2020, and U.S. Provisional Patent Application No. 63/069,540, filed Aug. 24, 2020. The contents of each of these applications are incorporated herein by reference in their entireties.

### TECHNICAL FIELD

This disclosure generally relates to biotechnology methods for forming microbial compositions and methods of using the same for the diverse land ecosystems including crop land, grazing land, forestry, recreational land, horticultural land, and land reclamation.

### BACKGROUND

Soil provides many direct and indirect ecosystem services to society including food, feed, fuel, water quality, and climate mitigation. The expansion of intensive agriculture has helped meet the increasing global grains demand for food, feed, and fuel. However, the continual exercise of such practices which involve tillage practices, removal of residual crops, and the extensive use of synthetic fertilizers and herbicides has led to a number of economic and environmental problems including loss of organic matter (OM) and nutrients, soil erosion, loss of soil fertility, contamination of water bodies, increased greenhouse gas emission, reduced capacity of soil to store carbon, and damage to soil health. The poor health of soil makes agriculture increasingly dependent on synthetic fertilizers for the key nutrients to maintain the high crop yield and profitability. Ultimately, such continued practices will impact the ability of agriculture to meet the increasing global grain requirements, as well as various ecosystem services provided by soil and agriculture. It has also been suggested that some crops may have reached their physical limits to yield productivity, and therefore, the increasing use of synthetic fertilizers would further exacerbate the environmental problems including land degradation caused by the intensive agriculture practices.

To meet the emerging challenges, various stakeholders (such as policy-makers, farmers, land managers, etc.) are increasingly advocating the incorporation of sustainable agriculture practices. Adoption of such practices will ensure a future food supply to the growing global population, reduce the overall cost of farming, and importantly, will have a minimal impact on the environment through the reduced use of synthetic fertilizers and increased capacity of soil to capture and store carbon. A central theme around sustainable agriculture is the soil OM which provides a habitat and food source for the soil microbes, stabilizes soil by forming aggregates, improves aeration and water holding capacity, and requires less fertilizer. It has been suggested that an optimal OM amount in soil can meet more than half of the nitrogen and one-fourth of the phosphorus needs of crops. Further, loss of OM has been linked to the declining grain yields and soil degradation leading to food insecurity as well as environmental concerns due to over-application of synthetic fertilizers and pesticides. It is estimated that the United States agricultural soil has lost 50% of OM since the time developed from grass prairies or forestland. Further, the Food and Agricultural Organization estimates that >6 million hectares of the global agricultural land is irreversibly degraded every year. It is also estimated that about 11% of Earth's vegetative state is damaged, which can be expensive to fix. Severely depleted soil in Asia and Australia has already become a major issue not only for feeding the population but also because of its negative impact on environment due to the reduced capacity to capture and store carbon.

Crop rotation, cover crops, no-tillage or strip-tillage, biochar, and/or the targeted use of manure and/or compost are the currently available practices to improve OM in soil. These methods either increase input of OM in soil or slow down decomposition of OM. Despite demonstrated successes of these practices at small scale, they have not been widely adopted by farmers because there is no one-size-fits-all solution to improve OM. Further, the usefulness in the restoration of degraded soil is unknown.

Improving OM by the application of agriculturally-derived materials such as mulches, compost, organic, and green manure is at best minimally effective because they are rapidly mineralized by the soil microbes leading to the loss of the majority of applied carbon as C02. Also, these amendments need to be applied more frequently and in higher amount to observe any measurable effect on OM build-up in agricultural soil which makes its large-scale application tedious and costly. Further, there is a significant variability of nutrients depending on the source of these materials differently affecting soil's biological and chemical properties. Similarly, the initial investment in machinery as well as the high operational cost (for seeds and herbicide especially for overwinter crops) can require dedicated commitment to utilize no-till and cover crop practices on a routine basis. It can take multiple years of continual practices of the currently available methods to see any measurable change in soil OM.

In addition to improving soil health for the purpose of agriculture (both cropping and grazing), there are other land types that have significant potential as a cost-effective system to capture and sequester carbon towards the goal of mitigating climate change. Such land types include forestry, agroforestry, horticulture, wet land and organic soil, and turfgrass as well as reclamation of low-quality land ecosystems. In addition, the presence of organic carbon (and therefore, organic matter) positively impacts the chemical, physical, and biological attributes of soil leading to improved health and quality of soil. Although many existing methods are available towards improving health and quality of agricultural land, such methods have very limited useability in non-agricultural land ecosystems.

Amount of OM in soil is determined primarily by the interactions of two competing processes: photosynthesis and respiration. Crops through photosynthesis deposit roots, plant residues, and exudates in soil, which in turn are decomposed by microbial respiration to recycle nutrients and build OM. In this process, a significant amount of carbon (60-80%) present in the plant residues and exudates is released back to the environment as CO₂. In addition to crops, cyanobacterium, a prokaryotic photosynthetic microorganism, also carries out oxygenic photosynthesis. Further, some cyanobacterial species can also fix nitrogen, which is considered as the second most important process influencing primary productivity after photosynthesis. Cyanobacteria also secrete large amounts of exopolysaccharides (EPS) which have very high-water holding capacity and help form soil aggregates. These unique features (carbon and nitrogen fixation, water-holding capacity, rapid biomass production, mineralization of nutrients, and tolerance to extreme conditions) make them an effective microbial-based system towards the goal of improving the soil health.

### SUMMARY

The present invention is based on the discovery of microbial compositions that provide for elevated level of easily usable forms of carbon species and/or nitrogen species in soil as compared to level(s) in a control soil not contacted with the microbial composition. Based on this discovery, provided herein are microbial compositions that have of one or more (e.g., one, two, three, four, five, six, seven, eight, nine, ten, eleven, or twelve) of the following activities: produces one or more carbon species; produces one or more nitrogen species; produces one or more molecule(s) containing carbon and nitrogen; increases soil organic matter; improves soil water-holding capacity; demonstrates growth in different soil types with or without vegetation; protects vegetation against plant pathogens; protects vegetation against pests; promotes growth of vegetation; produces molecules having one or more of insecticidal, herbicidal, anti-fungal, weed controlling, and seed germination activity; promotes root growth of vegetation; and inhibits denitrification.

In one aspect, this disclosure features methods of selective enrichment, isolation, and characterization of photosynthetic and non-photosynthetic microorganism(s) from soil for the specific purpose of improving the health of soil and crops as well as for the purpose for carbon capture and sequestration in diverse land ecosystems, the method including: (a) providing a sample including uncharacterized and/or uncultivated photosynthetic and non-photosynthetic microorganism(s), where the sample is obtained from an environmental source; (b) subjecting the soil sample to grow at a controlled temperature with or without light; (c) enriching or isolating photosynthetic and non-photosynthetic microorganism(s) having one or more of following activities: produces one or more carbon species; produces one or more nitrogen species; produces one or more molecule(s) containing carbon and nitrogen; increases soil organic matter; improves soil water-holding capacity; demonstrates growth in different soil types with or without vegetation; protects vegetation against plant pathogens; protects vegetation against pests; promotes growth of vegetation; produces molecules having one or more of insecticidal, herbicidal, anti-fungal, weed controlling, and seed germination activity; promotes root growth of vegetation; and inhibits denitrification; and (d) subjecting the photosynthetic and non-photosynthetic microorganism(s) to 16S and 18S ribosomal RNA sequencing to identify the species of enriched microorganism(s). In some embodiments, inhibition of denitrification occurs via production of oxygen by the photosynthetic microorganism(s). In some embodiments, inhibition of denitrification occurs by release of molecules that inhibit denitrification. In some embodiments, the environmental source is selected from the group consisting of: including but not limited to agricultural land (both cropping and grazing), farm land, forest land, recreational land, degraded land, vegetable land, landfill, mountains, fresh water, and marine water. In some embodiments, step (b) (e.g., the step subjecting the soil sample to grow at a controlled temperature with or without light) is performed by providing one or more micronutrients to the soil which are selected by chemical analysis of a soil. In some embodiments, the method further includes identifying heterotrophic microorganisms that have mutual beneficial relationship with the photosynthetic microorganism(s). In some embodiments, the photosynthetic and non-photosynthetic microorganism(s) are subjected to 16S and 18S ribosomal RNA sequencing to identify the species of enriched microorganism(s).

In another aspect, this document features microbial compositions that include: (a) one or more photosynthetic microorganism(s); and (b) one or more agricultural adjuvant(s); where the microbial composition has one or more of any of the following activities: produces one or more carbon species; produces one or more nitrogen species; produces one or more molecule(s) containing carbon and nitrogen; increases soil organic matter; improves soil water-holding capacity; demonstrates growth in different soil types with or without vegetation; protects vegetation against plant pathogens; protects vegetation against pests; promotes growth of vegetation; produces molecules having one or more of insecticidal, herbicidal, anti-fungal, weed controlling, and seed germination activity; promotes root growth of vegetation; and inhibits denitrification.

In some embodiments of any of the microbial compositions described herein, inhibition of denitrification occurs via production of oxygen by the photosynthetic microorganism(s). In some embodiments, the microbial composition produces chemicals leading to the inhibit denitrification. In some embodiments, the microbial composition reduces emission of methane and/or nitrogen oxides.

In some embodiments of any of the microbial compositions described herein, the one or more photosynthetic microorganism(s) includes a cyanobacterium. In some embodiments, the cyanobacterium is a non-nitrogen fixing cyanobacterium. In some embodiments, the cyanobacterium is a nitrogen-fixing cyanobacterium. In some embodiments, the cyanobacterium is selected from the group consisting of: Nostoc sp., Microcoleus sp., Phormidium sp., Anabaena sp., Cyanothece sp., Leptolyngbya sp., Porphyrosiphon sp., Scytonema sp., Symploca sp., and Schizothrix sp. In some embodiments, the cyanobacterium is selected from the group consisting of Nostoc commune, Nostoc longstaffi, Nostoc calcicola, Nostoc muscorum, Anabaena verrucosa, and Anabaena 33047.

In some embodiments of any of the microbial compositions described herein, the one or more photosynthetic microorganism(s) includes a non-cyanobacterium photosynthetic microorganism. In some embodiments, the non-cyanobacterium photosynthetic microorganism does not have nitrogen-fixing activity. In some embodiments, the non-cyanobacterium photosynthetic microorganism is a nitrogen-fixing bacterium. In some embodiments, the non-cyanobacterium is selected from the group consisting of: Rhodospirillaceae sp., Chromatiaceae sp., Chlorobiaceae sp., Chloroflexaceae sp., and Heliobacteriaceae sp.

In some embodiments of any of the microbial compositions described herein, the one or more photosynthetic microorganism(s) include a eukaryotic microorganism. In some embodiments, the eukaryotic microorganism is selected from the group consisting of: Chlamydomonas sp., Dunaliella sp., Scenedesmus sp., Chlorella sp., Prototheca sp., and Botryococcus sp.

In some embodiments of any of the microbial compositions described herein, the one or more photosynthetic microorganisms are selected from the group consisting of: Synechocystis sp., Synechococcus sp., Prochlorococcus sp., Anabaena catenula sp., Anabaena minutissima sp., Anabaena subcylindrica sp., Nostoc parmeloides sp., Nodularia spumigena sp., Desertella californica sp., Microcoleus vaginatus sp., and Thermosynechococcus sp.

In some embodiments of any of the microbial compositions described herein, the microbial composition produces one or both carbon species of the group consisting of sugars, fatty acids, and organic acids.

In some embodiments of any of the microbial compositions described herein, the microbial composition produces one or more nitrogen species from the group consisting of nitrate, urea, ammonia, ammonium, and amine(s).

In some embodiments of any of the microbial compositions described herein, the microbial composition produces one or more molecules containing carbon and nitrogen form the group consisting of amino acids, amino sugars, nucleobases, and sesquiterpene lactones. In some embodiments, the produced nucleobases and/or their nucleoside include one or more nucleobases from the group consisting of cytosine, thymine, adenine, guanine, xanthine, and hypoxanthine.

In some embodiments, the produced amino acids include one or more aspartate family amino acids from the group consisting of aspartic acid, asparagine, methionine, and threonine.

In some embodiments, the produced amino acids include one or more branch chain amino acids from the group consisting of isoleucine, leucine, and valine.

In some embodiments of any of the microbial compositions described herein, the microbial composition further includes one or more heterotrophic microorganism(s). In some embodiments, the one or more heterotrophic microorganism(s) further include one or more nitrogen-fixing heterotrophic microorganism(s). In some embodiments, the one or more heterotrophic microorganism(s) solubilize one or more of potassium, iron, and phosphorous when the microbial composition is exposed to conditions sufficient to solubilize one or more of potassium, iron, and phosphorous. In some embodiments, the one or more heterotrophic microorganism(s) store phosphorous in the form of polyphosphate.

In some embodiments of any of the microbial compositions described herein, the one or more photosynthetic microorganism(s) or the one or more heterotrophic microorganism(s) produce and secrete an exopolysaccharide; and the exopolysaccharide improves water-holding capacity of soil. In some embodiments, the one or more photosynthetic microorganism(s) or the one or more heterotrophic microorganism(s) produce a peptide or a chemical, and the peptide or chemical improves water-holding capacity of soil. In some embodiments, the microbial composition forms soil microaggregates, where the soil microaggregates improve the water-holding capacity of soil. In some embodiments of any of the microbial compositions described herein, the microbial composition produces organic matter.

In some embodiments of any of the microbial compositions described herein, the microbial composition demonstrates growth in different soil types with or without vegetation.

In some embodiments of any of the microbial compositions described herein, the microbial composition protects vegetation against one or more plant pathogen(s) selected from the group consisting of: fungi, fungal-like organisms, bacteria, phytoplasmas, viruses, viroids, and nematodes.

In some embodiments of any of the microbial compositions described herein, the microbial composition protects against one or more pests selected from the group consisting of: wireworm, bean nodule fly, grub worms, cutworms, lesser corn stalk borer, Dectes stem borer, Kudzu bug, aphid, corn earworm, stink bug complex, grasshopper, bean leaf beetle, soybean looper, green clover worm, velvet bean caterpillar, fall army worm, Japanese beetle, cutworms, Thrips, corn rootworm, Chinch bug, and white grub.

In some embodiments of any of the microbial compositions described herein, the microbial composition promotes growth of vegetation by the production of factors including phytohormones and plant growth-promoting factors.

In some embodiments of any of the microbial compositions described herein, the microbial composition produces one or more molecules having one or more of insecticidal, herbicidal, anti-fungal, weed controlling, and seed germination activity.

In some embodiments of any of the microbial compositions described herein, the microbial composition promotes root growth of vegetation through modification of rhizosphere and promoting oxygenic environment around root(s).

In some embodiments of any of the microbial compositions described herein, the microbial composition inhibits denitrification.

In some embodiments of any of the microbial compositions described herein, the one or more photosynthetic microorganism(s) and/or the one or more heterotrophic microorganism(s) are tolerant to biotic/abiotic conditions.

In some embodiments of any of the microbial compositions described herein, the one or more photosynthetic microorganism(s) and/or the one or more heterotrophic microorganism(s) are tolerant to one or more of minerals, an herbicide, and an insecticide.

In some embodiments of any of the microbial compositions described herein, the one or more photosynthetic microorganisms and/or the one or more heterotrophic microorganism(s) have previously been exposed to a chemical mutagen.

In some embodiments of any of the microbial compositions described herein, the one or more photosynthetic microorganisms and/or the one or more heterotrophic microorganism(s) have previously been exposed to a chemical mutagen and/or undergone adaptive laboratory evolution (ALE) to improve the overall performance of microbial composition on different soil types and under varying environmental conditions. In some embodiments, the chemical mutagen is selected from the group consisting of: ethyl methanesulfonate, methyl methanesulfonate, and ethyl nitrosourea. In some embodiments, the one or more photosynthetic microorganisms secrete nucleobases, nucleobase derivatives, or both when exposed to analogs selected from the group consisting of 8-azaguanine, 6-azauracil, 2-diazo-5-oxo-L-norleucine, decoyinine, and 6-mercaptoguanine.

In some embodiments of any of the microbial compositions described herein, the one or more photosynthetic microorganisms secrete aspartate amino acids, branched-chain amino acids or both when exposed to one or more analogs selected from the group consisting of norleucine, S-2-aminoethyl-L-cysteine, ethionine, methyl-methionine, and hydroxynorvaline.

In some embodiments of any of the microbial compositions described herein, the one or more heterotrophic microorganism(s) includes an Azotobacter species. In some embodiments, the one or more heterotrophic microorganism(s) include Pink-Pigmented Facultative Methylotroph. In some embodiments, the one or more heterotrophic microorganism(s) include Bacillus sp. In some embodiments, the one or more heterotrophic microorganism(s) include fungi. In some embodiments, the fungus is a member of either Arbuscular mycorrhiza, ericoid mycorrhiza, or ectomycorrhizal, or a combination thereof. In some embodiments, the one or more heterotrophic microorganism(s) includes a methanotrophic microorganism. In some embodiments, the methanotrophic microorganism is Methylomicrobium buryatense.

In some embodiments of any of the microbial compositions described herein, the ratio of one or more photosynthetic microorganism(s) to one or more heterotrophic microorganism(s) includes a ratio of: 10:1, 5:1, 4:1, 3:1, 2:1, 1:1, 1:2, 1:3, 1:4, 1:5, and 1:10.

In some embodiments of any of the microbial compositions described herein, the one or more agricultural adjuvant(s) includes a wetting agent. In some embodiments, the one or more agricultural adjuvant(s) includes one or more of: biochar, activated char, polyacrylamide, and polyaspartate. In some embodiments, the one or more agricultural adjuvant(s) includes a colorant. In some embodiments, the one or more agricultural adjuvant(s) includes an emulsifier. In some embodiments, the one or more agricultural adjuvant(s) includes a penetrating agent. In some embodiments, the one or more agricultural adjuvant(s) includes a humectant. In some embodiments, the one or more agricultural adjuvant(s) includes a foam suppressant. In some embodiments, the one or more agricultural adjuvant(s) includes drift control agent. In some embodiments, the one or more agricultural adjuvant(s) includes a water conditioner. In some embodiments, the one or more agricultural adjuvant(s) includes a deposition agent. In some embodiments, the one or more agricultural adjuvant(s) includes an acidifying agent. In some embodiments, the one or more agricultural adjuvant(s) includes a sticking agent.

In some embodiments of any of the microbial compositions described herein, the one or more agricultural aduvant(s) includes an agent that promotes plant growth. In some embodiments, the one or more agricultural aduvant(s) include an agent that promotes growth of the one or more photosynthetic microorganism(s) and/or the one or more heterotrophic microorganisms(s). In some embodiments, the one or more agricultural adjuvant(s) include an agent that protects against heat and/or drought.

In some embodiments of any of the microbial compositions described herein, at least one of the one or more photosynthetic microorganism(s) are isolated from a soil.

In some embodiments of any of the microbial compositions described herein, at least one of the one or more photosynthetic microorganism(s) are isolated from a marine environment.

In some embodiments of any of the microbial compositions described herein, the microbial composition is a crop dusting composition.

In some embodiments of any of the microbial compositions described herein, the microbial composition is a seed-coating composition.

In another aspect, this disclosure features methods of generating a microbial composition, including: (a) providing a combination of one or more photosynthetic microorganism(s); (b) determining a level of one or more activities of the combination selected from the group consisting of: production of one or more carbon species; production of one or more nitrogen species; production of one or more molecule(s) containing carbon and nitrogen; production of organic matter; soil water-holding capacity; growth in different soil types with or without vegetation; protection of vegetation against plant pathogens; protection of vegetation against pests; promotion of growth of vegetation; production of molecules having one or more of insecticidal, herbicidal, anti-fungal, weed controlling, and seed germination activity; promotion of root growth of vegetation; and inhibition of denitrification; (c) selecting a combination having an elevated level of the one or more activities as compared to a control level(s); and (d) producing a microbial composition including the selected combination and one or more microbial excipient(s).

In some embodiments of any of the methods described herein, the one or more photosynthetic microorganism(s) includes a cyanobacterium. In some embodiments, the cyanobacterium does not have nitrogen-fixing activity. In some embodiments, the cyanobacterium is a nitrogen-fixing cyanobacterium. In some embodiments, the cyanobacterium is selected from the group consisting of: Nostoc sp., Microcoleus sp., Phormidium sp., Anabaena sp., Cyanothece sp., Leptolyngbya sp., Porphyrosiphon sp., Scytonema sp., Symploca sp., and Schizothrix sp. In some embodiments, the cyanobacterium is selected from the group consisting of Nostoc commune, Nostoc longstaffi, Nostoc calcicola, Anabaena 33047, Nostoc muscorum, and Anabaena verrucosa.

In some embodiments of any of the methods described herein, the one or more photosynthetic microorganism(s) includes a non-cyanobacterium. In some embodiments, the non-cyanobacterium does not have nitrogen-fixing activity. In some embodiments, the non-cyanobacterium is a nitrogen-fixing bacterium. In some embodiments, the non-cyanobacterium is selected from the group consisting of: Rhodospirillaceae sp., Chromatiaceae sp., Chlorobiaceae sp., Chloroflexaceae sp., and Heliobacteriaceae sp.

In some embodiments of any of the methods described herein, the one or more photosynthetic microorganism(s) include a eukaryotic microorganism. In some embodiments, the eukaryotic microorganism is selected from the group consisting of: Chlamydomonas sp., Dunaliella sp., Scenedesmus sp., Chlorella sp., Prototheca sp., and Botryococcus sp.

In some embodiments of any of the methods described herein, the one or more photosynthetic microorganisms are selected from the group consisting of: Synechocystis sp., Synechococcus sp., Prochlorococcus sp., Anabaena catenula sp., Anabaena minutissima sp., Anabaena subcylindrica sp., Nostoc parmeloides sp., Nodularia spumigena sp., Desertella californica sp., Microcoleus vaginatus sp., and Thermosynechococcus sp.

In some embodiments of any of the methods described herein, the microbial composition produces one or both carbon species of the group consisting of sugars, fatty acids, and organic acids.

In some embodiments of any of the methods described herein, the microbial composition produces one or more nitrogen species from the group consisting of nitrate, urea, ammonia, ammonium, and amine(s).

In some embodiments of any of the methods described herein, the microbial composition produces one or more molecules containing carbon and nitrogen form the group consisting of amino acids, amino sugars, nucleobases, and sesquiterpene lactones. In some embodiments, the produced nucleobases and/or their nucleoside include one or more nucleobases from the group consisting of cytosine, thymine, adenine, guanine, xanthine, and hypoxanthine. In some embodiments, the produced amino acids include one or more aspartate family amino acids from the group consisting of aspartic acid, asparagine, methionine, and threonine. In some embodiments, the produced amino acids include one or more branch chain amino acids from the group consisting of isoleucine, leucine, and valine.

In some embodiments of any of the methods described herein, the combination further includes one or more heterotrophic microorganism(s). In some embodiments, the one or more heterotrophic microorganism(s) include one or more nitrogen-fixing heterotrophic microorganism(s). In some embodiments, the one or more heterotrophic microorganism(s) solubilize one or more of potassium, iron, and phosphorous when the microbial composition is exposed to conditions sufficient to solubilize one or more of potassium, iron, and phosphorous. In some embodiments, the one or more heterotrophic microorganism(s) store phosphorous in the form of polyphosphate.

In some embodiments of any of the methods described herein, the one or more photosynthetic microorganism(s) or the one or more heterotrophic microorganism(s) produce and secrete an exopolysaccharide; and the exopolysaccharide improves water-holding capacity of soil.

In some embodiments of any of the methods described herein, the one or more photosynthetic microorganism(s) or the one or more heterotrophic microorganism(s) produce a peptide or a chemical, and the peptide or chemical improves water-holding capacity of soil.

In some embodiments of any of the methods described herein, the microbial composition forms soil microaggregates, where the soil microaggregates improve the water-holding capacity of soil.

In some embodiments of any of the methods described herein, the microbial composition produces organic matter.

In some embodiments of any of the methods described herein, the microbial composition demonstrates growth in different soil types with or without vegetation.

In some embodiments of any of the methods described herein, the microbial composition protects vegetation against one or more plant pathogen(s) selected from the group consisting of: fungi, fungal-like organisms, bacteria, phytoplasmas, viruses, viroids, and nematodes.

In some embodiments of any of the methods described herein, the microbial composition protects against one or more pests selected from the group consisting of: wireworm, bean nodule fly, grub worms, cutworms, lesser corn stalk borer, Dectes stem borer, Kudzu bug, aphid, corn earworm, stink bug complex, grasshopper, bean leaf beetle, soybean looper, green clover worm, velvet bean caterpillar, fall army worm, Japanese beetle, cutworms, Thrips, corn rootworm, Chinch bug, and white grub.

In some embodiments of any of the methods described herein, the microbial composition promotes growth of vegetation by the production of factors including phytohormones and plant growth-promoting factors.

In some embodiments of any of the methods described herein, the microbial composition produces one or more molecules having one or more of insecticidal, herbicidal, anti-fungal, weed controlling, and seed germination activity.

In some embodiments of any of the methods described herein, the microbial composition promotes root growth of vegetation through modification of rhizosphere and promoting oxygenic environment around root(s).

In some embodiments of any of the methods described herein, the microbial composition inhibits denitrification.

In some embodiments of any of the methods described herein, the one or more photosynthetic microorganism(s) and/or the one or more heterotrophic microorganism(s) are tolerant to biotic/abiotic conditions.

In some embodiments of any of the methods described herein, the one or more photosynthetic microorganism(s) and/or the one or more heterotrophic microorganism(s) are tolerant to one or more of minerals, an herbicide, and an insecticide.

In some embodiments of any of the methods described herein, the method further includes further selecting a combination having an elevated level of exopolysaccharide production as compared to a control level.

In some embodiments of any of the methods described herein, the method further includes further selecting a combination having an elevated level of solubilized potassium, iron, and phosphorus production as compared to a control level. In some embodiments, the method further includes one or more heterotrophic microorganism(s) storing phosphorous in the form of polyphosphate.

In some embodiments of any of the methods described herein, the method further includes selecting a combination having an elevated level of siderophore production as compared to a control level.

In some embodiments of any of the methods described herein, the method further includes, between steps (a) (e.g., the step of providing a combination of one or more photosynthetic microorganism(s)) and (b) (e.g., the step of determining a level of one or more activities of the combination selected from the group consisting of: production of one or more carbon species): contacting the combination with a chemical mutagen. In some embodiments, the chemical mutagen is selected from the group consisting of: ethyl methanesulfonate, methyl methanesulfonate, and ethyl nitrosourea. In some embodiments, the combination has previously been exposed to a chemical mutagen. In some embodiments, the chemical mutagen is selected from the group consisting of: ethyl methanesulfonate, methyl methanesulfonate, and ethyl nitrosourea.

In some embodiments of any of the methods described herein, the one or more photosynthetic microorganisms secrete nucleobases, nucleobase derivatives, or both when exposed to analogs selected from the group consisting of 8-azaguanine, 6-azauracil, 2-diazo-5-oxo-L-norleucine, decoyinine, and 6-mercaptoguanine.

In some embodiments of any of the methods described herein, the one or more photosynthetic microorganisms secrete aspartate amino acids, branched-chain amino acids or both when exposed to one or more analogs selected from the group consisting of norleucine, S-2-aminoethyl-L-cysteine, ethionine, methyl-methionine, and hydroxynorvaline.

In some embodiments of any of the methods described herein, the one or more heterotrophic microorganism(s) includes an Azotobacter species. In some embodiments, the one or more heterotrophic microorganism(s) include Pink-Pigmented Facultative Methylotroph. In some embodiments, the one or more heterotrophic microorganism(s) include Bacillus sp.

In some embodiments of any of the methods described herein, the one or more heterotrophic microorganism(s) include fungi. In some embodiments, the fungus is a member of either Arbuscular mycorrhiza, ericoid mycorrhiza, or ectomycorrhizal, or a combination thereof.

In some embodiments, the one or more heterotrophic microorganism(s) includes a methanotrophic microorganism. In some embodiments, the methanotrophic microorganism is Methylomicrobium buryatense.

In some embodiments of any of the methods described herein, the one or more agricultural adjuvant(s) includes a wetting agent. In some embodiments, the one or more agricultural adjuvant(s) includes one or more of biochar, activated char, polyacrylamide, and polyaspartate. In some embodiments, the one or more agricultural adjuvant(s) includes a colorant. In some embodiments, the one or more agricultural adjuvant(s) includes an emulsifier. In some embodiments, the one or more agricultural adjuvant(s) includes a penetrating agent. In some embodiments, the one or more agricultural adjuvant(s) includes a humectant. In some embodiments, the one or more agricultural adjuvant(s) includes a foam suppressant. In some embodiments, the one or more agricultural adjuvant(s) includes drift control agent. In some embodiments, the one or more agricultural adjuvant(s) includes a water conditioner. In some embodiments, the one or more agricultural adjuvant(s) includes a deposition agent. In some embodiments, the one or more agricultural adjuvant(s) includes an acidifying agent. In some embodiments, the one or more agricultural adjuvant(s) includes a sticking agent.

In some embodiments of any of the methods described herein, the one or more agricultural adjuvant(s) includes an agent that promotes plant growth. In some embodiments, the one or more agricultural adjuvant(s) include an agent that promotes growth of the one or more photosynthetic microorganism(s) and/or the one or more heterotrophic microorganisms(s). In some embodiments, the one or more agricultural adjuvant(s) include an agent that protects against heat and/or drought.

In some embodiments of any of the methods described herein, at least one of the one or more photosynthetic microorganism(s) are isolated from a soil.

In some embodiments of any of the methods described herein, at least one of the one or more photosynthetic microorganism(s) are isolated from a marine environment.

In some embodiments of any of the methods described herein, the microbial composition is a crop dusting composition.

In some embodiments of any of the methods described herein, the microbial composition is a seed-coating composition.

In another aspect, this disclosure features methods that include contacting soil or a plant with any of the microbial compositions described herein. In some embodiments, the microbial composition enriches the soil with carbon. In some embodiments, the soil is enriched by at least 0.25 tons of carbon per acre.

In another aspect, this disclosure features methods of increasing a level of nitrogen species in a soil, the method including: contacting the soil with any of the microbial compositions described herein. In some embodiments, the level of nitrogen species in the soil is increased as compared to the level of a control soil not contacted with the microbial composition. In some embodiments, the level of nitrogen species in the soil is increased by at least 50% as compared to the level of the control soil not contacted with the microbial composition.

In another aspect, this disclosure features methods of increasing a level of carbon species in a soil, the method including: contacting the soil with any of the microbial compositions described herein. In some embodiments, the level of carbon species in the soil is increased as compared to the level of a control soil not contacted with the microbial composition. In some embodiments, the level of carbon species in the soil is increased by at least 40% as compared to the level of the control soil not contacted with the microbial composition.

In another aspect, this disclosure features methods of increasing a level of organic matter in a soil, the method including: contacting the soil with any of the microbial compositions described herein. In some embodiments, the level of organic matter in the soil is increased as compared to the level of a control soil not contacted with the microbial composition. In some embodiments, the level of organic matter in the soil is increased by at least 5% as compared to the level of the control soil not contacted with the microbial composition.

In another aspect, this disclosure features methods of increasing a level of exopolysaccharides in a soil, the method including: contacting the soil with any of the microbial compositions described herein. In some embodiments, the level of exopolysaccharides in the soil is increased as compared to the level of a control soil not contacted with the microbial composition. In some embodiments, the level of exopolysaccharides in the soil is increased by at least 5% as compared to the level of the control soil not contacted with the microbial composition.

In another aspect, this disclosure features methods of increasing a level of solubilized potassium, iron, and phosphorus in a soil, the method including: contacting the soil with any of the microbial compositions described herein. In some embodiments, the level of solubilized potassium, iron, and phosphorus in the soil is increased as compared to the level of a control soil not contacted with the microbial composition. In some embodiments, the level of solubilized potassium, iron, and phosphorus in the soil is increased by at least 5% as compared to the level of the control soil not contacted with the microbial composition.

In another aspect, this disclosure features methods of increasing a level of a siderophore in a soil, the method including: contacting the soil with any of the microbial compositions described herein. In some embodiments, the level of siderophore in the soil is increased as compared to the level of a control soil not contacted with the microbial composition. In some embodiments, the level of siderophore in the soil is increased by at least 5% as compared to the level of the control soil not contacted with the microbial composition.

In another aspect, this disclosure features methods of increasing the bioavailability of sulfur, boron, magnesium, or manganese in a soil, the method including: contacting the soil with any of the microbial compositions described herein. In some embodiments, the bioavailability of sulfur, boron, magnesium, or manganese in the soil is increased as compared to the level of a control soil not contacted with the microbial composition. In some embodiments, the bioavailability of sulfur, boron, magnesium, or manganese in the soil is increased by at least 5% as compared to the level of the control soil not contacted with the microbial composition.

All publications, patents, patent applications, and information available on the internet and mentioned in this specification are herein incorporated by reference to the same extent as if each individual publication, patent, patent application, or item of information was specifically and individually indicated to be incorporated by reference. To the extent publications, patents, patent applications, and items of information incorporated by reference contradict the disclosure contained in the specification, the specification is intended to supersede and/or take precedence over any such contradictory material.

Where values are described in terms of ranges, it should be understood that the description includes the disclosure of all possible sub-ranges within such ranges, as well as specific numerical values that fall within such ranges irrespective of whether a specific numerical value or specific sub-range is expressly stated.

### DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of the use of a microbial composition to increase the levels of total organic carbon and total nitrogen in a soil. Carbon species are deposited in soil through plant exudates, roots, and above-ground litters. Microbes consume these deposited carbon sources to build organic matter while releasing about two-thirds of carbon as CO₂. Loss of organic carbon can occur from the intensive agricultural practices, soil erosion, and leaching. The proposed technology can work with or without vegetation to increase organic matter and sequester carbon in soil. In this scenario, the applied agriculture composition will capture CO₂ and return it to soil in the reduced form for use by soil microbial population. This will allow a better grain yields as crops will be able to keep the fixed carbon for making more grains but will still be able to get the same benefits from the soil microbial population. Also, the overall CO₂ emission from the field will be greatly reduced. Further, the proposed technology can be useful to restore degraded soil which has limited ability to support vegetation.

FIG. 2 is a schematic diagram of the use of a microbial composition to increase the production of organic matter (OM) in a soil. The example microbial composition can increase organic matter in the soil and increase carbon capture. The microbial composition may include one or more cyanobacterial species, an agricultural adjuvant, and/or one or more other microorganisms such as a heterotrophic microorganism species.

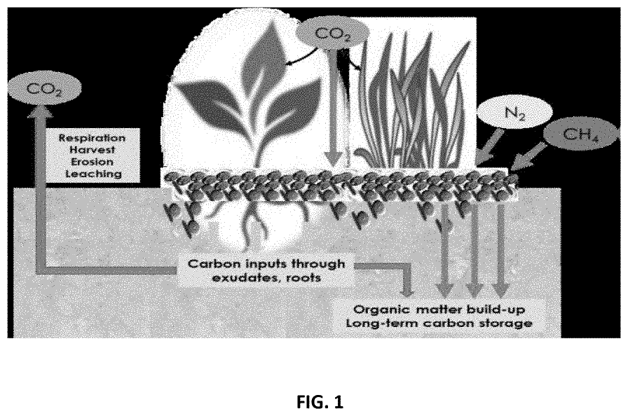

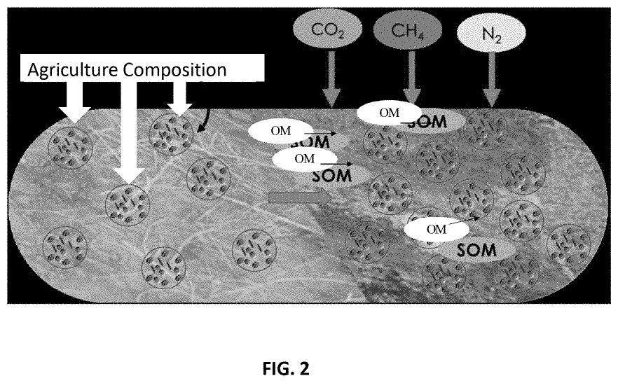

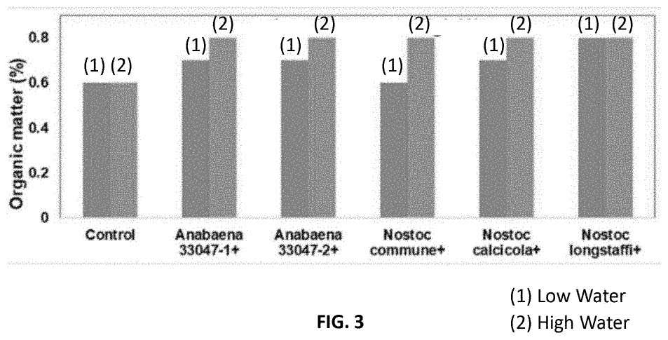

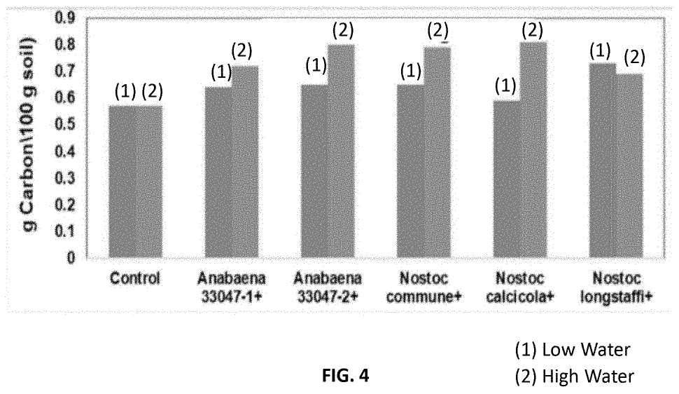

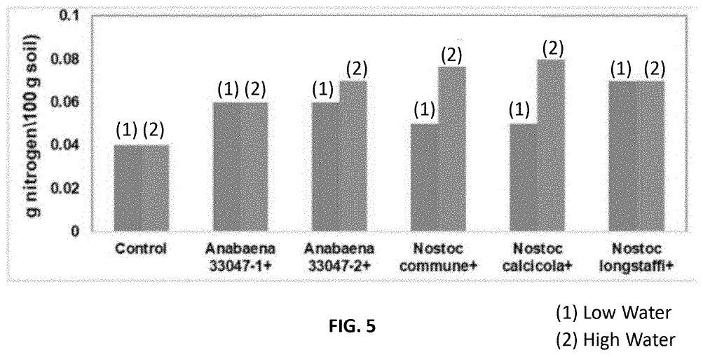

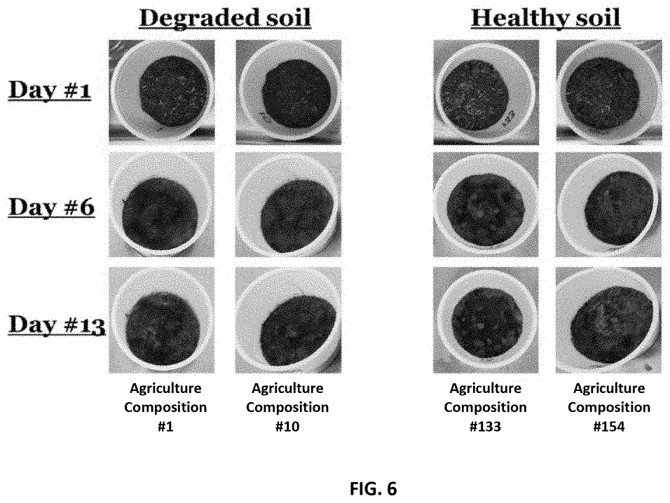

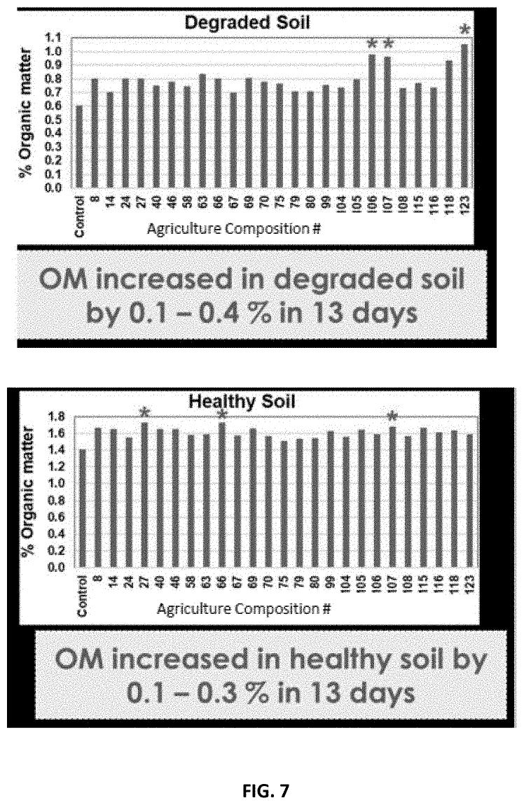

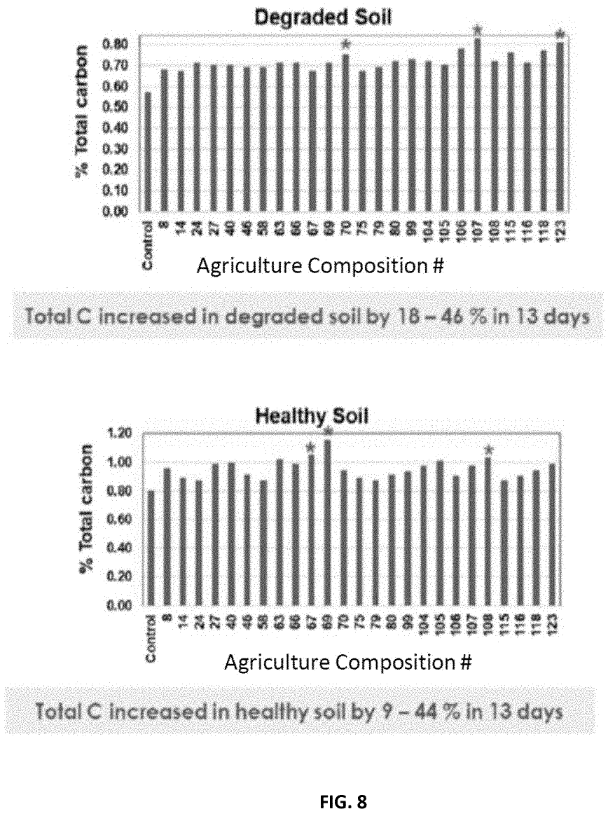

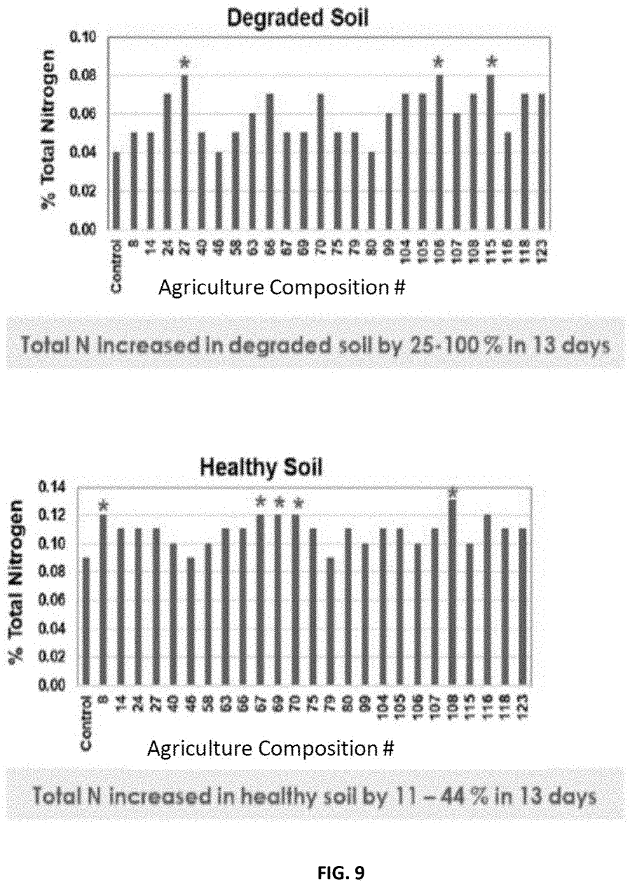

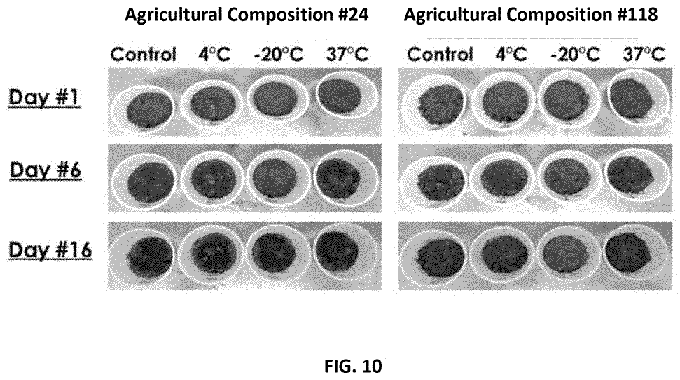

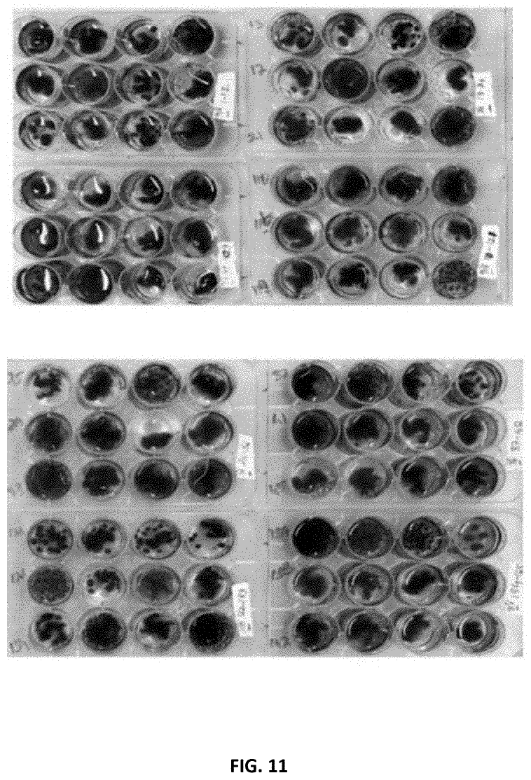

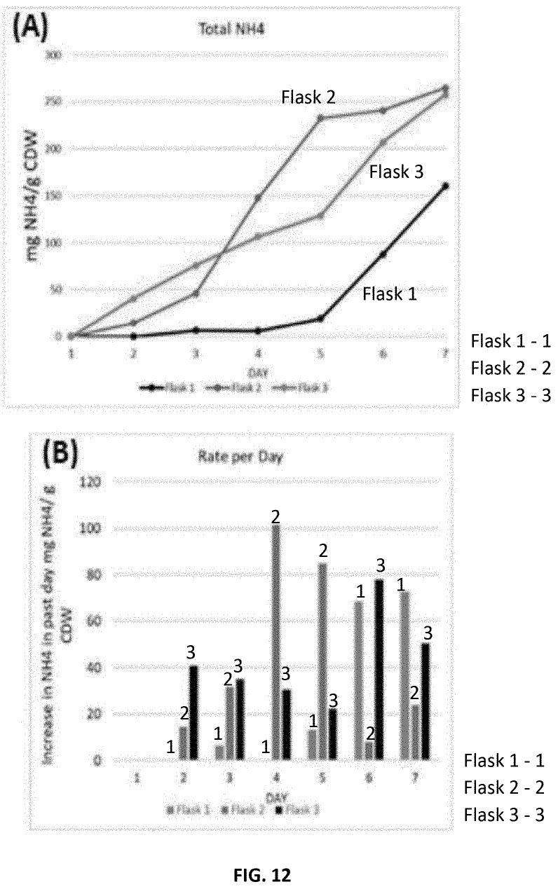

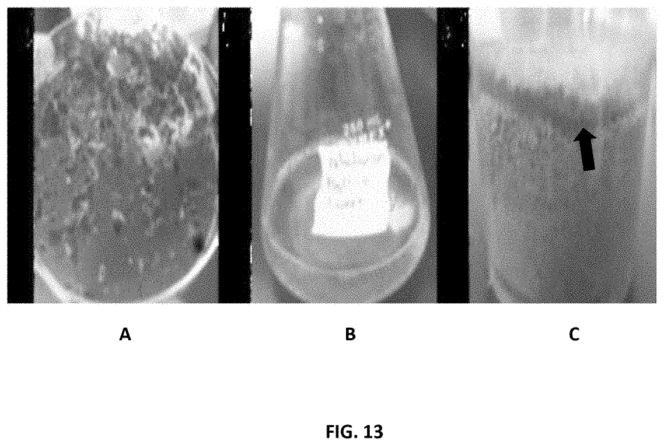

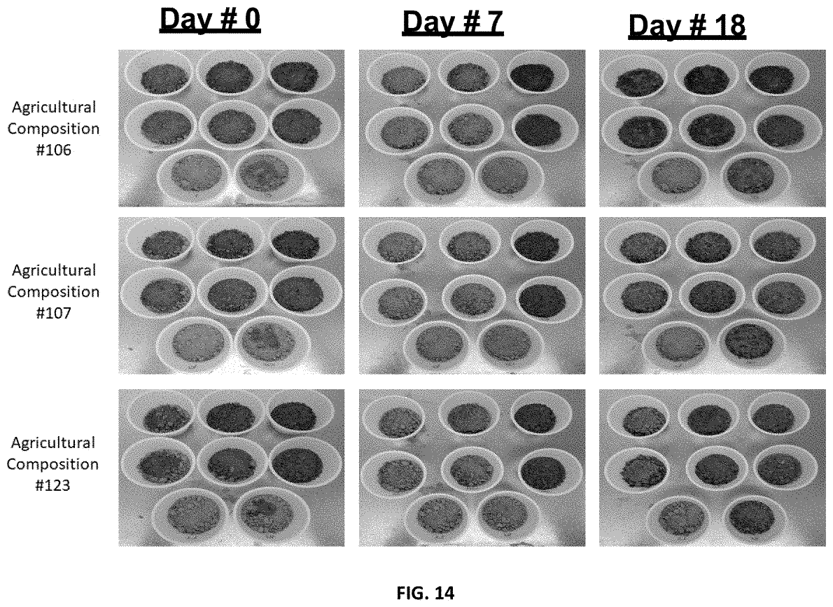

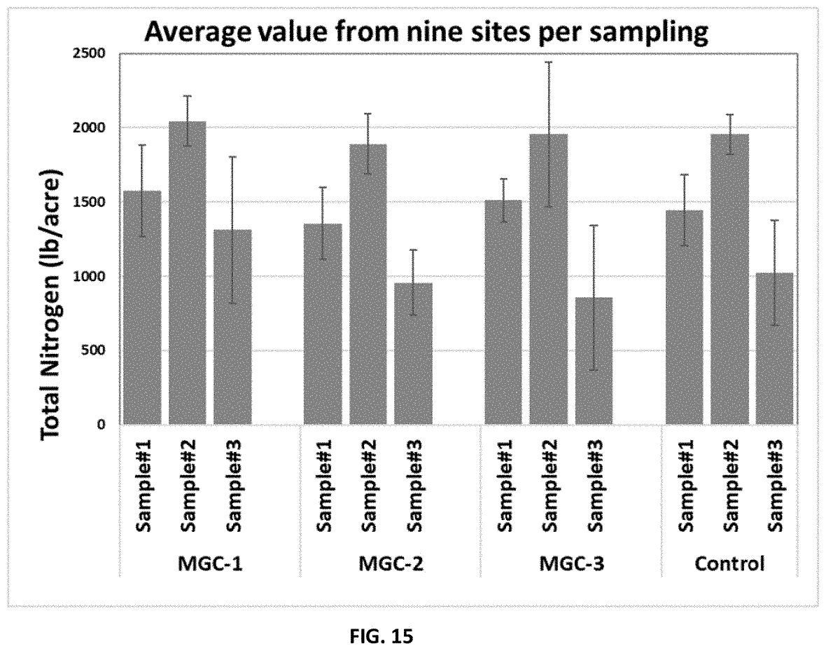

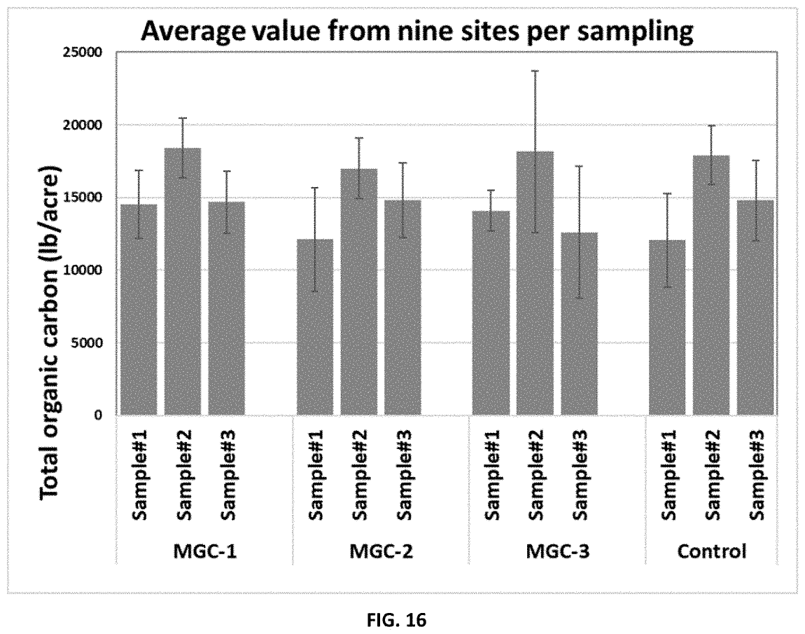

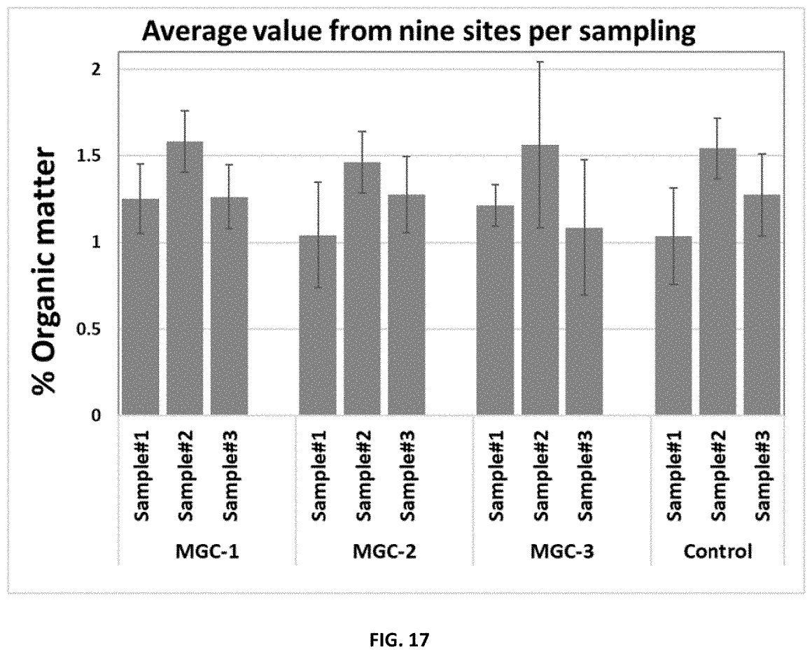

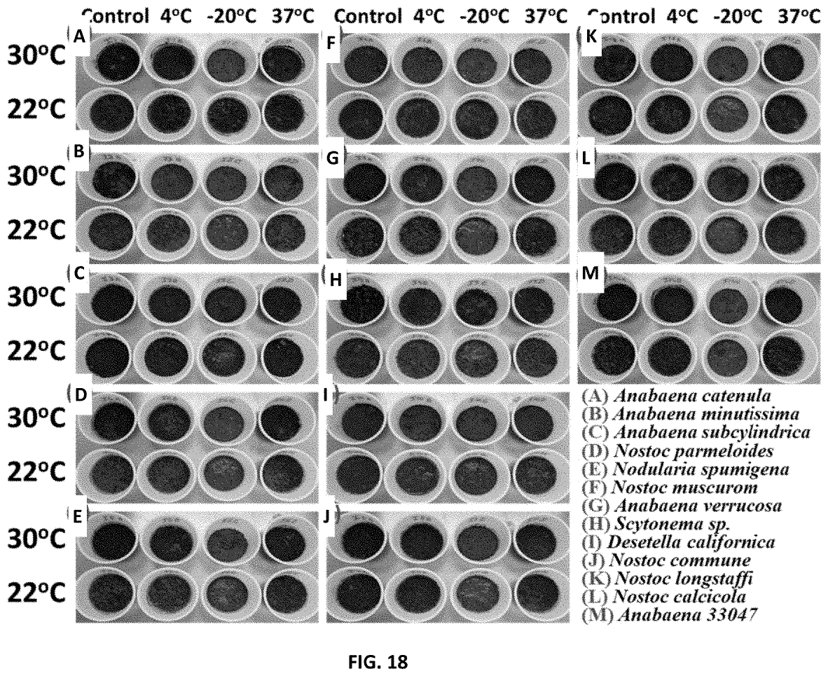

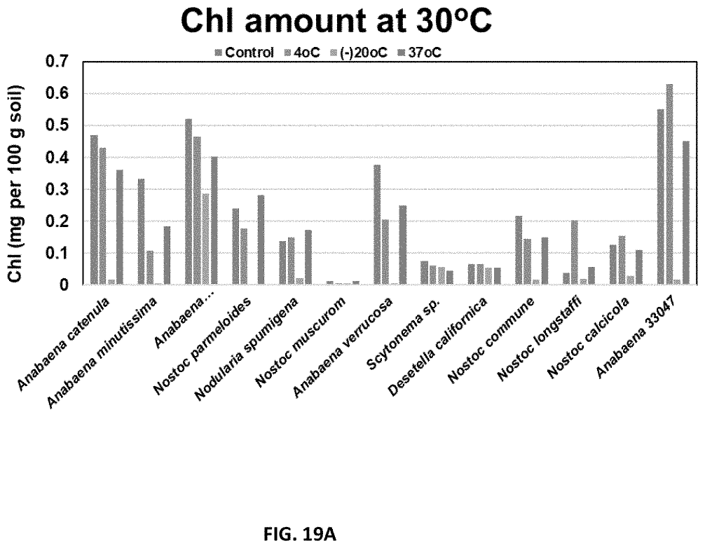

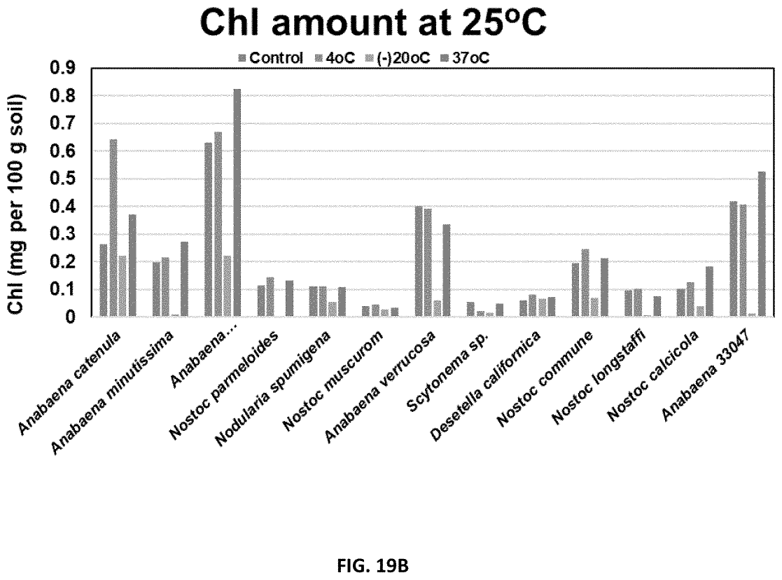

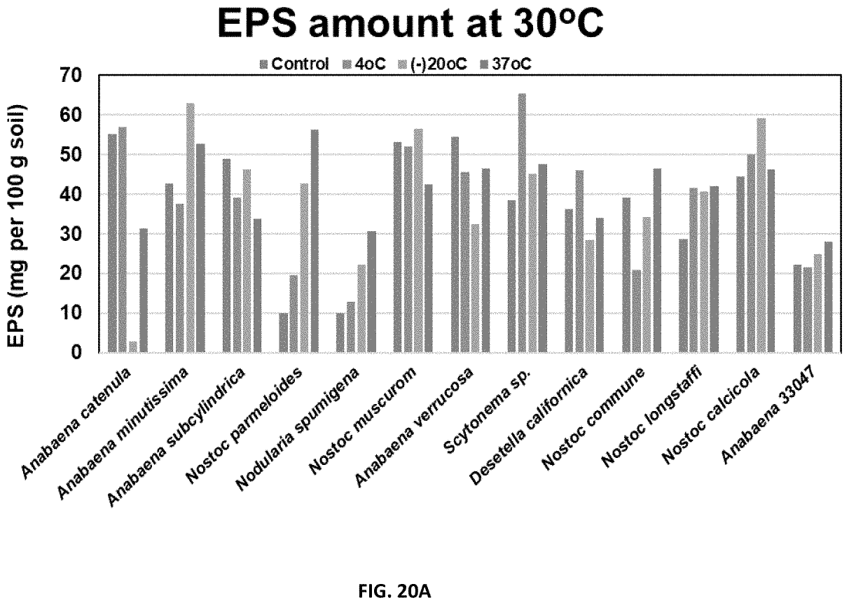

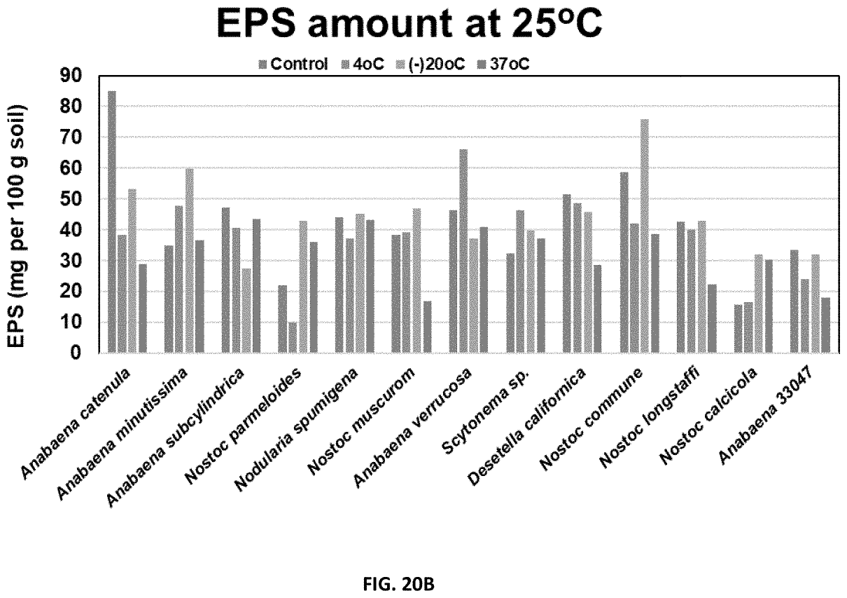

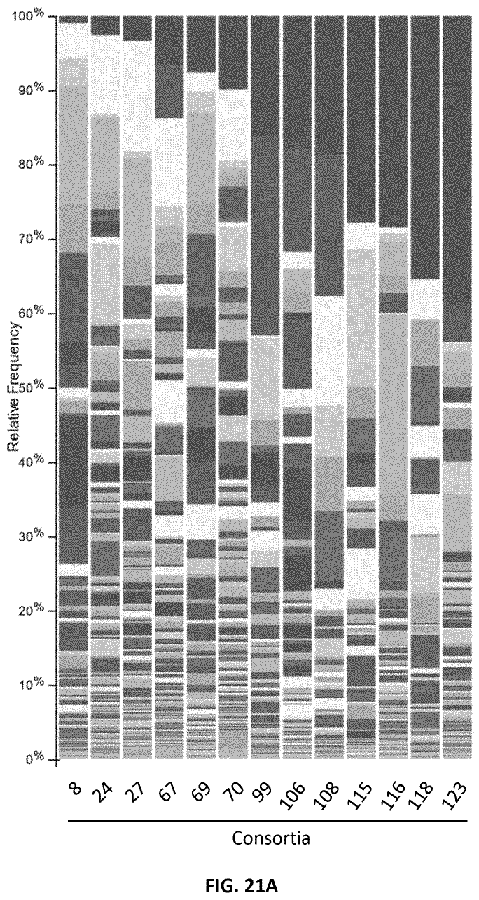

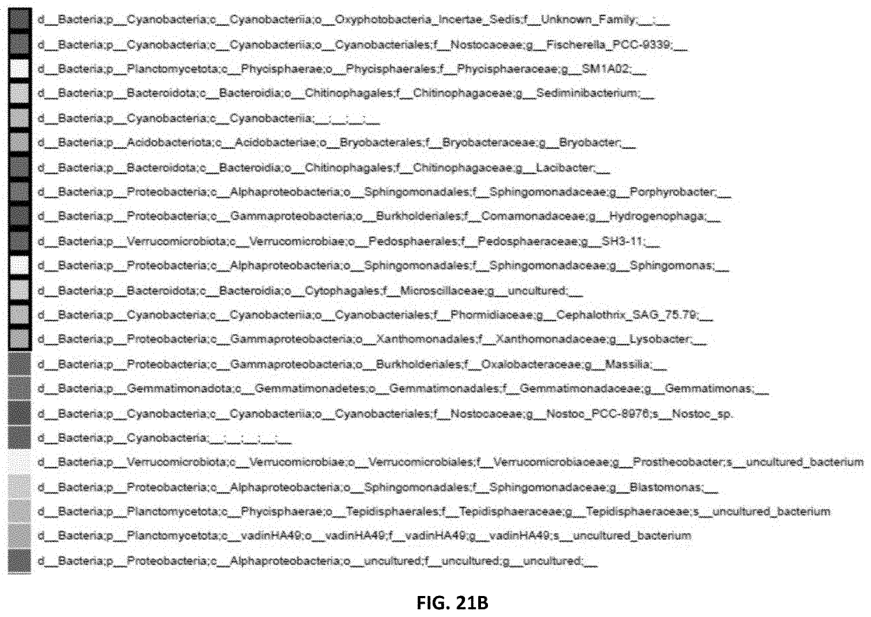

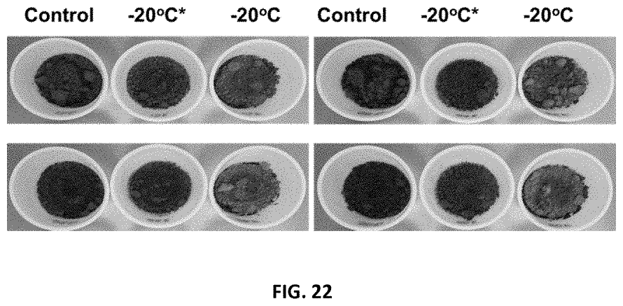

The cyanobacterial species can contribute OM to soil and improve water holding capacity leading to initiation of vegetation. The improvement to water holding capacity may, in some examples, be attributed to the production of EPS by the cyanobacterial species, the heterotrophic microorganisms, or both. The improvement to water holding capacity may, in some examples, be also attributed to the filamentous nature of these microbes which enables formation of soil microaggregates. The microbial composition can drive the rapid build-up of OM from sunlight, CO₂ and N₂. As mentioned, one or more of the cyanobacterial species can be nitrogen-fixing species that can provide nitrogen and organic carbon to soil, soil microbiome, and/or crops. In other examples, one or more of the cyanobacterial species can be non-nitrogen-fixing species that, in combination with other microorganisms (e.g., heterotrophic microorganism species), can generate nitrogen and carbon to soil, soil microbiome, and/or crops.

The microbial compositions disclosed herein can decrease cost when compared to current methods (e.g., tillage practices, removal of residual crops, synthetic fertilizers, herbicides, etc.). Adding valuable nutrients, via the described microbial compositions, to otherwise ineffectual soil can increase the value of land. Further, the fixation of carbon and nitrogen from the atmosphere can provide a foundation for negative GHG emissions.

FIG. 3 is a graph showing the percentage of organic matter produced by a control (no added microorganisms), Anabaena 33047-1+, Anabaena 33047-2+, Nostoc commune+, Nostoc calcicola+, and Nostoc longstaffi+ in low water and high water conditions. The “+” indicates presence of additional microorganisms such as Synechocystis sp. Synechococcus sp., Methylomicrobium buryatense, and Azotobacter vinelandii. The results indicated an increase OM in the respective soil by the microbial composition including the respective cyanobacterial species. The example cyanobacterial species based microbial compositions can increase OM compared to control soil at different rates as illustrated by FIG. 3. In general, all cyanobacterial species growing in high-water conditions led to 33% increase OM (0.8% vs. 0.6% in control soil) in 20 days. In contrast, cyanobacterial species growing in low-water condition resulted in a variable increase in OM. However, increase in OM by Nostoc longstaffi based microbial composition was the same in both low water and high water conditions.

FIG. 4 is a graph showing the level of total organic carbon (g carbon per 100 g soil) produced by a control (no added microorganisms), Anabaena 33047-1+, Anabaena 33047-2+, Nostoc commune+, Nostoc calcicola+, and Nostoc longstaffi+ in low water and high water conditions. The “+” indicates presence of additional microorganisms such as Synechocystis sp. Synechococcus sp., Methylomicrobium buryatense, and Azotobacter vinelandii. The results indicate an increase in total organic carbon in the respective soil by the microbial composition including the respective cyanobacterial species. All five cyanobacterial species based microbial compositions increased total organic carbon by 40% compared to control soil. In general, the increase in total organic carbon and is more apparent in the high-water condition compared to the low-water condition. Total organic carbon produced by Nostoc longstaffi in low-water condition soil was slightly more than the high-water condition soil.

FIG. 5 is a graph showing the level of total nitrogen (g nitrogen per 100 g soil) by a control (no added microorganisms), Anabaena 33047-1+, Anabaena 33047-2+, Nostoc commune+, Nostoc calcicola+, and Nostoc longstaffi+ in low water and high water conditions. The “+” indicates presence of additional microorganisms such as Synechocystis sp. Synechococcus sp., Methylomicrobium buryatense, and Azotobacter vinelandii. All five cyanobacterial species based microbial compositions increased total nitrogen by 100% compared to control soil. In general, increase in total nitrogen was more apparent in the high-water condition compared to the low-water condition.

FIG. 6 is a picture showing the production of biomass on degraded soil and healthy soil using exemplary microbial compositions described herein. FIG. 6 is an image of plastic cups including about 20 g of soil that include an example microbial composition that can include one or more cyanobacterial species isolated from soil. The degraded soil includes about 0.6% OM, about 0.04% total nitrogen, and about 0.57% total organic carbon. The healthy soil includes about 1.4% OM, about 0.09% total nitrogen, and about 0.9% total organic carbon content. About 0.1 mg (about 500 g per hectare) of the example microbial composition that can include one or more cyanobacterial species enriched from soil are included in each cup of soil. The cups are illustrated as incubated in a growth chamber at about 30° C. in relatively low light (e.g., about 50 μE·m⁻²·s⁻¹). The image shown in FIG. 6 shows incubation at days 1, 6, and 13.

The cyanobacterial species depicted in FIG. 6 were optimized using ALE for the optimal performance on different types of soil. Chemical mutagens were used to collectively optimize the functionality of all components of the microbial composition for the rapid growth and adaptations to the environmental conditions on soil. Chemical mutagens and selection against specific analogs to secrete specific carbon and nitrogen containing molecules by nitrogen-fixing cyanobacteria for utilization by the heterotrophic components of the microbial composition. The results illustrated in FIG. 6 indicate that the microbial composition can provide rapid biomass growth in both healthy soil and degraded soil.

FIG. 7 is a graph showing an increase in organic matter in degraded soil and healthy soil using exemplary microbial compositions described herein. FIG. 7 shows that multiple microbial compositions as described in connection with FIG. 6 exhibited an increase in OM versus the control in both the degraded soil (about 0.1-0.4% in 13 days) and the healthy soil (about 0.1-0.3% in 13 days).

FIG. 8 is a graph showing an increase in total organic carbon in degraded soil and healthy soil using exemplary microbial compositions described herein. FIG. 8 shows that multiple microbial compositions as described in connection with FIG. 6 exhibited an increase in total organic carbon versus the control in both the degraded soil (about 18.0% to 46.0% increase in 13 days) and the healthy soil (about 9.0% to 44.0% increase in 13 days).

FIG. 9 is a graph showing an increase in total nitrogen in degraded soil and healthy soil using exemplary microbial compositions described herein. FIG. 9 shows that multiple microbial compositions as described in connection with FIG. 6 exhibited an increase in total nitrogen versus the control in both the degraded soil (about 25.0% to 100.0% increase in 13 days) and the healthy soil (about 11.0% to 44.0% increase in 13 days).

FIG. 10 is a set of images showing the production of biomass in soil samples contacted with different microbial compositions in a condition which are either untreated (control) or, and exposed to 4° C., −20° C., and 37° C. for 2 hour every day. FIG. 10 is an image of plastic cups including about 20 g of soil that include example microbial compositions that can include one or more cyanobacterial species enriched from soil incubated at various temperatures to determine the effect of changing temperature of a microbial composition including selected cyanobacterial species in microbial composition #24 and #118. The levels of growth are depicted in FIG. 10 where images of Day #1, Day #6, and Day #16 are shown for two example microbial compositions including example microbial compositions #24 and #118.

FIG. 11 is an image showing growth of exemplary microbial compositions in modified Burk's medium in the absence of carbon and nitrogen sources at 30° C. under continuous light (100 μE·m⁻² s⁻¹). The cups of FIG. 11 example microbial compositions that can include one or more cyanobacterial species enriched from soil. These microbial compositions have been sub-cultured more than twenty times. They grow well both in liquid media and on soil under carbon and nitrogen-fixing conditions. Further, pigment color of enriched cyanobacterial species suggest the successful in enrichment of multiple species of nitrogen-fixing cyanobacteria.

FIG. 12 is a graph illustrating ammonia production of an exemplary microbial composition grown in liquid nitrogen-free BG11 media at 30° C. under continuous light (100 μE m⁻² s⁻¹). FIG. 12 includes two graphs illustrating the secretion of ammonia by an optimized Nostoc commune. The total ammonia secreted is depicted in graph A and the rate of secretion is depicted by graph B. Chemical mutagen and selection was performed in the presence of analogs to obtain ammonia secreting Nostoc commune under nitrogen-fixing photoautotrophic conditions. The amount of secreted ammonia was measured in the supernatant. The amount of secreted ammonia was measured enzymatically using glutamate dehydrogenase, oxoglutarate, and NADH.

Two of the cyanobacterial species produced a total of about 0.25 g ammonia/gCDW in 7 days. Results also indicated that the specific rate of ammonia secreted depended on growth stage (FIG. 12B). The rate of ammonia production was maximal on day 4 in species 2, day 6 in species 3, and day 7 in species 1. This suggests that the mechanism resulting in ammonia secretion in the three species is due to mutation(s) at different locus. Interestingly, species 2 produced about 100 mg/gCDW on day 4 alone highlighting the capability of this species to produce high amount of fixed nitrogen molecules while growing photoautotrophically. Further, in some examples, the total amount of ammonia secreted could reach a steady-state due to inhibition, and that production by these species could be higher provided there is a continuous consumption of ammonia.

FIG. 13 is an image of an aggregate formation, storage, and regrowth of an example cyanobacterial species Nostoc commune. The image of FIG. 13A shows Nostoc commune grown on solid agar plate and dried. Dried cell materials were transferred in nitrogen-free BG11 medium and grown for 1 week at 30° C. in continuous light (100 μE·m⁻²·s⁻¹) (FIG. 13B). The image in FIG. 13C shows crust formation by Nostoc commune.

FIG. 14 is an image showing stability of agriculture composition to extended drought and regrowth once water was added. Microbial composition was added to dry soil and incubated in a growth temperature maintained at 30° C. and 12 hours light: 12 hours dark. After 7 days, water was sprinkled on soil which laid to growth of cyanobacteria.

FIG. 15 is a graph showing the level of total nitrogen (g nitrogen per 100 g soil) produced following treatment with microbial compositions including: a control (no added microorganisms), MGC-1, MGC-2, and MGC-3 (the three microbial compositions) in a field trial under natural conditions. Percentage change of total nitrogen amount following the application of respective microbial composition as compared to control (vs. sample #1): +9% with MGC1; −6% with MGC2; and +3.5% with MGC3.

FIG. 16 is a graph showing the level of total organic carbon (g carbon per 100 g soil) produced following treatment with microbial compositions including: a control (no added microorganisms), MGC-1, MGC-2, and MGC-3 (three microbial compositions) in a field trial under natural conditions. Percentage change of total organic carbon amount following the application of respective microbial composition as compared to control (vs. sample #1): +21% with MGC1; +1% with MGC2; and +17% with MGC3.

FIG. 17 is a graph showing the percentage of organic matter produced following treatment with microbial compositions including: a control (no added microorganisms), MGC-1, MGC-2, and MGC-3 (three microbial compositions) in a field trial under natural conditions. Percentage change of organic matter following the application of respective microbial composition as compared to control (vs. sample #1): +0.21% with MGC1; +0.006% with MGC2; and +1.76% with MGC3.

FIG. 18 is a picture showing the growth of an isolated cyanobacterium following treatment with different temperatures using exemplary microbial compositions described herein. FIG. 18 is an image of plastic cups including about 20 g of soil that include an example microbial composition that can include an isolated cyanobacterial species isolated from soil. Cups containing the isolated cyanobacterial species were exposed to 4° C., −20° C., 37° C., or were kept at ambient temperatures as a control. These cups were then grown at either 30° C. or 22° C. with changes in growth indicated by changes in pigment phenotype.

FIGS. 19A-19B show graphs of the amount of total chlorophyll (mg chlorophyll per 100 g soil) produced following treatment with microbial compositions grown according to the conditions described in Example 9 and FIG. 18.

FIGS. 20A-20B show graphs of the amount of total exopolysaccharide (EPS) (g EPS/100 g soil) produced following treatment with microbial compositions grown according to the conditions described in Example 9 and FIG. 18.

FIGS. 21A-B show a heat map of data from 16S rRNA sequencing of the microbial compositions described in Example 4 and FIG. 11.

FIG. 22 is a picture showing the growth of cyanobacteria following ALE that combined chemical mutagens and temperature to collectively optimize the functionality of all components of microbial composition for the rapid growth and adaptations to the environmental conditions on soil. The selected cyanobacterial cells were treated with one of the three chemical mutagens; washed, combined, and inoculated on soil (marked with −20° C.*). The other two cups (control and −20° C.) contain non-treated cells. Cups containing these cells were then exposed to −20° C. for 2 hr and then returned to 30° C. for growth. On days 2, 3, and 4, one cup was exposed (marked with −20° C.*) to UV-A for 30 min.

### DETAILED DESCRIPTION

The microbial compositions described herein provides a platform to capture carbon and increase organic matter (OM) in soil, and thus improve the health of soil. Further, the microbial compositions described herein provide a means to increase nitrogen and improve water-holding capacity of soil. The microbial compositions provided herein can have widespread applications in agriculture and can be used to reclaim degraded soil. The microbial compositions described herein can result in the addition of at least 0.1% OM in soil on an annual basis. This can add at least 100 lbs. combined nitrogen per acre per year and at least 1,000 lbs. carbon per acre per year to soil.

Disclosed herein are microbial compositions that can be used to increase organic matter in soil as compared to a control (e.g., a soil that has not been treated with the microbial composition). In some examples, the microbial compositions provided herein can increase organic matter by about 0.1% or greater on an annual basis. The microbial compositions provide herein can applied to soil or to a crop to increase the level of organic matter in different types of soil in different regions including semi-arid climates.

The microbial compositions provided herein can: generate nutrients, carbon, and nitrogen, from CO₂ and atmospheric nitrogen; produce exopolysaccharides (EPS) to hold water; mineralize micronutrients, such as iron and phosphorous through production of siderophores and organic acids; protect vegetation from disease, pathogens and pests; produce molecules having one or more of insecticidal, herbicidal, anti-fungal, weed controlling, and seed germination activity; promoter growth of vegetation, promote root growth of vegetation, and inhibit denitrification. The importance of exopolysaccharides in soil stability and health is being increasingly recognized due to its high water-holding capacity and ability to form soil aggregates, thus preventing loss of topsoil. The microbial compositions described herein can increase organic matter more than 0.1% and store at least 0.5 tons carbon per acre on an annual basis, and provide a significant amount of utilizable nitrogen.

More specifically, provided herein are a plurality of cyanobacterial species which can be nitrogen-fixing and/or non-nitrogen-fixing microorganisms. One or more of the cyanobacterial species can be grouped together with other microorganisms (e.g., heterotrophic microorganisms) in a symbiotic relationship or an associative relationship together with one or more microbial adjuvants to form a microbial composition.

In some examples, a microbial composition provided herein can include nitrogen-fixing cyanobacterial species (e.g., which can be isolated from soil, a fresh water, and/or marine environment). In some examples, the microbial composition can fix both carbon and nitrogen, while one or more heterotrophic organisms present in the microbial composition can attribute other beneficial functions, such as solubilizing phosphate, potassium, protection from pathogens, etc. In some examples, microbial composition provided herein can include non-nitrogen-fixing cyanobacterial species as a source of carbon and energy, where such non-nitrogen-fixing cyanobacterial species can provide fixed carbon from CO₂ to heterotrophic organisms, which can, in turn, fix nitrogen. The microorganisms present in any of the microbial compositions described herein can be obtained from the culture collection sites such as University of Texas, Austin (UTEX) Culture Collection. The microorganisms present in any of the microbial compositions described herein can be identified by screening for specific attributes, where the attributes are identified based at least in part on attributes of the soil to which the microbial composition is to be applied.

In some embodiments of any of the microbial compositions described herein, the microbial composition disclosed herein can include a non-naturally occurring component. For example, the microbial composition can include a synthesized component such as a chemically synthesized molecule, a synthesized biological component, etc.

In some embodiments of any of the microbial compositions described herein, the microbial composition includes a component not naturally present in a soil and/or a plant. In some examples, a component not naturally present in a soil and/or a plant can be an excipient and/or microbial adjuvant. In some embodiments of any of the microbial compositions described herein, the microbial composition does not include a component naturally present in a soil and/or a plant.

In some embodiments of any of the compositions or methods described herein, a microbial composition can be an agricultural composition.

Also provided herein are methods of selective enrichment, isolation, and characterization of photosynthetic and non-photosynthetic microorganism(s) from soil for the purpose of soil reclamation.

Also provided herein are microbial compositions that can be used for soil reclamation.

Also provided herein are methods for generating a microbial composition for use in soil reclamation.

### Microbial Compositions

Provided herein are microbial compositions that include: (a) one or more photosynthetic microorganism(s) and/or one or more heterotrophic microorganism(s); and (b) one or more agricultural adjuvant(s); wherein the microbial composition has one or more of any of the following activities: produces one or more carbon species (e.g., sugars and fatty acids); produces one or more nitrogen species (e.g., ammonia); produces one or more molecule(s) containing carbon and nitrogen (e.g., amino sugars, amino acids, and nucleobases); increases soil organic matter; improves soil water-holding capacity; demonstrates growth in different soil types with or without vegetation; protects vegetation against plant pathogens; protects vegetation against pests; promotes growth of vegetation; produces molecules having one or more of insecticidal, herbicidal, anti-fungal, weed controlling, and seed germination activity; promotes root growth of vegetation; and inhibits denitrification.

In some embodiments, the inhibition of denitrification occurs via production of oxygen by the photosynthetic microorganism(s). In some embodiments, the inhibition of denitrification occurs by release of molecules that inhibit denitrification (e.g., any of molecules that can inhibit denitrification described herein or known in the art). In some embodiments, the microbial composition produces chemicals leading to the inhibition of denitrification. In some embodiments, the microbial compositions produce chemicals that inhibit microorganism from facilitating denitrification. For example, the microbial composition can include chemicals that inhibit bacterial denitrification (e.g., the chemicals can inhibit aerobic and/or anaerobic denitrification).

In some embodiments, the one or more (e.g., one, two, three, four, five or six or more) photosynthetic microorganism(s) includes a cyanobacterium. In some embodiments, the cyanobacterium is a non-nitrogen fixing cyanobacterium. In some embodiments, the cyanobacterium is a nitrogen-fixing cyanobacterium. Non-limiting examples of cyanobacterium include: Nostoc sp., Microcoleus sp., Phormidium sp., Anabaena sp., Cyanothece sp., Leptolyngbya sp., Porphyrosiphon sp., Scytonema sp., Symploca sp., and Schizothrix sp. In some embodiments, the cyanobacterium is selected from the group consisting of Nostoc commune, Nostoc longstaffi, Nostoc calcicola, Nostoc muscorum, Anabaena verrucosa, and Anabaena 33047.

In some embodiments, the one or more (e.g., one, two, three, four, five, or six or more) photosynthetic microorganism(s) includes a non-cyanobacterium photosynthetic microorganism. In some embodiments, the non-cyanobacterium photosynthetic microorganism does not have nitrogen-fixing activity. In some embodiments, the non-cyanobacterium photosynthetic microorganism is a nitrogen-fixing bacterium. Non-limiting examples of non-cyanobacterium include: Rhodospirillaceae sp., Chromatiaceae sp., Chlorobiaceae sp., Chloroflexaceae sp., and Heliobacteriaceae sp. For example, the one or more non-cyanobacterium are selected from Rhodospirillaceae sp., Chromatiaceae sp., Chlorobiaceae sp., Chloroflexaceae sp., and Heliobacteriaceae sp.

In some embodiments, the one or more (e.g., one, two, three, four, five, or six or more) photosynthetic microorganism(s) include a eukaryotic microorganism. In some embodiments, the eukaryotic microorganism is selected from the group consisting of: Chlamydomonas sp., Dunaliella sp., Scenedesmus sp., Chlorella sp., Prototheca sp., and Botryococcus sp. In some embodiments, the one or more photosynthetic microorganisms are selected from the group consisting of: Synechocystis sp., Synechococcus sp., Prochlorococcus sp., Anabaena catenula sp., Anabaena minutissima sp., Anabaena subcylindrica sp., Nostoc parmeloides sp., Nodularia spumigena sp., Desertella californica sp., Microcoleus vaginatus sp., and Thermosynechococcus sp.

In some embodiments, the one or more (e.g., one, two, three, four, five, or six or more) photosynthetic microorganisms (e.g., any of the photosynthetic microorganisms described herein or known in the art) secrete nucleobases, nucleobase derivatives, or both when exposed to analogs selected from the group consisting of 8-azaguanine, 6-azauracil, 2-diazo-5-oxo-L-norleucine, decoyinine, and 6-mercaptoguanine. In some embodiments, the one or more (e.g., one, two, three, four, five, or six or more) photosynthetic microorganisms (e.g., any of the photosynthetic microorganisms described herein or known in the art) secrete aspartate family amino acids, branched-chain amino acids or both when exposed to one or more analogs selected from the group consisting of norleucine, S-2-aminoethyl-L-cysteine, ethionine, methyl-methionine, and hydroxynorvaline.

In some embodiments, the agriculture composition produces one or both carbon species of the group consisting of sugars, fatty acids, and organic acids. In some embodiments, the microbial composition produces one or more nitrogen species from the group consisting of nitrate, ammonia, ammonium, and amine(s). In some embodiments, the microbial composition produces one or more molecules containing carbon and nitrogen form the group consisting of amino acids, amino sugars, nucleobases, and sesquiterpene lactones. In some embodiments the produced nucleobases and/or their nucleoside include one or more nucleobases from the group consisting of cytosine, thymine, adenine, guanine, xanthine, and hypoxanthine. In some embodiments, the produced amino acids include one or more aspartate family amino acids from the group consisting of aspartic acid, asparagine, methionine, and threonine. In some embodiments, the produced amino acids include one or more branch chain amino acids from the group consisting of isoleucine, leucine, and valine.

In some embodiments, the microbial composition also includes one or more (e.g., one, two, three, four, five or six or more) heterotrophic microorganism(s) (e.g., any of the exemplary heterotrophic microorganisms described herein or known in the art). In some embodiments, the one or more heterotrophic microorganism(s) further comprise one or more nitrogen-fixing heterotrophic microorganism(s) (e.g., any of the exemplary heterotrophic microorganisms described herein or known in the art). In some embodiments, the one or more (e.g., one, two, three, four, five or six) heterotrophic microorganism(s) (e.g., any of the exemplary heterotrophic microorganisms described herein or known in the art) solubilize one or more of potassium, iron, and phosphorous when the microbial composition is exposed to conditions sufficient to solubilize one or more of potassium, iron, and phosphorous. In some embodiments, the one or more heterotrophic microorganism(s) (e.g., any of the heterotrophic microorganisms described herein or known in the art) store phosphorous in the form of polyphosphate.

In some embodiments, the one or more heterotrophic microorganism(s) includes an Azotobacter species. In some embodiments, the one or more heterotrophic microorganism(s) include Pink-Pigmented Facultative Methylotroph (PPFM). In some embodiments, the one or more heterotrophic microorganism(s) include Bacillus sp.

In some embodiments, the one or more heterotrophic microorganism(s) include fungi. In some embodiments, the fungus is a member of either Arbuscular mycorrhiza, ericoid mycorrhiza, or ectomycorrhizal, or a combination thereof. In some embodiments, the one or more heterotrophic microorganism(s) comprises a methanotrophic microorganism. In some embodiments, the methanotrophic microorganism is Methylomicrobium buryatense.

In some embodiments, the one or more heterotrophic microorganism(s) (e.g., any of the heterotrophic microorganisms described herein or known in the art) produce and secrete an exopolysaccharide; and the exopolysaccharide (EPS) improves water-holding capacity of soil. For example, the heterotrophic microorganism(s) can produce and secrete an exopolysaccharide that increases the formation of soil microaggregation as compared to the level of a control soil not contacted with any one of the microbial compositions described herein. In some embodiments, the one or more heterotrophic microorganism(s) (e.g., any of the heterotrophic microorganisms described herein or known in the art) produce a peptide or a chemical, and the peptide or chemical improves water-holding capacity of soil. For example, the heterotrophic microorganism(s) can produce and secrete a chemical that increases the formation of soil microaggregation (e.g., increasing water-holding capacity of the soil) as compared to the level of a control soil not contacted with any one of the microbial compositions described herein.

In some embodiments, the microbial composition forms soil microaggregates, wherein the soil microaggregates improve the water-holding capacity of soil. For example, the microbial composition can increase the formation of soil microaggregation as compared to the level of a control soil not contacted with any one of the microbial compositions described herein. In some embodiments, the increase in microaggregation formation is due at least in part to the peptide or chemical (e.g., EPS) produced or secreted by any of the one or more heterotrophic microorganisms (e.g., any of the exemplary heterotrophic microorganisms described herein or known in the art) and/or one or more photosynthetic microorganisms (e.g., any of the exemplary photosynthetic microorganisms described herein or known in the art) included in the microbial composition.

In embodiments, the microbial composition produces organic matter. For example, the microbial composition can increase in organic matter in the soil as compared to the level of a control soil not contacted with any one of the microbial compositions described herein. In some embodiments, the increase in organic matter is due at least in part to the one or more heterotrophic microorganisms (e.g., any of the exemplary heterotrophic microorganisms described herein or known in the art) and/or one or more photosynthetic microorganisms (e.g., any of the exemplary photosynthetic microorganisms described herein or known in the art) included in the microbial composition.

In some embodiments, the microbial composition increases vegetation growth in different soil types as compared to the level of a control soil not contacted with any one of the microbial compositions described herein. In some embodiments, the microbial composition increases plant growth in different soil types with vegetation as compared to the level of a control soil not contacted with any one of the microbial compositions described herein. In some embodiments, the microbial composition increases vegetation growth in different soil types without vegetation as compared to the level of a control soil not contacted with any one of the microbial compositions described herein.

In some embodiments, the microbial composition protects vegetation against one or more (e.g., one, two, three, four, five, six, or seven) plant pathogen(s) (e.g., any of the exemplary plant pathogens described herein or known in the art). For example, the microbial composition can increase the levels of protection of vegetation against one or more (e.g., one, two, three, four, five, six, or seven) plant pathogen(s) (e.g., any of the exemplary plant pathogens described herein or known in the art) as compared to the level of a control soil not contacted with any one of the microbial compositions described herein. Non-limiting examples of plant pathogens include: fungi, fungal-like organisms, bacteria, phytoplasmas, viruses, viroids, and nematodes. In some embodiments, the microbial composition protects vegetation against one or more (e.g., one, two, three, four, five, six, or seven) plant pathogen(s) (e.g., any of the exemplary plant pathogens described herein or known in the art) by removing, inhibiting, or otherwise blocking plant pathogen interference with vegetation growth and/or production. For example, the microbial composition can remove, inhibit, or otherwise block one or more plant pathogens from interfering with vegetation growth and/or production as compared to the level of a control soil not contacted with any one of the microbial compositions described herein. In some embodiments, the microbial composition protects vegetation against one or more (e.g., one, two, three, four, five, six, or seven) plant pathogen(s) (e.g., any of the exemplary plant pathogens described herein or known in the art) by producing one or more molecules that protect the vegetation against the one or more pathogen(s).

In some embodiments, the microbial composition protects against one or more (e.g., one, two, three, four or five or more) pests (e.g., any of the pests described herein or known in the art). For example, the microbial composition can increase the level of protection against one or more (e.g., one, two, three, four or five or more) pests (e.g., any of the pests described herein or known in the art) as compared to the level of a control soil not contacted with any one of the microbial compositions described herein. Non-limiting examples of pests include: wireworm, bean nodule fly, grub worms, cutworms, lesser corn stalk borer, Dectes stem borer, Kudzu bug, aphid, corn earworm, stink bug complex, grasshopper, bean leaf beetle, soybean looper, green clover worm, velvet bean caterpillar, fall army worm, Japanese beetle, cutworms, Thrips, corn rootworm, Chinch bug, and white grub. In some embodiments, the microbial composition protects vegetation against one or more (e.g., one, two, three, four, five, six, or seven) pest(s) (e.g., any of the exemplary pest(s) described herein or known in the art) by removing, inhibiting, or otherwise blocking the pests ability to interfere with vegetation growth and/or production. For example, the microbial composition can remove, inhibit, or otherwise block one or more pests from interfering with vegetation growth and/or production as compared to the level of a control soil not contacted with any one of the microbial compositions described herein. In some embodiments, the microbial composition protects against one or more (e.g., one, two, three, four or five or more) pests (e.g., any of the pests described herein or known in the art) by producing one or more molecules that protect that vegetation against the one or more pest(s).

In some embodiments, the microbial composition promotes the growth of vegetation by the production of factors including phytohormones and plant growth-promoting factors. For example, the microbial composition can promote the growth of vegetation (e.g., by the production of factors including phytohormones and plant growth-promoting factors) as compared to the level of a control soil not contacted with any one of the microbial compositions described herein.

In some embodiments, the microbial composition produces molecules having one or more of insecticidal, herbicidal, anti-fungal, weed controlling, and seed germination activity. In some embodiments, the microbial composition includes a bacterial insecticide (e.g., a bacterium that provides biological control of insect pests). In some embodiments, the microbial composition includes a bacterial herbicide (e.g., a bacterium that provides biological control of weeds). In some embodiments, the microbial composition includes a bioherbicide (e.g., a bacterium that provides biological control of weeds). In some embodiments, the microbial compositions include a bacterium having anti-fungal activity. In some embodiments, the microbial composition includes a microorganism (e.g., a bacterium, a virus, and/or a fungi) that includes insecticidal, herbicidal, anti-fungal, weed-controlling, and seed germination activity.

In some embodiments, the microbial composition promotes root growth of vegetation. In some embodiments, the microbial composition promotes root growth of vegetation through modification of rhizosphere and promoting an oxygenic environment around root(s). For example, the microbial composition can increase root growth of vegetation (e.g., through modification of rhizosphere and promoting an oxygenic environment around root(s)) as compared to the level of a control soil not contacted with any one of the microbial compositions described herein.

In some embodiments, the microbial compositions inhibit denitrification as compared to the level of denitrification in a control soil not contacted with any one of the microbial compositions described herein. Denitrification is a major source of nitrogen loss that negatively impacts plant productivity. Thus, the microbial composition includes any means by which the loss of nitrogen from the soil is prevented. In some embodiments, the microbial composition inhibits denitrification via production of oxygen by the photosynthetic microorganism(s). In some embodiments, the microbial composition can produce chemicals leading to the inhibition of denitrification. For example, the microbial composition can include chemicals that inhibit bacterial denitrification (e.g., the chemicals can inhibit aerobic and/or anaerobic denitrification). Non-limiting examples of chemicals that can be produced by the microbial composition and that inhibit denitrification include procyanidins. In one example, the microbial composition can produce a chemical (e.g., procyanidins) that increases the level of denitrification inhibition in the soil (e.g., increasing the level of nitrogen in the soil) as compared to the level of a control soil not contacted with any one of the microbial compositions described herein.

In some embodiments, the one or more photosynthetic microorganism(s) (e.g., any of the exemplary photosynthetic microorganisms described herein or know in the art) and/or the one or more heterotrophic microorganism(s) (e.g., any of the exemplary heterotrophic microorganisms described herein or know in the art) are tolerant to biotic/abiotic conditions. Non-limiting examples of abiotic factors include: light, temperature, water, acidity, UV radiation, atmosphere, low-nutrient content, and low-soil-moisture content. Non-limiting examples of biotic factors include: other microorganisms, pests, pathogens, and vegetation.

In some embodiments, the one or more photosynthetic microorganism(s) (e.g., any of the exemplary photosynthetic microorganisms described herein or know in the art) and/or the one or more heterotrophic microorganism(s) (e.g., any of the exemplary heterotrophic microorganisms described herein or know in the art) are tolerant to one or more of minerals, a herbicide, and an insecticide.

In some embodiments, the one or more photosynthetic microorganism(s) (e.g., any of the exemplary photosynthetic microorganisms described herein or know in the art) and/or the one or more heterotrophic microorganism(s) (e.g., any of the exemplary heterotrophic microorganisms described herein or know in the art) have previously been exposed to a chemical mutagen. Non-limiting examples of mutagens include ethyl methanesulfonate, methyl methanesulfonate, and ethyl nitrosourea.

In some examples, the one or more heterotrophic microorganism(s) solubilize one or more (e.g., one, two, or three) of potassium, iron, and phosphate, when the microbial composition is exposed to conditions sufficient to solubilize one or more (e.g., one, two, or three) of potassium, iron, and phosphate.

In some examples, the microbial compositions include one or more heterotrophic microorganism(s) that produce an exopolysaccharide.

In some embodiments, the one or more nitrogen-fixing microorganisms and/or the one or more heterotrophic microorganism(s) have previously been exposed to a chemical mutagen (e.g., one or more of ethyl methanesulfonate, methyl methanesulfonate, and ethyl nitrosourea). In some examples, the one or more heterotrophic microorganism(s) includes an Azotobacter species. In some examples, the one or more heterotrophic microorganism(s) can PPFM, Bacillus sp. and/or fungi such as Arbuscular mycorrhiza, ericoid mycorrhiza, or ectomycorrhizal, or a combination thereof. In some examples, the one or more heterotrophic microorganism(s) includes a methanotrophic microorganism (e.g., Methylomicrobium buryatense).

In some embodiments, at least one of the one or more nitrogen-fixing microorganism(s) are isolated from a soil or a marine environment. In some embodiments, the one or more nitrogen-fixing microorganisms are isolated from a plant. In some embodiments, the one or more nitrogen-fixing microorganisms can be obtained from the American Type Culture Collection (ATCC).

Also provided are microbial compositions that include: (a) one or more of Synechocystis sp., Synechococcus sp., Prochlorococcus sp., and Thermosynechococcus sp. (b) one or more (e.g., one, two, three, four, five, six, seven, eight, nine, or ten) heterotrophic microorganism(s) (e.g., any of the heterotrophic microorganisms described herein); and (c) one or more (e.g., one, two, three, four, five, six, seven, eight, nine, or ten) agricultural adjuvant(s) (e.g., any of the agricultural adjuvants described herein or known in the art), where the microbial composition produces one or both of carbon (e.g., sugars and fatty acids) and the nitrogen (e.g., ammonia) and reduced carbon and nitrogen species (e.g., amino sugars, amino acids, and nucleobases), when the microbial composition is exposed to conditions sufficient to produce one or more (e.g., one, two, or three) of carbon, nitrogen, and organic matter. In some examples, the one or more heterotrophic microorganism(s) solubilize one or more (e.g., one, two, or three) of potassium, iron, phosphate, and phosphorous when the microbial composition is exposed to conditions sufficient to solubilize one or more (e.g., one, two, or three) of potassium, iron, and phosphate. In some examples, the one or more heterotrophic microorganism(s) can store phosphorous in the form of polyphosphate. In some examples, the one or more heterotrophic microorganism(s) produce and secrete an exopolysaccharide.

In some examples, the one or more nitrogen-fixing microorganisms and/or the one or more heterotrophic microorganism(s) have previously been exposed to a chemical mutagen (e.g., one or more of ethyl methanesulfonate, methyl methanesulfonate, and ethyl nitrosourea). In some examples, the one or more heterotrophic microorganism(s) comprises an Azotobacter species. In some examples, the one or more heterotrophic microorganism(s) comprises a methanotrophic microorganism (e.g., Methylomicrobium buryatense).

In some embodiments of any of the microbial compositions described herein, the ratio of one or more photosynthetic microorganism(s) to one or more heterotrophic microorganism(s) includes a ratio of: 10:1, 5:1, 4:1, 3:1, 2:1, 1:1, 1:2, 1:3, 1:4, 1:5, and 1:10. Non-limiting examples of a ratio of one or more photosynthetic microorganism(s) to one or more heterotrophic microorganism(s) includes: total number of one or more photosynthetic microorganism(s) to total number of one or more heterotrophic microorganism(s) and total amount (e.g., mass, weight by weight, weight by volume, or concentration of microorganisms) of one or more photosynthetic microorganism(s) to total amount (e.g., mass, weight by weight, weight by volume, or concentration of microorganisms) of one or more heterotrophic microorganism(s). In some embodiments, the ratio of one or more photosynthetic microorganism(s) to one or more heterotrophic microorganisms can be the ratio of the total number of different species of photosynthetic microorganisms to the total number of different species of heterotrophic microorganisms.

In some examples, at least one of the one or more non-nitrogen-fixing microorganism(s) are isolated from a soil or a marine environment. In some examples, at least one of the one or more non-nitrogen-fixing microorganism(s) are isolated from a plant.

In some examples of any of the microbial compositions described herein, the microbial composition can be a crop dusting composition or a seed-coating composition. In some embodiments of any of the microbial compositions described herein, the microbial composition can be pressurized material that can be aerosolized before application to a soil and/or the surface of a plant or seed. In some embodiments of any of the microbial compositions described herein, the microbial composition can be formulated as a liquid. In some embodiments of any of the microbial compositions described herein, the microbial composition can be formulated a solid (e.g., a powder). In some embodiments of any of the microbial compositions described herein, the microbial compositions can be provided a dry composition that can be reconstituted in a liquid (e.g., water) before it is administered to a soil and/or a surface of a plant or seed.

In some embodiments of any of the microbial compositions described herein, the microbial compositions can be contacted with soil where the environmental source of the soil is non-agricultural land. As used herein “non-agricultural land” can refer to land upon which no agricultural activities are conducted and/or from which no agricultural products are derived.

### Microorganisms

Non-limiting examples of nitrogen-fixing microorganism(s) include cyanobacteria. Non-limiting examples of nitrogen-fixing microorganisms include of Nostoc sp., Microcoleus sp., Phormidium sp., Cyanothece sp., Leptolyngbya sp., Porphyrosiphon sp., Scytonema sp., Symploca sp., Schizothrix sp., and Anabaena sp. In some embodiments, one or more nitrogen-fixing microorganisms is selected from: Nostoc commune; Nostoc longstaffi; Nostoc calcicola; Anabaena 33047; Nostoc muscorum; and Anabaena verrucosa.

Non-limiting examples of non-nitrogen-fixing microorganisms include Synechocystis sp., and Synechococcus sp., Prochlorococcus sp., Thermosynechococcus sp.

Non-limiting examples of heterotrophic microorganisms include methanotrophic microorganisms (e.g., Methylomicrobium buryatense), an Azotobacter species, Pink-Pigmented Facultative Methylotroph, Bacillus species, and Fungi such as Arbuscular mycorrhiza or ericoid mycorrhiza or ectomycorrhizal or a combination of these.

Non-limiting examples of photosynthetic microorganisms include Synechocystis sp., Synechococcus sp., Prochlorococcus sp., Anabaena catenula sp., Anabaena minutissima sp., Anabaena subcylindrica sp., Nostoc parmeloides sp., Nodularia spumigena sp., Desertella californica sp., Microcoleus vaginatus sp., and Thermosynechococcus sp.

### Agricultural Adjuvants and Excipients

Any of the microbial compositions provided herein can include one or more excipient(s). An excipient can be a medium (e.g., an inactive substance) that can facilitate the delivery of the microorganism(s) included in the microbial composition. In some examples, the excipient can be an agricultural adjuvant.

Non-limiting examples of agricultural adjuvants include wetting agents, colorants, emulsifiers, penetrating agents, humectants, suppressants, drift control agents, water conditioning agents, depositing agents, acidifying agents, and/or sticking agents, etc. Additional examples of agricultural adjuvants are known in the art. The described examples of agricultural adjuvants can be added to the described microbial composition individually, or in combination with each other. For example, the described microbial composition can include one or more (e.g., two, three, four, five, six, seven, eight, nine, or ten) of any of the exemplary agricultural adjuvants described herein or known in the art.

In some embodiments, the one or more (e.g., one, two, three, four, five, six, seven, eight, nine or ten) agricultural adjuvants include properties (e.g., any of the properties described herein or known in the art) in addition to the property of facilitating the delivery of microorganism. Non-limiting examples of additional properties provided by an adjuvant include promoting plant growth, promoting growth of the one or more photosynthetic microorganism(s) and/or the one or more heterotrophic microorganisms(s) present in the microbial composition, and protecting against heat and/or drought.

A wetting agent can contain surface-active ingredients (e.g., surfactants) that can reduce the contact angle of a droplet of the described microbial composition on the target (e.g., the soil or plant). This can allow a microbial composition to contact more of the soil surface. The surfactants included in the wetting agent can be non-ionic, cationic, anionic, or amphoteric surfactants. A wetting agent can include surfactant molecules that have a lipophilic end and a hydrophilic end. Exemplary wetting agents include fatty amines, glucosides, alkylphenols, alkylamine ethoxylates, polyethylene oxides, and/or organosilicons.

A colorant can alter the color of a microbial composition such that a user can apply the microbial composition in a desired location. Some examples of colorants are inert and can include yellow #5, red #40, and blue #1, among others. A colorant can increase the precision of application of a microbial composition.

An emulsifier can distribute the described microbial composition within a solution. Some examples of an emulsifier include anionic surfactants (e.g., calcium salt of alkylbenzenesulfonate) and nonionic surfactants (e.g., polyoxyethylene alkylphenyl ethers), which can be mixed.

A penetrating agent is an agent that helps a microbial composition enter the target (e.g., soil) once the microbial composition is deposited or delivered. Some examples of penetrating agents can include petroleum oils, vegetable oils, and/or modified vegetable oils.

A humectant is an agent that reduces evaporation of a microbial composition before and after it reaches the target (e.g., soil or a plant). Examples of humectants include glycerin, various glycols, petroleum oils, vegetable oils, and/or urea.

A foam suppressant is an agent that reduces or prevents foaming of a microbial composition when it is deposited on the soil or a plant, or during delivery of the microbial composition to a soil or a plant. An example of a foam suppressant is a silicone/carbon polymer (e.g., dimethylpolysiloxane).

A drift control agent is an agent that can prevent and/or reduce the portion of the microbial composition distributed outside of a certain diameter after its delivery to a target soil or plant. Small droplets of a microbial composition can be more susceptible to drift. For example, the smaller the droplet, the farther it can move with wind. Examples of a drift control agent can include polyacrylamides and polysaccharides.

A water conditioner is an agent that can eliminate or reduce the interaction of ions a microbial composition. For example, efficacy can be reduced when hard water is used in the distribution of a microbial composition. A range of materials including chelating agents, citric acids, and/or fertilizer salts, such as ammonium sulfate and/or ammonium nitrate, can be used as water conditioners to improve the delivery of a microbial composition to soil or a plant when a water source contains hard water.

A deposition agent is an agent that improves the amount of a microbial composition deposited on the soil, and can indirectly reduce drift and/or improve the uniformity of deposit of a microbial composition. Examples of depositing agents can include oil-based concentrates, inverting oils, polymer formulations, etc.

An acidifying agent is an agent that decreases the pH of a microbial composition. An example of an acidifying agent can be a dilute strong acid solution (e.g., chloric acid, hydrobromic acid, hydrochloric acid, hydroiodic acid, nitric acid, perchloric acid, and/or sulfuric acid).

A buffer is an agent that works to resist change in the pH of a microbial composition. Buffers can limit the change in the pH of a microbial composition when an acid or base is added to the described microbial composition. A buffer/acidifier will reduce pH can be used to hold the pH of a microbial composition in a certain range. Example of buffers/acidifiers include phosphates or organic acids.

A sticking agent is a non-evaporating ingredient that is used to resist dislodging of a microbial composition from its target (e.g., soil or a plant). Examples of sticking agent ingredients include synthetic latex, low volatile oils, pinene polymer, water-soluble polymers, and resins, etc.

In some embodiments, the microbial composition includes one or more (e.g., one, two, three, or four) excipients select from biochar, activated char, polyacrylamide, and polyaspartate. In addition to serving as an agricultural excipient Biochar and activated char can be used to help build soil, conserve water and sequester carbon.

### Methods of Generating a Microbial Composition

Also provided herein are methods of generating a composition (e.g., a microbial composition) that include: (a) providing a combination of: (i) one or more (e.g., one, two, three, four, or five) photosynthetic microorganisms (e.g., any of the one or more photosynthetic microorganisms described herein); (ii) one or more (e.g., one, two, three, four, or five) nitrogen-fixing microorganisms (e.g., any of the one or more nitrogen-fixing microorganisms described herein); (b) determining a level of one or more activities of the combination selected from: production of one or more carbon species; production of one or more nitrogen species; production of one or more molecule(s) containing carbon and nitrogen; production of organic matter; soil water-holding capacity; growth in different soil types with or without vegetation; protection of vegetation against plant pathogens; protection of vegetation against pests; promotion of growth of vegetation; production of molecules having one or more of insecticidal, herbicidal, anti-fungal, weed controlling, and seed germination activity; promotion of root growth of vegetation; and inhibition of denitrification; (c) selecting a combination having an elevated level of the one or more activities as compared to a control level(s); and (d) producing a microbial composition comprising the selected combination and one or more agricultural excipient(s).

In some embodiments, at least one of the one or more nitrogen-fixing microorganisms is selected from the group of: Nostoc commune, Nostoc longstaffi, Nostoc calcicola, and Anabaena 33047.

In some embodiments, the method includes selecting a combination having an elevated level (e.g., at least a 1% increase, at least a 5% increase, at least a 10% increase, at least a 15% increase, at least a 20% increase, at least a 25% increase, at least a 30% increase, at least a 35% increase, at least a 40% increase, at least a 45% increase, at least a 50% increase, at least a 60% increase, at least a 70% increase, at least a 80% increase, at least a 90% increase, at least a 100% increase, at least a 110% increase, at least a 120% increase, at least a 130% increase, at least a 140% increase, at least a 150% increase, at least a 160% increase, at least a 170% increase, at least a 180% increase, at least a 190% increase, at least a 200% increase, at least a 220% increase, at least a 240% increase, at least a 260% increase, at least a 280% increase, at least a 300% increase, at least a 320% increase, at least a 340% increase, at least a 360% increase, at least a 380% increase, at least a 400% increase, at least a 420% increase, at least a 440% increase, at least a 460% increase, at least a 480% increase, at least a 500% increase, at least a 520% increase, at least a 540% increase, at least a 560% increase, at least a 580% increase, at least a 600% increase, at least a 620% increase, at least a 640% increase, at least a 660% increase, at least a 680% increase, at least a 700% increase, at least a 720% increase, at least a 740% increase, at least a 760% increase, at least a 780% increase, at least a 800% increase, at least a 820% increase, at least a 840% increase, at least a 860% increase, at least a 880% increase, at least a 900% increase, at least a 920% increase, at least a 940% increase, at least a 960% increase, at least a 980% increase, or at least a 1,000% increase, or about a 1% to about a 1,000% increase, about a 1% to about a 950% increase, about a 1% to about a 900% increase, about a 1% to about a 850% increase, about a 1% to about a 800% increase, about a 1% to about a 750% increase, about a 1% to about a 700% increase, about a 1% to about a 650% increase, about a 1% to about a 600% increase, about a 1% to about a 550% increase, about a 1% to about a 500% increase, about a 1% to about a 450% increase, about a 1% to about a 400% increase, about a 1% to about a 350% increase, about a 1% to about a 300% increase, about a 1% to about a 250% increase, about a 1% to about a 200% increase, about a 1% to about a 180% increase, about a 1% to about a 160% increase, about a 1% to about a 140% increase, about a 1% to about a 120% increase, about a 1% to about a 100% increase, about a 1% to about a 90% increase, about a 1% to about a 80% increase, about a 1% to about a 70% increase, about a 1% to about a 60% increase, about a 1% to about a 50% increase, about a 1% to about a 40% increase, about a 1% to about a 30% increase, about a 1% to about a 20% increase, about a 1% to about a 10% increase, about a 1% to about a 5% increase, about a 5% to about a 1,000% increase, about a 5% to about a 950% increase, about a 5% to about a 900% increase, about a 5% to about a 850% increase, about a 5% to about a 800% increase, about a 5% to about a 750% increase, about a 5% to about a 700% increase, about a 5% to about a 650% increase, about a 5% to about a 600% increase, about a 5% to about a 550% increase, about a 5% to about a 500% increase, about a 5% to about a 450% increase, about a 5% to about a 400% increase, about a 5% to about a 350% increase, about a 5% to about a 300% increase, about a 5% to about a 250% increase, about a 5% to about a 200% increase, about a 5% to about a 180% increase, about a 5% to about a 160% increase, about a 5% to about a 140% increase, about a 5% to about a 120% increase, about a 5% to about a 100% increase, about a 5% to about a 90% increase, about a 5% to about a 80% increase, about a 5% to about a 70% increase, about a 5% to about a 60% increase, about a 5% to about a 50% increase, about a 5% to about a 40% increase, about a 5% to about a 30% increase, about a 5% to about a 20% increase, about a 5% to about a 10% increase, about a 10% to about a 1,000% increase, about a 10% to about a 950% increase, about a 10% to about a 900% increase, about a 10% to about a 850% increase, about a 10% to about a 800% increase, about a 10% to about a 750% increase, about a 10% to about a 700% increase, about a 10% to about a 650% increase, about a 10% to about a 600% increase, about a 10% to about a 550% increase, about a 10% to about a 500% increase, about a 10% to about a 450% increase, about a 10% to about a 400% increase, about a 10% to about a 350% increase, about a 10% to about a 300% increase, about a 10% to about a 250% increase, about a 10% to about a 200% increase, about a 10% to about a 180% increase, about a 10% to about a 160% increase, about a 10% to about a 140% increase, about a 10% to about a 120% increase, about a 10% to about a 100% increase, about a 10% to about a 90% increase, about a 10% to about a 80% increase, about a 10% to about a 70% increase, about a 10% to about a 60% increase, about a 10% to about a 50% increase, about a 10% to about a 40% increase, about a 10% to about a 30% increase, about a 10% to about a 20% increase, about a 20% to about a 1,000% increase, about a 20% to about a 950% increase, about a 20% to about a 900% increase, about a 20% to about a 850% increase, about a 20% to about a 800% increase, about a 20% to about a 750% increase, about a 20% to about a 700% increase, about a 20% to about a 650% increase, about a 20% to about a 600% increase, about a 20% to about a 550% increase, about a 20% to about a 500% increase, about a 20% to about a 450% increase, about a 20% to about a 400% increase, about a 20% to about a 350% increase, about a 20% to about a 300% increase, about a 20% to about a 250% increase, about a 20% to about a 200% increase, about a 20% to about a 180% increase, about a 20% to about a 160% increase, about a 20% to about a 140% increase, about a 20% to about a 120% increase, about a 20% to about a 100% increase, about a 20% to about a 90% increase, about a 20% to about a 80% increase, about a 20% to about a 70% increase, about a 20% to about a 60% increase, about a 20% to about a 50% increase, about a 20% to about a 40% increase, about a 20% to about a 30% increase, about a 30% to about a 1,000% increase, about a 30% to about a 950% increase, about a 30% to about a 900% increase, about a 30% to about a 850% increase, about a 30% to about a 800% increase, about a 30% to about a 750% increase, about a 30% to about a 700% increase, about a 30% to about a 650% increase, about a 30% to about a 600% increase, about a 30% to about a 550% increase, about a 30% to about a 500% increase, about a 30% to about a 450% increase, about a 30% to about a 400% increase, about a 30% to about a 350% increase, about a 30% to about a 300% increase, about a 30% to about a 250% increase, about a 30% to about a 200% increase, about a 30% to about a 180% increase, about a 30% to about a 160% increase, about a 30% to about a 140% increase, about a 30% to about a 120% increase, about a 30% to about a 100% increase, about a 30% to about a 90% increase, about a 30% to about a 80% increase, about a 30% to about a 70% increase, about a 30% to about a 60% increase, about a 30% to about a 50% increase, about a 30% to about a 40% increase, about a 40% to about a 1,000% increase, about a 40% to about a 950% increase, about a 40% to about a 900% increase, about a 40% to about a 850% increase, about a 40% to about a 800% increase, about a 40% to about a 750% increase, about a 40% to about a 700% increase, about a 40% to about a 650% increase, about a 40% to about a 600% increase, about a 40% to about a 550% increase, about a 40% to about a 500% increase, about a 40% to about a 450% increase, about a 40% to about a 400% increase, about a 40% to about a 350% increase, about a 40% to about a 300% increase, about a 40% to about a 250% increase, about a 40% to about a 200% increase, about a 40% to about a 180% increase, about a 40% to about a 160% increase, about a 40% to about a 140% increase, about a 40% to about a 120% increase, about a 40% to about a 100% increase, about a 40% to about a 90% increase, about a 40% to about a 80% increase, about a 40% to about a 70% increase, about a 40% to about a 60% increase, about a 40% to about a 50% increase, about a 50% to about a 1,000% increase, about a 50% to about a 950% increase, about a 50% to about a 900% increase, about a 50% to about a 850% increase, about a 50% to about a 800% increase, about a 50% to about a 750% increase, about a 50% to about a 700% increase, about a 50% to about a 650% increase, about a 50% to about a 600% increase, about a 50% to about a 550% increase, about a 50% to about a 500% increase, about a 50% to about a 450% increase, about a 50% to about a 400% increase, about a 50% to about a 350% increase, about a 50% to about a 300% increase, about a 50% to about a 250% increase, about a 50% to about a 200% increase, about a 50% to about a 180% increase, about a 50% to about a 160% increase, about a 50% to about a 140% increase, about a 50% to about a 120% increase, about a 50% to about a 100% increase, about a 50% to about a 90% increase, about a 50% to about a 80% increase, about a 50% to about a 70% increase, about a 50% to about a 60% increase, about a 60% to about a 1,000% increase, about a 60% to about a 950% increase, about a 60% to about a 900% increase, about a 60% to about a 850% increase, about a 60% to about a 800% increase, about a 60% to about a 750% increase, about a 60% to about a 700% increase, about a 60% to about a 650% increase, about a 60% to about a 600% increase, about a 60% to about a 550% increase, about a 60% to about a 500% increase, about a 60% to about a 450% increase, about a 60% to about a 400% increase, about a 60% to about a 350% increase, about a 60% to about a 300% increase, about a 60% to about a 250% increase, about a 60% to about a 200% increase, about a 60% to about a 180% increase, about a 60% to about a 160% increase, about a 60% to about a 140% increase, about a 60% to about a 120% increase, about a 60% to about a 100% increase, about a 60% to about a 90% increase, about a 60% to about a 80% increase, about a 60% to about a 70% increase, about a 70% to about a 1,000% increase, about a 70% to about a 950% increase, about a 70% to about a 900% increase, about a 70% to about a 850% increase, about a 70% to about a 800% increase, about a 70% to about a 750% increase, about a 70% to about a 700% increase, about a 70% to about a 650% increase, about a 70% to about a 600% increase, about a 70% to about a 550% increase, about a 70% to about a 500% increase, about a 70% to about a 450% increase, about a 70% to about a 400% increase, about a 70% to about a 350% increase, about a 70% to about a 300% increase, about a 70% to about a 250% increase, about a 70% to about a 200% increase, about a 70% to about a 180% increase, about a 70% to about a 160% increase, about a 70% to about a 140% increase, about a 70% to about a 120% increase, about a 70% to about a 100% increase, about a 70% to about a 90% increase, about a 70% to about a 80% increase, about a 80% to about a 1,000% increase, about a 80% to about a 950% increase, about a 80% to about a 900% increase, about a 80% to about a 850% increase, about a 80% to about a 800% increase, about a 80% to about a 750% increase, about a 80% to about a 700% increase, about a 80% to about a 650% increase, about a 80% to about a 600% increase, about a 80% to about a 550% increase, about a 80% to about a 500% increase, about a 80% to about a 450% increase, about a 80% to about a 400% increase, about a 80% to about a 350% increase, about a 80% to about a 300% increase, about a 80% to about a 250% increase, about a 80% to about a 200% increase, about a 80% to about a 180% increase, about a 80% to about a 160% increase, about a 80% to about a 140% increase, about a 80% to about a 120% increase, about a 80% to about a 100% increase, about a 80% to about a 90% increase, about a 90% to about a 1,000% increase, about a 90% to about a 950% increase, about a 90% to about a 900% increase, about a 90% to about a 850% increase, about a 90% to about a 800% increase, about a 90% to about a 750% increase, about a 90% to about a 700% increase, about a 90% to about a 650% increase, about a 90% to about a 600% increase, about a 90% to about a 550% increase, about a 90% to about a 500% increase, about a 90% to about a 450% increase, about a 90% to about a 400% increase, about a 90% to about a 350% increase, about a 90% to about a 300% increase, about a 90% to about a 250% increase, about a 90% to about a 200% increase, about a 90% to about a 180% increase, about a 90% to about a 160% increase, about a 90% to about a 140% increase, about a 90% to about a 120% increase, about a 90% to about a 100% increase, about a 100% to about a 1,000% increase, about a 100% to about a 950% increase, about a 100% to about a 900% increase, about a 100% to about a 850% increase, about a 100% to about a 800% increase, about a 100% to about a 750% increase, about a 100% to about a 700% increase, about a 100% to about a 650% increase, about a 100% to about a 600% increase, about a 100% to about a 550% increase, about a 100% to about a 500% increase, about a 100% to about a 450% increase, about a 100% to about a 400% increase, about a 100% to about a 350% increase, about a 100% to about a 300% increase, about a 100% to about a 250% increase, about a 100% to about a 200% increase, about a 100% to about a 180% increase, about a 100% to about a 160% increase, about a 100% to about a 140% increase, about a 100% to about a 120% increase, about a 120% to about a 1,000% increase, about a 120% to about a 950% increase, about a 120% to about a 900% increase, about a 120% to about a 850% increase, about a 120% to about a 800% increase, about a 120% to about a 750% increase, about a 120% to about a 700% increase, about a 120% to about a 650% increase, about a 120% to about a 600% increase, about a 120% to about a 550% increase, about a 120% to about a 500% increase, about a 120% to about a 450% increase, about a 120% to about a 400% increase, about a 120% to about a 350% increase, about a 120% to about a 300% increase, about a 120% to about a 250% increase, about a 120% to about a 200% increase, about a 120% to about a 180% increase, about a 120% to about a 160% increase, about a 120% to about a 140% increase, about a 140% to about a 1,000% increase, about a 140% to about a 950% increase, about a 140% to about a 900% increase, about a 140% to about a 850% increase, about a 140% to about a 800% increase, about a 140% to about a 750% increase, about a 140% to about a 700% increase, about a 140% to about a 650% increase, about a 140% to about a 600% increase, about a 140% to about a 550% increase, about a 140% to about a 500% increase, about a 140% to about a 450% increase, about a 140% to about a 400% increase, about a 140% to about a 350% increase, about a 140% to about a 300% increase, about a 140% to about a 250% increase, about a 140% to about a 200% increase, about a 140% to about a 180% increase, about a 140% to about a 160% increase, about a 160% to about a 1,000% increase, about a 160% to about a 950% increase, about a 160% to about a 900% increase, about a 160% to about a 850% increase, about a 160% to about a 800% increase, about a 160% to about a 750% increase, about a 160% to about a 700% increase, about a 160% to about a 650% increase, about a 160% to about a 600% increase, about a 160% to about a 550% increase, about a 160% to about a 500% increase, about a 160% to about a 450% increase, about a 160% to about a 400% increase, about a 160% to about a 350% increase, about a 160% to about a 300% increase, about a 160% to about a 250% increase, about a 160% to about a 200% increase, about a 160% to about a 180% increase, about a 180% to about a 1,000% increase, about a 180% to about a 950% increase, about a 180% to about a 900% increase, about a 180% to about a 850% increase, about a 180% to about a 800% increase, about a 180% to about a 750% increase, about a 180% to about a 700% increase, about a 180% to about a 650% increase, about a 180% to about a 600% increase, about a 180% to about a 550% increase, about a 180% to about a 500% increase, about a 180% to about a 450% increase, about a 180% to about a 400% increase, about a 180% to about a 350% increase, about a 180% to about a 300% increase, about a 180% to about a 250% increase, about a 180% to about a 200% increase, about a 200% to about a 1,000% increase, about a 200% to about a 950% increase, about a 200% to about a 900% increase, about a 200% to about a 850% increase, about a 200% to about a 800% increase, about a 200% to about a 750% increase, about a 200% to about a 700% increase, about a 200% to about a 650% increase, about a 200% to about a 600% increase, about a 200% to about a 550% increase, about a 200% to about a 500% increase, about a 200% to about a 450% increase, about a 200% to about a 400% increase, about a 200% to about a 350% increase, about a 200% to about a 300% increase, about a 200% to about a 250% increase, about a 250% to about a 1,000% increase, about a 250% to about a 950% increase, about a 250% to about a 900% increase, about a 250% to about a 850% increase, about a 250% to about a 800% increase, about a 250% to about a 750% increase, about a 250% to about a 700% increase, about a 250% to about a 650% increase, about a 250% to about a 600% increase, about a 250% to about a 550% increase, about a 250% to about a 500% increase, about a 250% to about a 450% increase, about a 250% to about a 400% increase, about a 250% to about a 350% increase, about a 250% to about a 300% increase, about a 300% to about a 1,000% increase, about a 300% to about a 950% increase, about a 300% to about a 900% increase, about a 300% to about a 850% increase, about a 300% to about a 800% increase, about a 300% to about a 750% increase, about a 300% to about a 700% increase, about a 300% to about a 650% increase, about a 300% to about a 600% increase, about a 300% to about a 550% increase, about a 300% to about a 500% increase, about a 300% to about a 450% increase, about a 300% to about a 400% increase, about a 300% to about a 350% increase, about a 350% to about a 1,000% increase, about a 350% to about a 950% increase, about a 350% to about a 900% increase, about a 350% to about a 850% increase, about a 350% to about a 800% increase, about a 350% to about a 750% increase, about a 350% to about a 700% increase, about a 350% to about a 650% increase, about a 350% to about a 600% increase, about a 350% to about a 550% increase, about a 350% to about a 500% increase, about a 350% to about a 450% increase, about a 350% to about a 400% increase, about a 400% to about a 1,000% increase, about a 400% to about a 950% increase, about a 400% to about a 900% increase, about a 400% to about a 850% increase, about a 400% to about a 800% increase, about a 400% to about a 750% increase, about a 400% to about a 700% increase, about a 400% to about a 650% increase, about a 400% to about a 600% increase, about a 400% to about a 550% increase, about a 400% to about a 500% increase, about a 400% to about a 450% increase, about a 450% to about a 1,000% increase, about a 450% to about a 950% increase, about a 450% to about a 900% increase, about a 450% to about a 850% increase, about a 450% to about a 800% increase, about a 450% to about a 750% increase, about a 450% to about a 700% increase, about a 450% to about a 650% increase, about a 450% to about a 600% increase, about a 450% to about a 550% increase, about a 450% to about a 500% increase, about a 500% to about a 1,000% increase, about a 500% to about a 950% increase, about a 500% to about a 900% increase, about a 500% to about a 850% increase, about a 500% to about a 800% increase, about a 500% to about a 750% increase, about a 500% to about a 700% increase, about a 500% to about a 650% increase, about a 500% to about a 600% increase, about a 500% to about a 550% increase, about a 550% to about a 1,000% increase, about a 550% to about a 950% increase, about a 550% to about a 900% increase, about a 550% to about a 850% increase, about a 550% to about a 800% increase, about a 550% to about a 750% increase, about a 550% to about a 700% increase, about a 550% to about a 650% increase, about a 550% to about a 600% increase, about a 600% to about a 1,000% increase, about a 600% to about a 950% increase, about a 600% to about a 900% increase, about a 600% to about a 850% increase, about a 600% to about a 800% increase, about a 600% to about a 750% increase, about a 600% to about a 700% increase, about a 600% to about a 650% increase, about a 650% to about a 1,000% increase, about a 650% to about a 950% increase, about a 650% to about a 900% increase, about a 650% to about a 850% increase, about a 650% to about a 800% increase, about a 650% to about a 750% increase, about a 650% to about a 700% increase, about a 700% to about a 1,000% increase, about a 700% to about a 950% increase, about a 700% to about a 900% increase, about a 700% to about a 850% increase, about a 700% to about a 800% increase, about a 700% to about a 750% increase, about a 750% to about a 1,000% increase, about a 750% to about a 950% increase, about a 750% to about a 900% increase, about a 750% to about a 850% increase, about a 750% to about a 800% increase, about a 800% to about a 1,000% increase, about a 800% to about a 950% increase, about a 800% to about a 900% increase, about a 800% to about a 850% increase, about a 850% to about a 1,000% increase, about a 850% to about a 950% increase, about a 850% to about a 900% increase, about a 900% to about a 1,000% increase, about a 900% to about a 950% increase, or about a 950% to about a 1,000% increase) of carbon as compared to a control level (e.g., a level present in a similar assay not containing the combination).

In some embodiments, the method includes selecting a combination having an elevated level (e.g., at least a 1% increase, at least a 5% increase, at least a 10% increase, at least a 15% increase, at least a 20% increase, at least a 25% increase, at least a 30% increase, at least a 35% increase, at least a 40% increase, at least a 45% increase, at least a 50% increase, at least a 60% increase, at least a 70% increase, at least a 80% increase, at least a 90% increase, at least a 100% increase, at least a 110% increase, at least a 120% increase, at least a 130% increase, at least a 140% increase, at least a 150% increase, at least a 160% increase, at least a 170% increase, at least a 180% increase, at least a 190% increase, at least a 200% increase, at least a 220% increase, at least a 240% increase, at least a 260% increase, at least a 280% increase, at least a 300% increase, at least a 320% increase, at least a 340% increase, at least a 360% increase, at least a 380% increase, at least a 400% increase, at least a 420% increase, at least a 440% increase, at least a 460% increase, at least a 480% increase, at least a 500% increase, at least a 520% increase, at least a 540% increase, at least a 560% increase, at least a 580% increase, at least a 600% increase, at least a 620% increase, at least a 640% increase, at least a 660% increase, at least a 680% increase, at least a 700% increase, at least a 720% increase, at least a 740% increase, at least a 760% increase, at least a 780% increase, at least a 800% increase, at least a 820% increase, at least a 840% increase, at least a 860% increase, at least a 880% increase, at least a 900% increase, at least a 920% increase, at least a 940% increase, at least a 960% increase, at least a 980% increase, or at least a 1,000% increase, or about a 1% to about a 1,000% increase (or any of the subranges of this range described herein)) of nitrogen as compared to a control level (e.g., a level present in a similar assay not containing the combination).

In some embodiments, the method includes selecting a combination having an elevated level (e.g., at least a 1% increase, at least a 5% increase, at least a 10% increase, at least a 15% increase, at least a 20% increase, at least a 25% increase, at least a 30% increase, at least a 35% increase, at least a 40% increase, at least a 45% increase, at least a 50% increase, at least a 60% increase, at least a 70% increase, at least a 80% increase, at least a 90% increase, at least a 100% increase, at least a 110% increase, at least a 120% increase, at least a 130% increase, at least a 140% increase, at least a 150% increase, at least a 160% increase, at least a 170% increase, at least a 180% increase, at least a 190% increase, at least a 200% increase, at least a 220% increase, at least a 240% increase, at least a 260% increase, at least a 280% increase, at least a 300% increase, at least a 320% increase, at least a 340% increase, at least a 360% increase, at least a 380% increase, at least a 400% increase, at least a 420% increase, at least a 440% increase, at least a 460% increase, at least a 480% increase, at least a 500% increase, at least a 520% increase, at least a 540% increase, at least a 560% increase, at least a 580% increase, at least a 600% increase, at least a 620% increase, at least a 640% increase, at least a 660% increase, at least a 680% increase, at least a 700% increase, at least a 720% increase, at least a 740% increase, at least a 760% increase, at least a 780% increase, at least a 800% increase, at least a 820% increase, at least a 840% increase, at least a 860% increase, at least a 880% increase, at least a 900% increase, at least a 920% increase, at least a 940% increase, at least a 960% increase, at least a 980% increase, or at least a 1,000% increase, or about a 1% to about a 1,000% increase (or any of the subranges of this range described herein)) of molecules containing carbon and nitrogen as compared to a control level (e.g., a level present in a similar assay not containing the combination).

In some embodiments, the method includes selecting a combination having an elevated level (e.g., at least a 1% increase, at least a 5% increase, at least a 10% increase, at least a 15% increase, at least a 20% increase, at least a 25% increase, at least a 30% increase, at least a 35% increase, at least a 40% increase, at least a 45% increase, at least a 50% increase, at least a 60% increase, at least a 70% increase, at least a 80% increase, at least a 90% increase, at least a 100% increase, at least a 110% increase, at least a 120% increase, at least a 130% increase, at least a 140% increase, at least a 150% increase, at least a 160% increase, at least a 170% increase, at least a 180% increase, at least a 190% increase, at least a 200% increase, at least a 220% increase, at least a 240% increase, at least a 260% increase, at least a 280% increase, at least a 300% increase, at least a 320% increase, at least a 340% increase, at least a 360% increase, at least a 380% increase, at least a 400% increase, at least a 420% increase, at least a 440% increase, at least a 460% increase, at least a 480% increase, at least a 500% increase, at least a 520% increase, at least a 540% increase, at least a 560% increase, at least a 580% increase, at least a 600% increase, at least a 620% increase, at least a 640% increase, at least a 660% increase, at least a 680% increase, at least a 700% increase, at least a 720% increase, at least a 740% increase, at least a 760% increase, at least a 780% increase, at least a 800% increase, at least a 820% increase, at least a 840% increase, at least a 860% increase, at least a 880% increase, at least a 900% increase, at least a 920% increase, at least a 940% increase, at least a 960% increase, at least a 980% increase, or at least a 1,000% increase, or about a 1% to about a 1,000% increase (or any of the subranges of this range described herein)) of soil organic matter as compared to a control level (e.g., a level present in a similar assay not containing the combination).

In some embodiments, the method further includes selecting a combination having an elevated level (e.g., at least a 1% increase, at least a 5% increase, at least a 10% increase, at least a 15% increase, at least a 20% increase, at least a 25% increase, at least a 30% increase, at least a 35% increase, at least a 40% increase, at least a 45% increase, at least a 50% increase, at least a 60% increase, at least a 70% increase, at least a 80% increase, at least a 90% increase, at least a 100% increase, at least a 110% increase, at least a 120% increase, at least a 130% increase, at least a 140% increase, at least a 150% increase, at least a 160% increase, at least a 170% increase, at least a 180% increase, at least a 190% increase, at least a 200% increase, at least a 220% increase, at least a 240% increase, at least a 260% increase, at least a 280% increase, at least a 300% increase, at least a 320% increase, at least a 340% increase, at least a 360% increase, at least a 380% increase, at least a 400% increase, at least a 420% increase, at least a 440% increase, at least a 460% increase, at least a 480% increase, at least a 500% increase, at least a 520% increase, at least a 540% increase, at least a 560% increase, at least a 580% increase, at least a 600% increase, at least a 620% increase, at least a 640% increase, at least a 660% increase, at least a 680% increase, at least a 700% increase, at least a 720% increase, at least a 740% increase, at least a 760% increase, at least a 780% increase, at least a 800% increase, at least a 820% increase, at least a 840% increase, at least a 860% increase, at least a 880% increase, at least a 900% increase, at least a 920% increase, at least a 940% increase, at least a 960% increase, at least a 980% increase, or at least a 1,000% increase, or about a 1% to about a 1,000% increase (or any of the subranges of this range described herein)) of soil-water holding capacity as compared to a control level (e.g., a level present in a similar assay not containing the combination).

In some embodiments, the method further includes selecting a combination having an elevated level (e.g., at least a 1% increase, at least a 5% increase, at least a 10% increase, at least a 15% increase, at least a 20% increase, at least a 25% increase, at least a 30% increase, at least a 35% increase, at least a 40% increase, at least a 45% increase, at least a 50% increase, at least a 60% increase, at least a 70% increase, at least a 80% increase, at least a 90% increase, at least a 100% increase, at least a 110% increase, at least a 120% increase, at least a 130% increase, at least a 140% increase, at least a 150% increase, at least a 160% increase, at least a 170% increase, at least a 180% increase, at least a 190% increase, at least a 200% increase, at least a 220% increase, at least a 240% increase, at least a 260% increase, at least a 280% increase, at least a 300% increase, at least a 320% increase, at least a 340% increase, at least a 360% increase, at least a 380% increase, at least a 400% increase, at least a 420% increase, at least a 440% increase, at least a 460% increase, at least a 480% increase, at least a 500% increase, at least a 520% increase, at least a 540% increase, at least a 560% increase, at least a 580% increase, at least a 600% increase, at least a 620% increase, at least a 640% increase, at least a 660% increase, at least a 680% increase, at least a 700% increase, at least a 720% increase, at least a 740% increase, at least a 760% increase, at least a 780% increase, at least a 800% increase, at least a 820% increase, at least a 840% increase, at least a 860% increase, at least a 880% increase, at least a 900% increase, at least a 920% increase, at least a 940% increase, at least a 960% increase, at least a 980% increase, or at least a 1,000% increase, or about a 1% to about a 1,000% increase (or any of the subranges of this range described herein)) of growth in different soil types as compared to a control level (e.g., a level present in a similar assay not containing the combination).

In some embodiments, the method further includes selecting a combination having an elevated level (e.g., at least a 1% increase, at least a 5% increase, at least a 10% increase, at least a 15% increase, at least a 20% increase, at least a 25% increase, at least a 30% increase, at least a 35% increase, at least a 40% increase, at least a 45% increase, at least a 50% increase, at least a 60% increase, at least a 70% increase, at least a 80% increase, at least a 90% increase, at least a 100% increase, at least a 110% increase, at least a 120% increase, at least a 130% increase, at least a 140% increase, at least a 150% increase, at least a 160% increase, at least a 170% increase, at least a 180% increase, at least a 190% increase, at least a 200% increase, at least a 220% increase, at least a 240% increase, at least a 260% increase, at least a 280% increase, at least a 300% increase, at least a 320% increase, at least a 340% increase, at least a 360% increase, at least a 380% increase, at least a 400% increase, at least a 420% increase, at least a 440% increase, at least a 460% increase, at least a 480% increase, at least a 500% increase, at least a 520% increase, at least a 540% increase, at least a 560% increase, at least a 580% increase, at least a 600% increase, at least a 620% increase, at least a 640% increase, at least a 660% increase, at least a 680% increase, at least a 700% increase, at least a 720% increase, at least a 740% increase, at least a 760% increase, at least a 780% increase, at least a 800% increase, at least a 820% increase, at least a 840% increase, at least a 860% increase, at least a 880% increase, at least a 900% increase, at least a 920% increase, at least a 940% increase, at least a 960% increase, at least a 980% increase, or at least a 1,000% increase, or about a 1% to about a 1,000% increase (or any of the subranges of this range described herein)) of molecules that protect vegetation against plant pathogens as compared to a control level (e.g., a level present in a similar assay not containing the combination).

In some embodiments, the method further includes selecting a combination having an elevated level (e.g., at least a 1% increase, at least a 5% increase, at least a 10% increase, at least a 15% increase, at least a 20% increase, at least a 25% increase, at least a 30% increase, at least a 35% increase, at least a 40% increase, at least a 45% increase, at least a 50% increase, at least a 60% increase, at least a 70% increase, at least a 80% increase, at least a 90% increase, at least a 100% increase, at least a 110% increase, at least a 120% increase, at least a 130% increase, at least a 140% increase, at least a 150% increase, at least a 160% increase, at least a 170% increase, at least a 180% increase, at least a 190% increase, at least a 200% increase, at least a 220% increase, at least a 240% increase, at least a 260% increase, at least a 280% increase, at least a 300% increase, at least a 320% increase, at least a 340% increase, at least a 360% increase, at least a 380% increase, at least a 400% increase, at least a 420% increase, at least a 440% increase, at least a 460% increase, at least a 480% increase, at least a 500% increase, at least a 520% increase, at least a 540% increase, at least a 560% increase, at least a 580% increase, at least a 600% increase, at least a 620% increase, at least a 640% increase, at least a 660% increase, at least a 680% increase, at least a 700% increase, at least a 720% increase, at least a 740% increase, at least a 760% increase, at least a 780% increase, at least a 800% increase, at least a 820% increase, at least a 840% increase, at least a 860% increase, at least a 880% increase, at least a 900% increase, at least a 920% increase, at least a 940% increase, at least a 960% increase, at least a 980% increase, or at least a 1,000% increase, or about a 1% to about a 1,000% increase (or any of the subranges of this range described herein)) of molecules that protect vegetation against pests as compared to a control level (e.g., a level present in a similar assay not containing the combination).

In some embodiments, the method further includes selecting a combination having an elevated level (e.g., at least a 1% increase, at least a 5% increase, at least a 10% increase, at least a 15% increase, at least a 20% increase, at least a 25% increase, at least a 30% increase, at least a 35% increase, at least a 40% increase, at least a 45% increase, at least a 50% increase, at least a 60% increase, at least a 70% increase, at least a 80% increase, at least a 90% increase, at least a 100% increase, at least a 110% increase, at least a 120% increase, at least a 130% increase, at least a 140% increase, at least a 150% increase, at least a 160% increase, at least a 170% increase, at least a 180% increase, at least a 190% increase, at least a 200% increase, at least a 220% increase, at least a 240% increase, at least a 260% increase, at least a 280% increase, at least a 300% increase, at least a 320% increase, at least a 340% increase, at least a 360% increase, at least a 380% increase, at least a 400% increase, at least a 420% increase, at least a 440% increase, at least a 460% increase, at least a 480% increase, at least a 500% increase, at least a 520% increase, at least a 540% increase, at least a 560% increase, at least a 580% increase, at least a 600% increase, at least a 620% increase, at least a 640% increase, at least a 660% increase, at least a 680% increase, at least a 700% increase, at least a 720% increase, at least a 740% increase, at least a 760% increase, at least a 780% increase, at least a 800% increase, at least a 820% increase, at least a 840% increase, at least a 860% increase, at least a 880% increase, at least a 900% increase, at least a 920% increase, at least a 940% increase, at least a 960% increase, at least a 980% increase, or at least a 1,000% increase, or about a 1% to about a 1,000% increase (or any of the subranges of this range described herein)) of growth of vegetation as compared to a control level (e.g., a level present in a similar assay not containing the combination).

In some embodiments, the method further includes selecting a combination having an elevated level (e.g., at least a 1% increase, at least a 5% increase, at least a 10% increase, at least a 15% increase, at least a 20% increase, at least a 25% increase, at least a 30% increase, at least a 35% increase, at least a 40% increase, at least a 45% increase, at least a 50% increase, at least a 60% increase, at least a 70% increase, at least a 80% increase, at least a 90% increase, at least a 100% increase, at least a 110% increase, at least a 120% increase, at least a 130% increase, at least a 140% increase, at least a 150% increase, at least a 160% increase, at least a 170% increase, at least a 180% increase, at least a 190% increase, at least a 200% increase, at least a 220% increase, at least a 240% increase, at least a 260% increase, at least a 280% increase, at least a 300% increase, at least a 320% increase, at least a 340% increase, at least a 360% increase, at least a 380% increase, at least a 400% increase, at least a 420% increase, at least a 440% increase, at least a 460% increase, at least a 480% increase, at least a 500% increase, at least a 520% increase, at least a 540% increase, at least a 560% increase, at least a 580% increase, at least a 600% increase, at least a 620% increase, at least a 640% increase, at least a 660% increase, at least a 680% increase, at least a 700% increase, at least a 720% increase, at least a 740% increase, at least a 760% increase, at least a 780% increase, at least a 800% increase, at least a 820% increase, at least a 840% increase, at least a 860% increase, at least a 880% increase, at least a 900% increase, at least a 920% increase, at least a 940% increase, at least a 960% increase, at least a 980% increase, or at least a 1,000% increase, or about a 1% to about a 1,000% increase (or any of the subranges of this range described herein)) of molecules having one or more insecticidal, herbicidal, anti-fungal, weed controlling, and seed germination activity as compared to a control level (e.g., a level present in a similar assay not containing the combination).

In some embodiments, the method further includes selecting a combination having an elevated level (e.g., at least a 1% increase, at least a 5% increase, at least a 10% increase, at least a 15% increase, at least a 20% increase, at least a 25% increase, at least a 30% increase, at least a 35% increase, at least a 40% increase, at least a 45% increase, at least a 50% increase, at least a 60% increase, at least a 70% increase, at least a 80% increase, at least a 90% increase, at least a 100% increase, at least a 110% increase, at least a 120% increase, at least a 130% increase, at least a 140% increase, at least a 150% increase, at least a 160% increase, at least a 170% increase, at least a 180% increase, at least a 190% increase, at least a 200% increase, at least a 220% increase, at least a 240% increase, at least a 260% increase, at least a 280% increase, at least a 300% increase, at least a 320% increase, at least a 340% increase, at least a 360% increase, at least a 380% increase, at least a 400% increase, at least a 420% increase, at least a 440% increase, at least a 460% increase, at least a 480% increase, at least a 500% increase, at least a 520% increase, at least a 540% increase, at least a 560% increase, at least a 580% increase, at least a 600% increase, at least a 620% increase, at least a 640% increase, at least a 660% increase, at least a 680% increase, at least a 700% increase, at least a 720% increase, at least a 740% increase, at least a 760% increase, at least a 780% increase, at least a 800% increase, at least a 820% increase, at least a 840% increase, at least a 860% increase, at least a 880% increase, at least a 900% increase, at least a 920% increase, at least a 940% increase, at least a 960% increase, at least a 980% increase, or at least a 1,000% increase, or about a 1% to about a 1,000% increase (or any of the subranges of this range described herein)) of root growth of vegetation as compared to a control level (e.g., a level present in a similar assay not containing the combination).

In some embodiments, the method further includes selecting a combination having an elevated level (e.g., at least a 1% increase, at least a 5% increase, at least a 10% increase, at least a 15% increase, at least a 20% increase, at least a 25% increase, at least a 30% increase, at least a 35% increase, at least a 40% increase, at least a 45% increase, at least a 50% increase, at least a 60% increase, at least a 70% increase, at least a 80% increase, at least a 90% increase, at least a 100% increase, at least a 110% increase, at least a 120% increase, at least a 130% increase, at least a 140% increase, at least a 150% increase, at least a 160% increase, at least a 170% increase, at least a 180% increase, at least a 190% increase, at least a 200% increase, at least a 220% increase, at least a 240% increase, at least a 260% increase, at least a 280% increase, at least a 300% increase, at least a 320% increase, at least a 340% increase, at least a 360% increase, at least a 380% increase, at least a 400% increase, at least a 420% increase, at least a 440% increase, at least a 460% increase, at least a 480% increase, at least a 500% increase, at least a 520% increase, at least a 540% increase, at least a 560% increase, at least a 580% increase, at least a 600% increase, at least a 620% increase, at least a 640% increase, at least a 660% increase, at least a 680% increase, at least a 700% increase, at least a 720% increase, at least a 740% increase, at least a 760% increase, at least a 780% increase, at least a 800% increase, at least a 820% increase, at least a 840% increase, at least a 860% increase, at least a 880% increase, at least a 900% increase, at least a 920% increase, at least a 940% increase, at least a 960% increase, at least a 980% increase, or at least a 1,000% increase, or about a 1% to about a 1,000% increase (or any of the subranges of this range described herein)) of chemicals leading to the inhibition of denitrification as compared to a control level (e.g., a level present in a similar assay not containing the combination).

In some embodiments, the method further includes selecting a combination having an elevated level (e.g., at least a 1% increase, at least a 5% increase, at least a 10% increase, at least a 15% increase, at least a 20% increase, at least a 25% increase, at least a 30% increase, at least a 35% increase, at least a 40% increase, at least a 45% increase, at least a 50% increase, at least a 60% increase, at least a 70% increase, at least a 80% increase, at least a 90% increase, at least a 100% increase, at least a 110% increase, at least a 120% increase, at least a 130% increase, at least a 140% increase, at least a 150% increase, at least a 160% increase, at least a 170% increase, at least a 180% increase, at least a 190% increase, at least a 200% increase, at least a 220% increase, at least a 240% increase, at least a 260% increase, at least a 280% increase, at least a 300% increase, at least a 320% increase, at least a 340% increase, at least a 360% increase, at least a 380% increase, at least a 400% increase, at least a 420% increase, at least a 440% increase, at least a 460% increase, at least a 480% increase, at least a 500% increase, at least a 520% increase, at least a 540% increase, at least a 560% increase, at least a 580% increase, at least a 600% increase, at least a 620% increase, at least a 640% increase, at least a 660% increase, at least a 680% increase, at least a 700% increase, at least a 720% increase, at least a 740% increase, at least a 760% increase, at least a 780% increase, at least a 800% increase, at least a 820% increase, at least a 840% increase, at least a 860% increase, at least a 880% increase, at least a 900% increase, at least a 920% increase, at least a 940% increase, at least a 960% increase, at least a 980% increase, or at least a 1,000% increase, or about a 1% to about a 1,000% increase (or any of the subranges of this range described herein)) of exopolysaccharide production as compared to a control level (e.g., a level present in a similar assay not containing the combination).

In some embodiments, the method further includes selecting a combination having an elevated level (e.g., at least a 1% increase, at least a 5% increase, at least a 10% increase, at least a 15% increase, at least a 20% increase, at least a 25% increase, at least a 30% increase, at least a 35% increase, at least a 40% increase, at least a 45% increase, at least a 50% increase, at least a 60% increase, at least a 70% increase, at least a 80% increase, at least a 90% increase, at least a 100% increase, at least a 110% increase, at least a 120% increase, at least a 130% increase, at least a 140% increase, at least a 150% increase, at least a 160% increase, at least a 170% increase, at least a 180% increase, at least a 190% increase, at least a 200% increase, at least a 220% increase, at least a 240% increase, at least a 260% increase, at least a 280% increase, at least a 300% increase, at least a 320% increase, at least a 340% increase, at least a 360% increase, at least a 380% increase, at least a 400% increase, at least a 420% increase, at least a 440% increase, at least a 460% increase, at least a 480% increase, at least a 500% increase, at least a 520% increase, at least a 540% increase, at least a 560% increase, at least a 580% increase, at least a 600% increase, at least a 620% increase, at least a 640% increase, at least a 660% increase, at least a 680% increase, at least a 700% increase, at least a 720% increase, at least a 740% increase, at least a 760% increase, at least a 780% increase, at least a 800% increase, at least a 820% increase, at least a 840% increase, at least a 860% increase, at least a 880% increase, at least a 900% increase, at least a 920% increase, at least a 940% increase, at least a 960% increase, at least a 980% increase, or at least a 1,000% increase, or about a 1% to about a 1,000% increase (or any of the subranges of this range described herein)) of solubilized potassium, iron, and/or phosphorus bioavailability as compared to a control level (e.g., a level present in a similar assay not containing the combination).

In some embodiments, the method further includes selecting a combination having an elevated level (e.g., at least a 1% increase, at least a 5% increase, at least a 10% increase, at least a 15% increase, at least a 20% increase, at least a 25% increase, at least a 30% increase, at least a 35% increase, at least a 40% increase, at least a 45% increase, at least a 50% increase, at least a 60% increase, at least a 70% increase, at least a 80% increase, at least a 90% increase, at least a 100% increase, at least a 110% increase, at least a 120% increase, at least a 130% increase, at least a 140% increase, at least a 150% increase, at least a 160% increase, at least a 170% increase, at least a 180% increase, at least a 190% increase, at least a 200% increase, at least a 220% increase, at least a 240% increase, at least a 260% increase, at least a 280% increase, at least a 300% increase, at least a 320% increase, at least a 340% increase, at least a 360% increase, at least a 380% increase, at least a 400% increase, at least a 420% increase, at least a 440% increase, at least a 460% increase, at least a 480% increase, at least a 500% increase, at least a 520% increase, at least a 540% increase, at least a 560% increase, at least a 580% increase, at least a 600% increase, at least a 620% increase, at least a 640% increase, at least a 660% increase, at least a 680% increase, at least a 700% increase, at least a 720% increase, at least a 740% increase, at least a 760% increase, at least a 780% increase, at least a 800% increase, at least a 820% increase, at least a 840% increase, at least a 860% increase, at least a 880% increase, at least a 900% increase, at least a 920% increase, at least a 940% increase, at least a 960% increase, at least a 980% increase, or at least a 1,000% increase, or about a 1% to about a 1,000% increase (or any of the subranges of this range described herein)) of siderophore production as compared to a control level (e.g., a level present in a similar assay not containing the combination).

In some embodiments, the method further includes selecting a combination having an elevated level (e.g., at least a 1% increase, at least a 5% increase, at least a 10% increase, at least a 15% increase, at least a 20% increase, at least a 25% increase, at least a 30% increase, at least a 35% increase, at least a 40% increase, at least a 45% increase, at least a 50% increase, at least a 60% increase, at least a 70% increase, at least a 80% increase, at least a 90% increase, at least a 100% increase, at least a 110% increase, at least a 120% increase, at least a 130% increase, at least a 140% increase, at least a 150% increase, at least a 160% increase, at least a 170% increase, at least a 180% increase, at least a 190% increase, at least a 200% increase, at least a 220% increase, at least a 240% increase, at least a 260% increase, at least a 280% increase, at least a 300% increase, at least a 320% increase, at least a 340% increase, at least a 360% increase, at least a 380% increase, at least a 400% increase, at least a 420% increase, at least a 440% increase, at least a 460% increase, at least a 480% increase, at least a 500% increase, at least a 520% increase, at least a 540% increase, at least a 560% increase, at least a 580% increase, at least a 600% increase, at least a 620% increase, at least a 640% increase, at least a 660% increase, at least a 680% increase, at least a 700% increase, at least a 720% increase, at least a 740% increase, at least a 760% increase, at least a 780% increase, at least a 800% increase, at least a 820% increase, at least a 840% increase, at least a 860% increase, at least a 880% increase, at least a 900% increase, at least a 920% increase, at least a 940% increase, at least a 960% increase, at least a 980% increase, or at least a 1,000% increase, or about a 1% to about a 1,000% increase (or any of the subranges of this range described herein)) of solubilized sulfur, boron, magnesium, and/or manganese bioavailability as compared to a control level (e.g., a level present in a similar assay not containing the combination).

In some embodiments, the method can further include, between the step of providing a combination of one or more photosynthetic microorganism(s) (e.g., any of the exemplary photosynthetic microorganisms described herein or known in the art) and the step of determining a level of one or more activities of the combination selected from: production of one or more carbon species; production of one or more nitrogen species; production of one or more molecule(s) containing carbon and nitrogen; production of organic matter; soil water-holding capacity; growth in different soil types with or without vegetation; protection of vegetation against plant pathogens; protection of vegetation against pests; promotion of growth of vegetation; production of molecules having one or more of insecticidal, herbicidal, anti-fungal, weed controlling, and seed germination activity; promotion of root growth of vegetation; and inhibition of denitrification, contacting the combination with a chemical mutagen (e.g., one or more of ethyl methanesulfonate, methyl methanesulfonate, and ethyl nitrosourea). In some embodiments of these methods, the combination has previously been exposed to a chemical mutagen (e.g., one or more of ethyl methanesulfonate, methyl methanesulfonate, and ethyl nitrosourea).

In some examples, the one or more heterotrophic microorganism(s) comprises an Azotobacter species. In some embodiments, the one or more heterotrophic microorganism(s) comprises a methanotrophic microorganism (e.g., Methylomicrobium buryatense).

In some examples, at least one of the one or more nitrogen-fixing microorganism(s) is isolated from a soil or is isolated from a marine environment. In some examples, the microbial composition is a crop dusting composition or a seed-coating composition (or any of the other microbial compositions described herein).

Combinations of microorganisms used in a microbial composition (e.g., nitrogen-fixing and/or non-nitrogen-fixing cyanobacterial species) are screened to identify optimal species for robust growth on soils with different attributes (e.g., ineffectual levels of OM, nitrogen, carbon, water content, etc.). Combinations of microorganisms used in a microbial composition (e.g., nitrogen-fixing cyanobacterial species) can belong to various genera. In some examples, a combination of microorganisms used in a microbial composition can be maintained in pure culture. For example, combinations of microorganisms used in the microbial composition may have previously been deposited in a culture collection (e.g., UTEX Culture Collection or ATCC). Combinations of microorganisms can be screened for various attributes such as tolerance to light intensities, temperatures, salinity, pH, EPS production, level of nitrogen-fixation, level of production of carbon, level of production of nitrogen, and level of production of organic matter (e.g., using any of the exemplary methods determining these levels described herein). Screening and/or culturing of combinations of microorganisms can take place in a nutrient-limited soil (detailed below). In some examples, this soil can be modified by the addition of different ingredients to change the soil attributes to determine growth of the combinations of microorganisms described herein. Screening and/or culturing of any of the combinations of microorganisms described herein can be performed under the photoperiod of 12 hours of light/12 hours of dark.

As mentioned, in some examples, the light intensity used for screening, isolating, and/or culturing of any of the combinations of microorganisms described herein can be in the range of about 100 to about 2000 μm·m⁻²·s⁻¹ (e.g., about 100 μE·m⁻²·s⁻¹, about 110 μE·m⁻²·s⁻¹, about 120 μE·m⁻²·s⁻¹, about 130 μE·m⁻²·s⁻¹, about 140 μE·m⁻²·s⁻¹, about 150 μE·m⁻²·s⁻¹, about 160 μE·m⁻²·s⁻¹, about 170 μE·m⁻²·s⁻¹, about 180 μE·m⁻²·s⁻¹, about 190 μE·m⁻²·s⁻¹, about 200 μE·m⁻²·s⁻¹, about 220 μE·m⁻²·s⁻¹, about 240 μE·m⁻²·s⁻¹, about 260 μE·m⁻²·s⁻¹, about 280 μE·m⁻²·s⁻¹, about 300 μE·m⁻²·s⁻¹, about 320 μE·m⁻²·s⁻¹, about 340 μE·m⁻²·s⁻¹, about 360 μE·m⁻²·s⁻¹, about 380 μE·m⁻²·s⁻¹, about 400 μE·m⁻²·s⁻¹, about 420 μE·m⁻²·s⁻¹, about 440 μE·m⁻²·s⁻¹, about 460 μE·m⁻²·s⁻¹, about 480 μE·m⁻²·s⁻¹, about 500 μE·m⁻²·s⁻¹, about 520 μE·m⁻²·s⁻¹, about 540 μE·m⁻²·s⁻¹, about 560 μE·m⁻²·s⁻¹, about 580 μE·m⁻²·s⁻¹, about 600 μE·m⁻²·s⁻¹, about 620 μE·m⁻²·s⁻¹, about 640 μE·m⁻²·s⁻¹, about 660 μE·m⁻²·s⁻¹, about 680 μE·m⁻²·s⁻¹, about 700 μE·m⁻²·s⁻¹, about 720 μE·m⁻²·s⁻¹, about 740 μE·m⁻²·s⁻¹, about 760 μE·m⁻²·s⁻¹, about 780 μE·m⁻²·s⁻¹, about 800 μE·m⁻²·s⁻¹, about 820 μE·m⁻²·s⁻¹, about 840 μE·m⁻²·s⁻¹, about 860 μE·m⁻²·s⁻¹, about 880 μE·m⁻²·s⁻¹, about 900 μE·m⁻²·s⁻¹, about 920 μE·m⁻²·s⁻¹, about 940 μE·m⁻²·s⁻¹, about 960 μE·m⁻²·s⁻¹, about 980 μE·m⁻²·s⁻¹, about 1000 μE·m⁻²·s⁻¹, about 1050 μE·m⁻²·s⁻¹, about 1100 μE·m⁻²·s⁻¹, about 1150 μE·m⁻²·s⁻¹, about 1200 μE·m⁻²·s⁻¹, about 1250 μE·m⁻²·s⁻¹, about 1300 μE·m⁻²·s⁻¹, about 1350 μE·m⁻²·s⁻¹, about 1400 μE·m⁻²·s⁻¹, about 1450 μE·m⁻²·s⁻¹, about 1500 μE·m⁻²·s⁻¹, about 1550 μE·m⁻²·s⁻¹, about 1600 μE·m⁻²·s⁻¹, about 1650 μE·m⁻²·s⁻¹, about 1700 μE·m⁻²·s⁻¹, about 1750 μE·m⁻²·s⁻¹, about 1800 μE·m⁻²·s⁻¹, about 1850 μE·m⁻²·s⁻¹, about 1900 μE·m⁻²·s⁻¹, about 1950 μE·m⁻²·s⁻¹, or about 2000 μE·m⁻²·s⁻¹, or about 100 to about 1900 μE·m⁻²·s⁻¹, about 100 to about 1800 μE·m⁻²·s⁻¹, about 100 to about 1700 μE·m⁻²·s⁻¹, about 100 to about 1600 μE·m⁻²·s⁻¹, about 100 to about 1500 μE·m⁻²·s⁻¹, about 100 to about 1400 μE·m⁻²·s⁻¹, about 100 to about 1300 μE·m⁻²·s⁻¹, about 100 to about 1200 μE·m⁻²·s⁻¹, about 100 to about 1100 μE·m⁻²·s⁻¹, about 100 to about 1000 μE·m⁻²·s⁻¹, about 100 to about 900 μE·m⁻²·s⁻¹, about 100 to about 800 μE·m⁻²·s⁻¹, about 100 to about 700 μE·m⁻²·s⁻¹, about 100 to about 600 μE·m⁻²·s⁻¹, about 100 to about 500 μE·m⁻²·s⁻¹, about 100 to about 400 μE·m⁻²·s⁻¹, about 100 to about 300 μE·m⁻²·s⁻¹, about 100 to about 200 μE·m⁻²·s⁻¹, about 200 to about 2000 μE·m⁻²·s⁻¹, about 200 to about 1900 μE·m⁻²·s⁻¹, about 200 to about 1800 μE·m⁻²·s⁻¹, about 200 to about 1700 μE·m⁻²·s⁻¹, about 200 to about 1600 μE·m⁻²·s⁻¹, about 200 to about 1500 μE·m⁻²·s⁻¹, about 200 to about 1400 μE·m⁻²·s⁻¹, about 200 to about 1300 μE·m⁻²·s⁻¹, about 200 to about 1200 μE·m⁻²·s⁻¹, about 200 to about 1100 μE·m⁻²·s⁻¹, about 200 to about 1000 μE·m⁻²·s⁻¹, about 200 to about 900 μE·m⁻²·s⁻¹, about 200 to about 800 μE·m⁻²·s⁻¹, about 200 to about 700 μE·m⁻²·s⁻¹, about 200 to about 600 μE·m⁻²·s⁻¹, about 200 to about 500 μE·m⁻²·s⁻¹, about 200 to about 400 μE·m⁻²·s⁻¹, about 200 to about 300 μE·m⁻²·s⁻¹, about 300 to about 2000 μE·m⁻²·s⁻¹, about 300 to about 1900 μE·m⁻²·s⁻¹, about 300 to about 1800 μE·m⁻²·s⁻¹, about 300 to about 1700 μE·m⁻²·s⁻¹, about 300 to about 1600 μE·m⁻²·s⁻¹, about 300 to about 1500 μE·m⁻²·s⁻¹, about 300 to about 1400 μE·m⁻²·s⁻¹, about 300 to about 1300 μE·m⁻²·s⁻¹, about 300 to about 1200 μE·m⁻²·s⁻¹, about 300 to about 1100 μE·m⁻²·s⁻¹, about 300 to about 1000 μE·m⁻²·s⁻¹, about 300 to about 900 μE·m⁻²·s⁻¹, about 300 to about 800 μE·m⁻²·s⁻¹, about 300 to about 700 μE·m⁻²·s⁻¹, about 300 to about 600 μE·m⁻²·s⁻¹, about 300 to about 500 μE·m⁻²·s⁻¹, about 300 to about 400 μE·m⁻²·s⁻¹, about 400 to about 2000 μE·m⁻²·s⁻¹, about 400 to about 1900 μE·m⁻²·s⁻¹, about 400 to about 1800 μE·m⁻²·s⁻¹, about 400 to about 1700 μE·m⁻²·s⁻¹, about 400 to about 1600 μE·m⁻²·s⁻¹, about 400 to about 1500 μE·m⁻²·s⁻¹, about 400 to about 1400 μE·m⁻²·s⁻¹, about 400 to about 1300 μE·m⁻²·s⁻¹, about 400 to about 1200 μE·m⁻²·s⁻¹, about 400 to about 1100 μE·m⁻²·s⁻¹, about 400 to about 1000 μE·m⁻²·s⁻¹, about 400 to about 900 μE·m⁻²·s⁻¹, about 400 to about 800 μE·m⁻²·s⁻¹, about 400 to about 700 μE·m⁻²·s⁻¹, about 400 to about 600 μE·m⁻²·s⁻¹, about 400 to about 500 μE·m⁻²·s⁻¹, about 500 to about 2000 μE·m⁻²·s⁻¹, about 500 to about 1900 μE·m⁻²·s⁻¹, about 500 to about 1800 μE·m⁻²·s⁻¹, about 500 to about 1700 μE·m⁻²·s⁻¹, about 500 to about 1600 μE·m⁻²·s⁻¹, about 500 to about 1500 μE·m⁻²·s⁻¹, about 500 to about 1400 μE·m⁻²·s⁻¹, about 500 to about 1300 μE·m⁻²·s⁻¹, about 500 to about 1200 μE·m⁻²·s⁻¹, about 500 to about 1100 μE·m⁻²·s⁻¹, about 500 to about 1000 μE·m⁻²·s⁻¹, about 500 to about 900 μE·m⁻²·s⁻¹, about 500 to about 800 μE·m⁻²·s⁻¹, about 500 to about 700 μE·m⁻²·s⁻¹, about 500 to about 600 μE·m⁻²·s⁻¹, about 600 to about 2000 μE·m⁻²·s⁻¹, about 600 to about 1900 μE·m⁻²·s⁻¹, about 600 to about 1800 μE·m⁻²·s⁻¹, about 600 to about 1700 μE·m⁻²·s⁻¹, about 600 to about 1600 μE·m⁻²·s⁻¹, about 600 to about 1500 μE·m⁻²·s⁻¹, about 600 to about 1400 μE·m⁻²·s⁻¹, about 600 to about 1300 μE·m⁻²·s⁻¹, about 600 to about 1200 μE·m⁻²·s⁻¹, about 600 to about 1100 μE·m⁻²·s⁻¹, about 600 to about 1000 μE·m⁻²·s⁻¹, about 600 to about 900 μE·m⁻²·s⁻¹, about 600 to about 800 μE·m⁻²·s⁻¹, about 600 to about 700 μE·m⁻²·s⁻¹, about 700 to about 2000 μE·m⁻²·s⁻¹, about 700 to about 1900 μE·m⁻²·s⁻¹, about 700 to about 1800 μE·m⁻²·s⁻¹, about 700 to about 1700 μE·m⁻²·s⁻¹, about 700 to about 1600 μE·m⁻²·s⁻¹, about 700 to about 1500 μE·m⁻²·s⁻¹, about 700 to about 1400 μE·m⁻²·s⁻¹, about 700 to about 1300 μE·m⁻²·s⁻¹, about 700 to about 1200 μE·m⁻²·s⁻¹, about 700 to about 1100 μE·m⁻²·s⁻¹, about 700 to about 1000 μE·m⁻²·s⁻¹, about 700 to about 900 μE·m⁻²·s⁻¹, about 700 to about 800 μE·m⁻²·s⁻¹, about 800 to about 2000 μE·m⁻²·s⁻¹, about 800 to about 1900 μE·m⁻²·s⁻¹, about 800 to about 1800 μE·m⁻²·s⁻¹, about 800 to about 1700 μE·m⁻²·s⁻¹, about 800 to about 1600 μE·m⁻²·s⁻¹, about 800 to about 1500 μE·m⁻²·s⁻¹, about 800 to about 1400 μE·m⁻²·s⁻¹, about 800 to about 1300 μE·m⁻²·s⁻¹, about 800 to about 1200 μE·m⁻²·s⁻¹, about 800 to about 1100 μE·m⁻²·s⁻¹, about 800 to about 1000 μE·m⁻²·s⁻¹, about 800 to about 900 μE·m⁻²·s⁻¹, about 900 to about 2000 μE·m⁻²·s⁻¹, about 900 to about 1900 μE·m⁻²·s⁻¹, about 900 to about 1800 μE·m⁻²·s⁻¹, about 900 to about 1700 μE·m⁻²·s⁻¹, about 900 to about 1600 μE·m⁻²·s⁻¹, about 900 to about 1500 μE·m⁻²·s⁻¹, about 900 to about 1400 μE·m⁻²·s⁻¹, about 900 to about 1300 μE·m⁻²·s⁻¹, about 900 to about 1200 μE·m⁻²·s⁻¹, about 900 to about 1100 μE·m⁻²·s⁻¹, about 900 to about 1000 μE·m⁻²·s⁻¹, about 1000 to about 2000 μE·m⁻²·s⁻¹, about 1000 to about 1900 μE·m⁻²·s⁻¹, about 1000 to about 1800 μE·m⁻²·s⁻¹, about 1000 to about 1700 μE·m⁻²·s⁻¹, about 1000 to about 1600 μE·m⁻²·s⁻¹, about 1000 to about 1500 μE·m⁻²·s⁻¹, about 1000 to about 1400 μE·m⁻²·s⁻¹, about 1000 to about 1300 μE·m⁻²·s⁻¹, about 1000 to about 1200 μE·m⁻²·s⁻¹, about 1000 to about 1100 μE·m⁻²·s⁻¹, about 1100 to about 2000 μE·m⁻²·s⁻¹, about 1100 to about 1900 μE·m⁻²·s⁻¹, about 1100 to about 1800 μE·m⁻²·s⁻¹, about 1100 to about 1700 μE·m⁻²·s⁻¹, about 1100 to about 1600 μE·m⁻²·s⁻¹, about 1100 to about 1500 μE·m⁻²·s⁻¹, about 1100 to about 1400 μE·m⁻²·s⁻¹, about 1100 to about 1300 μE·m⁻²·s⁻¹, about 1100 to about 1200 μE·m⁻²·s⁻¹, about 1200 to about 2000 μE·m⁻²·s⁻¹, about 1200 to about 1900 μE·m⁻²·s⁻¹, about 1200 to about 1800 μE·m⁻²·s⁻¹, about 1200 to about 1700 μE·m⁻²·s⁻¹, about 1200 to about 1600 μE·m⁻²·s⁻¹, about 1200 to about 1500 μE·m⁻²·s⁻¹, about 1200 to about 1400 μE·m⁻²·s⁻¹, about 1200 to about 1300 μE·m⁻²·s⁻¹, about 1300 to about 2000 μE·m⁻²·s⁻¹, about 1300 to about 1900 μE·m⁻²·s⁻¹, about 1300 to about 1800 μE·m⁻²·s⁻¹, about 1300 to about 1700 μE·m⁻²·s⁻¹, about 1300 to about 1600 μE·m⁻²·s⁻¹, about 1300 to about 1500 μE·m⁻²·s⁻¹, about 1300 to about 1400 μE·m⁻²·s⁻¹, about 1400 to about 2000 μE·m⁻²·s⁻¹, about 1400 to about 1900 μE·m⁻²·s⁻¹, about 1400 to about 1800 μE·m⁻²·s⁻¹, about 1400 to about 1700 μE·m⁻²·s⁻¹, about 1400 to about 1600 μE·m⁻²·s⁻¹, about 1400 to about 1500 μE·m⁻²·s⁻¹, about 1500 to about 2000 μE·m⁻²·s⁻¹, about 1500 to about 1900 μE·m⁻²·s⁻¹, about 1500 to about 1800 μE·m⁻²·s⁻¹, about 1500 to about 1700 μE·m⁻²·s⁻¹, about 1500 to about 1600 μE·m⁻²·s⁻¹, about 1600 to about 2000 μE·m⁻²·s⁻¹, about 1600 to about 1900 μE·m⁻²·s⁻¹, about 1600 to about 1800 μE·m⁻²·s⁻¹, about 1600 to about 1700 μE·m⁻²·s⁻¹, about 1700 to about 2000 μE·m⁻²·s⁻¹, about 1700 to about 1900 μE·m⁻²·s⁻¹, about 1700 to about 1800 μE·m⁻²·s⁻¹, about 1800 to about 2000 μE·m⁻²·s⁻¹, about 1800 to about 1900 μE·m⁻²·s⁻¹, or about 1900 to about 2000 μE·m⁻²·s⁻¹).

The temperature that can be used for screening, isolating, storing, and/or culturing of any of the combinations of microorganisms described herein can be in the range of about −20° C. to 40° C.; about −20° C., about −19° C., about −18° C., about −17° C., about −16° C., about −15° C., about −14° C., about −13° C., about −12° C., about −11° C., about −10° C., about −9° C., about −8° C., about −7° C., about −6° C., about −5° C., about −4° C., about −3° C., about −2° C., about −1° C., about 0° C., about 1° C., about 2° C., about 3° C., about 4° C., about 5° C., about 6° C., about 7° C., about 8° C., about 9° C., about 10° C., about 11° C., about 12° C., about 13° C., about 14° C., about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., about 30° C., about 31° C., about 32° C., about 33° C., about 34° C., about 35° C., about 36° C., about 37° C., about 38° C., about 39° C., or about 40° C., or about −20° C. to about 38° C., about −20° C. to about 36° C., about −20° C. to about 34° C., about −20° C. to about 32° C., about −20° C. to about 30° C., about −20° C. to about 28° C., about −20° C. to about 26° C., about −20° C. to about 24° C., about −20° C. to about 22° C., about −20° C. to about 20° C., about −20° C. to about 18° C., about −20° C. to about 16° C., about −20° C. to about 14° C., about −20° C. to about 12° C., about −20° C. to about 10° C., about −20° C. to about 8° C., about −20° C. to about 6° C., about −20° C. to about 4° C., −20° C. to about 2° C., about −20° C. to about 0° C., about −20° C. to about −5° C., about −20° C. to about −10° C., about −10° C. to about 40° C., about −10° C. to about 38° C., about −10° C. to about 36° C., about −10° C. to about 34° C., about −10° C. to about 32° C., about −10° C. to about 30° C., about −10° C. to about 28° C., about −10° C. to about 26° C., about −10° C. to about 24° C., about −10° C. to about 22° C., about −10° C. to about 20° C., about −10° C. to about 18° C., about −10° C. to about 16° C., about −10° C. to about 14° C., about −10° C. to about 12° C., about −10° C. to about 10° C., about −10° C. to about 8° C., about −10° C. to about 6° C., about −10° C. to about 4° C., −10° C. to about 2° C., about −10° C. to about 0° C., about −10° C. to about −5° C., about −5° C. to about 40° C., about −5° C. to about 38° C., about −5° C. to about 36° C., about −5° C. to about 34° C., about −5° C. to about 32° C., about −5° C. to about 30° C., about −5° C. to about 28° C., about −5° C. to about 26° C., about −5° C. to about 24° C., about −5° C. to about 22° C., about −5° C. to about 20° C., about −5° C. to about 18° C., about −5° C. to about 16° C., about −5° C. to about 14° C., about −5° C. to about 12° C., about −5° C. to about 10° C., about −5° C. to about 8° C., about −5° C. to about 6° C., about −5° C. to about 4° C., −5° C. to about 2° C., about −5° C. to about 0° C., about 0° C. to about 40° C., about 0° C. to about 38° C., about 0° C. to about 36° C., about 0° C. to about 34° C., about 0° C. to about 32° C., about 0° C. to about 30° C., about 0° C. to about 28° C., about 0° C. to about 26° C., about 0° C. to about 24° C., about 0° C. to about 22° C., about 0° C. to about 20° C., about 0° C. to about 18° C., about 0° C. to about 16° C., about 0° C. to about 14° C., about 0° C. to about 12° C., about 0° C. to about 10° C., about 0° C. to about 8° C., about 0° C. to about 6° C., about 0° C. to about 4° C., 0° C. to about 2° C., about 2° C. to about 40° C., about 2° C. to about 38° C., about 2° C. to about 36° C., about 2° C. to about 34° C., about 2° C. to about 32° C., about 2° C. to about 30° C., about 2° C. to about 28° C., about 2° C. to about 26° C., about 2° C. to about 24° C., about 2° C. to about 22° C., about 2° C. to about 20° C., about 2° C. to about 18° C., about 2° C. to about 16° C., about 2° C. to about 14° C., about 2° C. to about 12° C., about 2° C. to about 10° C., about 2° C. to about 8° C., about 2° C. to about 6° C., about 2° C. to about 4° C., about 4° C. to about 40° C., about 4° C. to about 38° C., about 4° C. to about 36° C., about 4° C. to about 34° C., about 4° C. to about 32° C., about 4° C. to about 30° C., about 4° C. to about 28° C., about 4° C. to about 26° C., about 4° C. to about 24° C., about 4° C. to about 22° C., about 4° C. to about 20° C., about 4° C. to about 18° C., about 4° C. to about 16° C., about 4° C. to about 14° C., about 4° C. to about 12° C., about 4° C. to about 10° C., about 4° C. to about 8° C., about 4° C. to about 6° C., about 6° C. to about 40° C., about 6° C. to about 38° C., about 6° C. to about 36° C., about 6° C. to about 34° C., about 6° C. to about 32° C., about 6° C. to about 30° C., about 6° C. to about 28° C., about 6° C. to about 26° C., about 6° C. to about 24° C., about 6° C. to about 22° C., about 6° C. to about 20° C., about 6° C. to about 18° C., about 6° C. to about 16° C., about 6° C. to about 14° C., about 6° C. to about 12° C., about 6° C. to about 10° C., about 6° C. to about 8° C., about 8° C. to about 40° C., about 8° C. to about 38° C., about 8° C. to about 36° C., about 8° C. to about 34° C., about 8° C. to about 32° C., about 8° C. to about 30° C., about 8° C. to about 28° C., about 8° C. to about 26° C., about 8° C. to about 24° C., about 8° C. to about 22° C., about 8° C. to about 20° C., about 8° C. to about 18° C., about 8° C. to about 16° C., about 8° C. to about 14° C., about 8° C. to about 12° C., about 8° C. to about 10° C., about 10° C. to about 40° C., about 10° C. to about 38° C., about 10° C. to about 36° C., about 10° C. to about 34° C., about 10° C. to about 32° C., about 10° C. to about 30° C., about 10° C. to about 28° C., about 10° C. to about 26° C., about 10° C. to about 24° C., about 10° C. to about 22° C., about 10° C. to about 20° C., about 10° C. to about 18° C., about 10° C. to about 16° C., about 10° C. to about 14° C., about 10° C. to about 12° C., about 12° C. to about 40° C., about 12° C. to about 38° C., about 12° C. to about 36° C., about 12° C. to about 34° C., about 12° C. to about 32° C., about 12° C. to about 30° C., about 12° C. to about 28° C., about 12° C. to about 26° C., about 12° C. to about 24° C., about 12° C. to about 22° C., about 12° C. to about 20° C., about 12° C. to about 18° C., about 12° C. to about 16° C., about 12° C. to about 14° C., about 14° C. to about 40° C., about 14° C. to about 38° C., about 14° C. to about 36° C., about 14° C. to about 34° C., about 14° C. to about 32° C., about 14° C. to about 30° C., about 14° C. to about 28° C., about 14° C. to about 26° C., about 14° C. to about 24° C., about 14° C. to about 22° C., about 14° C. to about 20° C., about 14° C. to about 18° C., about 14° C. to about 16° C., about 16° C. to about 40° C., about 16° C. to about 38° C., about 16° C. to about 36° C., about 16° C. to about 34° C., about 16° C. to about 32° C., about 16° C. to about 30° C., about 16° C. to about 28° C., about 16° C. to about 26° C., about 16° C. to about 24° C., about 16° C. to about 22° C., about 16° C. to about 20° C., about 16° C. to about 18° C., about 18° C. to about 40° C., about 18° C. to about 38° C., about 18° C. to about 36° C., about 18° C. to about 34° C., about 18° C. to about 32° C., about 18° C. to about 30° C., about 18° C. to about 28° C., about 18° C. to about 26° C., about 18° C. to about 24° C., about 18° C. to about 22° C., about 18° C. to about 20° C., about 20° C. to about 40° C., about 20° C. to about 38° C., about 20° C. to about 36° C., about 20° C. to about 34° C., about 20° C. to about 32° C., about 20° C. to about 30° C., about 20° C. to about 28° C., about 20° C. to about 26° C., about 20° C. to about 24° C., about 20° C. to about 22° C., about 22° C. to about 40° C., about 22° C. to about 38° C., about 22° C. to about 36° C., about 22° C. to about 34° C., about 22° C. to about 32° C., about 22° C. to about 30° C., about 22° C. to about 28° C., about 22° C. to about 26° C., about 22° C. to about 24° C., about 24° C. to about 40° C., about 24° C. to about 38° C., about 24° C. to about 36° C., about 24° C. to about 34° C., about 24° C. to about 32° C., about 24° C. to about 30° C., about 24° C. to about 28° C., about 24° C. to about 26° C., about 26° C. to about 40° C., about 26° C. to about 38° C., about 26° C. to about 36° C., about 26° C. to about 34° C., about 26° C. to about 32° C., about 26° C. to about 30° C., about 26° C. to about 28° C., about 28° C. to about 40° C., about 28° C. to about 38° C., about 28° C. to about 36° C., about 28° C. to about 34° C., about 28° C. to about 32° C., about 28° C. to about 30° C., about 30° C. to about 40° C., about 30° C. to about 38° C., about 30° C. to about 36° C., about 30° C. to about 34° C., about 30° C. to about 32° C., about 32° C. to about 40° C., about 32° C. to about 38° C., about 32° C. to about 36° C., about 32° C. to about 34° C., about 34° C. to about 40° C., about 34° C. to about 38° C., about 34° C. to about 36° C., about 36° C. to about 40° C., about 36° C. to about 38° C., or about 38° C. to about 40° C.).

The salinity that can be used for screening, isolating, storing, and/or culturing of any of the combinations of microorganisms described herein can be in the range of about 0.25-1.0% (e.g., about 0.25%, about 0.30%, about 0.35%, about 0.40%, about 0.45%, about 0.50%, about 0.55%, about 0.60%, about 0.65%, about 0.70%, about 0.75%, about 0.80%, about 0.85%, about 0.90%, about 0.95%, or about 1.00%, or about 0.25% to about 0.95%, about 0.25% to about 0.90%, about 0.25% to about 0.85%, about 0.25% to about 0.80%, about 0.25% to about 0.75%, about 0.25% to about 0.70%, about 0.25% to about 0.65%, about 0.25% to about 0.60%, about 0.25% to about 0.55%, about 0.25% to about 0.50%, about 0.25% to about 0.45%, about 0.25% to about 0.40%, about 0.25% to about 0.35%, about 0.25% to about 0.30%, about 0.30% to about 1.0%, about 0.30% to about 0.95%, about 0.30% to about 0.90%, about 0.30% to about 0.85%, about 0.30% to about 0.80%, about 0.30% to about 0.75%, about 0.30% to about 0.70%, about 0.30% to about 0.65%, about 0.30% to about 0.60%, about 0.30% to about 0.55%, about 0.30% to about 0.50%, about 0.30% to about 0.45%, about 0.30% to about 0.40%, about 0.30% to about 0.35%, about 0.35% to about 1.0%, about 0.35% to about 0.95%, about 0.35% to about 0.90%, about 0.35% to about 0.85%, about 0.35% to about 0.80%, about 0.35% to about 0.75%, about 0.35% to about 0.70%, about 0.35% to about 0.65%, about 0.35% to about 0.60%, about 0.35% to about 0.55%, about 0.35% to about 0.50%, about 0.35% to about 0.45%, about 0.35% to about 0.40%, about 0.40% to about 1.0%, about 0.40% to about 0.95%, about 0.40% to about 0.90%, about 0.40% to about 0.85%, about 0.40% to about 0.80%, about 0.40% to about 0.75%, about 0.40% to about 0.70%, about 0.40% to about 0.65%, about 0.40% to about 0.60%, about 0.40% to about 0.55%, about 0.40% to about 0.50%, about 0.40% to about 0.45%, about 0.45% to about 1.0%, about 0.45% to about 0.95%, about 0.45% to about 0.90%, about 0.45% to about 0.85%, about 0.45% to about 0.80%, about 0.45% to about 0.75%, about 0.45% to about 0.70%, about 0.45% to about 0.65%, about 0.45% to about 0.60%, about 0.45% to about 0.55%, about 0.45% to about 0.50%, about 0.50% to about 1.0%, about 0.50% to about 0.95%, about 0.50% to about 0.90%, about 0.50% to about 0.85%, about 0.50% to about 0.80%, about 0.50% to about 0.75%, about 0.50% to about 0.70%, about 0.50% to about 0.65%, about 0.50% to about 0.60%, about 0.50% to about 0.55%, about 0.55% to about 1.0%, about 0.55% to about 0.95%, about 0.55% to about 0.90%, about 0.55% to about 0.85%, about 0.55% to about 0.80%, about 0.55% to about 0.75%, about 0.55% to about 0.70%, about 0.55% to about 0.65%, about 0.55% to about 0.60%, about 0.60% to about 1.0%, about 0.60% to about 0.95%, about 0.60% to about 0.90%, about 0.60% to about 0.85%, about 0.60% to about 0.80%, about 0.60% to about 0.75%, about 0.60% to about 0.70%, about 0.60% to about 0.65%, about 0.65% to about 1.0%, about 0.65% to about 0.95%, about 0.65% to about 0.90%, about 0.65% to about 0.85%, about 0.65% to about 0.80%, about 0.65% to about 0.75%, about 0.65% to about 0.70%, about 0.70% to about 1.0%, about 0.70% to about 0.95%, about 0.70% to about 0.90%, about 0.70% to about 0.85%, about 0.70% to about 0.80%, about 0.70% to about 0.75%, about 0.75% to about 1.0%, about 0.75% to about 0.95%, about 0.75% to about 0.90%, about 0.75% to about 0.85%, about 0.75% to about 0.80%, about 0.80% to about 1.0%, about 0.80% to about 0.95%, about 0.80% to about 0.90%, about 0.80% to about 0.85%, about 0.85% to about 1.0%, about 0.85% to about 0.95%, about 0.85% to about 0.90%, about 0.90% to about 1.0%, about 0.90% to about 0.95%, or about 0.95% to about 1.0%).

As mentioned, in some examples, the pH can vary for screening, isolating, storing, and/or culturing of any of the combinations of microorganisms described herein can be in the range of about 6.0 to about 8.0 (e.g., about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, about 7.5, about 7.6, about 7.7, about 7.8, about 7.9, or about 8.0° C., or about 6.0 to about 7.8, about 6.0 to about 7.6, about 6.0 to about 7.4, about 6.0 to about 7.2, about 6.0 to about 7.0, about 6.0 to about 6.8, about 6.0 to about 6.6, about 6.0 to about 6.4, about 6.0 to about 6.2, about 6.2 to about 8.0, about 6.2 to about 7.8, about 6.2 to about 7.6, about 6.2 to about 7.4, about 6.2 to about 7.2, about 6.2 to about 7.0, about 6.2 to about 6.8, about 6.2 to about 6.6, about 6.2 to about 6.4, about 6.4 to about 8.0, about 6.4 to about 7.8, about 6.4 to about 7.6, about 6.4 to about 7.4, about 6.4 to about 7.2, about 6.4 to about 7.0, about 6.4 to about 6.8, about 6.4 to about 6.6, about 6.6 to about 8.0, about 6.6 to about 7.8, about 6.6 to about 7.6, about 6.6 to about 7.4, about 6.6 to about 7.2, about 6.6 to about 7.0, about 6.6 to about 6.8, about 6.8 to about 8.0, about 6.8 to about 7.8, about 6.8 to about 7.6, about 6.8 to about 7.4, about 6.8 to about 7.2, about 6.8 to about 7.0, about 7.0 to about 8.0, about 7.0 to about 7.8, about 7.0 to about 7.6, about 7.0 to about 7.4, about 7.0 to about 7.2, about 7.2 to about 8.0, about 7.2 to about 7.8, about 7.2 to about 7.6, about 7.2 to about 7.4, about 7.4 to about 8.0, about 7.4 to about 7.8, about 7.4 to about 7.6, about 7.6 to about 8.0, about 7.6 to about 7.8, or about 7.8 to about 8.0).

Growth of a combination of microorganisms can be monitored by several methods. For example, the growth of a combination of microorganisms can be monitored by measuring optical density at 730 nm, total chlorophyll, and/or total biomass production. For example, the rate of recovery of the cyanobacterial species can be determined following storage of cells at different temperatures. For example, a cup containing soil inoculated with cyanobacterial cells can be stored at −20° C., 0° C., and/or 4° C. for 12 hours and growth stimulated by increasing the temperature. An exemplary embodiment of a screened cyanobacterial species (e.g., nitrogen-fixing or non-nitrogen-fixing) are those that can require a minimal lag phase to recover from the non-optimal growth temperature into a metabolically active state and growth phase.

Isolation and/or Enrichment of a Microorganism

Species of microorganisms living in soil as communities can contains multiple species. The multiple species can be due to the high mutation rates leading to a phenotype better equipped to tolerate the natural environmental conditions. Isolation and/or enrichment of these microbial organisms can provide a robust system to build organic matter and improve soil health. The isolation and/or enrichment of microorganisms used for the microbial compositions described herein from different soil types can lead to the development of phenotypes specialized to improve soil health in an ad hoc manner.

In some examples, soil can be collected from different agricultural fields, forestry, degraded land, horticultural land, recreational land, and wet land, and isolation and/or enrichment can be performed under nitrogen-fixing photoautotrophic growth conditions. For example, soil can be obtained from degraded soil known to have lost its ability to support vegetation. Such soil can be mixed with media in the absence of nitrogen and carbon. The growth in this soil may select for desired combinations of microorganisms which can be further sub-cultured (e.g., five passages) to isolate and confirm that the enriched species is free from unrelated microbes. The rate of nitrogen-fixation of the newly isolated microorganism can be calculated. Some non-limiting methods that can be used to calculate the rate of nitrogen-fixation can include, acetylene reduction assay [ARA], the Kjeldahl method, and incorporation of heavy isotope(s) (e.g., ¹⁵N₂) using elemental analyzer-Mass Spectrometry). The newly isolated microorganism can be used in a microbial composition as described herein. The effects of temperature, light, salinity, and pH as well as establish EPS production and rate of N₂ fixation can be determined for the microbial composition including the newly isolated microorganism. Further, 16S and 18S rDNA sequencing can be performed on the microorganisms in the microbial composition to identify the microorganisms in the microbial composition.

Provided herein are methods of selective enrichment, isolation, and characterization of photosynthetic and/or non-photosynthetic microorganism(s) from soil for the specific purpose of improving the health of soil and crops as well as for the purpose for carbon capture and sequestration in diverse land ecosystems, where the method includes: (a) providing a sample comprising uncharacterized and/or uncultivated photosynthetic and non-photosynthetic microorganism(s), wherein the sample is obtained from an environmental source; (b) subjecting the soil sample to grow (e.g., under light intensity) at a controlled temperature (e.g., with or without light); (c) enriching or isolating photosynthetic (e.g., any of the exemplary photosynthetic microorganisms described herein or known in the art) and non-photosynthetic microorganism(s) (e.g., any of the exemplary non-photosynthetic microorganisms described herein or known in the art) having one or more (e.g., one, two, three, four, five, six, seven, eight, nine, ten, eleven, or twelve) of the following activities: produces one or more carbon species (e.g., sugars and fatty acids); produces one or more nitrogen species (e.g., ammonia); produces one or more molecule(s) containing carbon and nitrogen (e.g., amino sugars, amino acids, and nucleobases); increases soil organic matter (e.g., compared to a control level); improves soil water-holding capacity (e.g., compared to a control level); demonstrates growth in different soil types with or without vegetation (e.g., compared to a control level); protects vegetation against plant pathogens; protects vegetation against pests; promotes growth of vegetation; produces molecules having one or more of insecticidal, herbicidal, anti-fungal, weed controlling, and seed germination activity; promotes root growth of vegetation; and inhibits denitrification; and (d) subjecting the photosynthetic and non-photosynthetic microorganism(s) to 16S and 18S ribosomal RNA sequencing to identify the species of enriched microorganism(s).

In some embodiments, inhibition of denitrification occurs via production of oxygen by the photosynthetic microorganism(s). In some embodiments, inhibition of denitrification occurs by release of molecules that inhibit denitrification. For example, the microbial composition can release chemicals that inhibit bacterial denitrification (e.g., the chemicals can inhibit aerobic and/or anaerobic denitrification). Non-limiting examples of chemicals that can be produced by the microbial composition and that inhibit denitrification include procyanidins. In one example, the microbial composition can produce a chemical (e.g., procyanidins) that increases the level of denitrification inhibition in the soil (e.g., increasing the level of nitrogen in the soil) as compared to the level of a control soil not contacted with any one of the microbial compositions described herein.

In some embodiments, the environmental source is selected from the group consisting of: including but not limited to agricultural land, farm land, recreational land, degraded land, forest land, vegetable land, landfill, mountains, fresh water, and marine water.

In some embodiments, the step of subjecting the soil sample to grow (e.g., under light intensity) at a controlled temperature (e.g., with or without light) is performed by providing one or more micronutrients to the soil which are selected by chemical analysis of the soil. In some embodiments, the step of subjecting the soil sample (e.g., including the microbial composition including one or more microorganism) to grow (e.g., under light intensity) at a controlled temperature (e.g., with or without light) is performed in the presence of micronutrients selected by chemical analysis of a soil. Chemical analysis of the soil can be performed by any of the methods described herein or known in the art. In some embodiments, chemical analysis of the soil can be done prior, contemporaneously with, or after application of the microbial composition to the soil and/or plant.

In some embodiments, the methods provided herein include a second application (e.g., contacting the plant and/or soil) with a second microbial composition. In some embodiments, the amount and/or concentration of first and/or second microbial compositions (e.g., the amount and/or concentration of one or more photosynthetic (e.g., any of the exemplary photosynthetic microorganisms described herein or known in the art) and/or one or more heterotrophic microorganisms (e.g., any of the exemplary heterotrophic microorganisms described herein or known in the art)) can be adjusted based on the chemical analysis of the soil. For example, following application of a first microbial composition to the soil (e.g., contacting the soil with a microbial composition), chemical analysis of the soil can be performed at a first time period following the application of the first microbial composition. Based on this chemical analysis at the first time period, the concentration and/or amount of microbial composition applied in a second application (e.g., contacted) can be based on the chemical analysis performed at the first time period.

In some embodiments, the method further comprises identifying heterotrophic microorganisms that have a mutual beneficial relationship with the one or more photosynthetic microorganism(s). In some embodiments, the method further comprises identifying heterotrophic microorganisms that provide a survival and/or growth benefit to the one or more photosynthetic microorganism(s).

In some embodiments, the method includes subjecting the photosynthetic and non-photosynthetic microorganism(s) to an identifying step where the species of enriched microorganism(s) are determined. Non-limiting examples of methods for identifying enriched microorganisms can be found in Beitwieser et al., Brief Bioinform., 20(4):1125-1136 (2019), which is herein incorporated by reference in its entirety. In some embodiments, the photosynthetic and non-photosynthetic microorganism(s) are subjected to 16S and 18S ribosomal RNA sequencing to identify the species of enriched microorganism(s). In some embodiments, the identifying of the heterotrophic microorganisms includes performing 16S and 18S ribosomal RNA sequencing.

### Methods for Determining Levels of Organic Matter, Carbon, and Nitrogen

The effect of the combinations of microorganisms included in the microbial compositions described herein can be determined by measuring the level of organic matter, total organic carbon, and total nitrogen. For example, microbial compositions described herein can be inoculated in 200 g of soil in a cup and grown in a growth chamber under the photoperiod of 12 hours light and/or 12 hours dark. About 10 g soil samples can be collected after growth for different days. The collected samples can be stored (e.g., at −20° C.) or immediately used for analysis. Non-limiting examples of assays used to determine the level of organic matter, total organic carbon, and/or total nitrogen can be performed using any of the exemplary assays described herein or known in the art. For example, a level of organic matter can be determined by Weight Lost on Ignition method as described by Schulte, E. E. and Hopkins, B. G. by Estimation of organic matter by weight loss-on-ignition. In Magdoff, F. R. et al. (eds.) Soil Organic Matter: Analysis and Interpretation. SSSA Spec. Pub. No. 46. SSSA, Madison. pp. 21-31. In some examples, total nitrogen can be determined as described in the Kieldahl method Lachat Instruments 1995 and/or Total Kjeldahl Nitrogen in Soil/Plant. QuikChem Method 13-107-06-2-D. In some examples, total organic carbon can be determined as described by the Walkley-Black procedure. In some examples, total organic carbon and total nitrogen is determined following treatment of soil with phosphoric acid to remove any calcium carbonate and then analysis with a carbon and nitrogen elemental analyzer.

### Utilization of Adaptive Laboratory Evolution (ALE) to Mutate Microorganisms

ALE can be used in organisms to obtain optimal phenotypes under given growth conditions. This approach can be helpful when there is a lack of knowledge on a genetic basis and/or an optimization involves interactions of complex genes and/or traits. The microorganisms included in the microbial compositions described herein can be mutated using ALE techniques to create a large population of phenotypic diversity. The microorganisms included in the microbial compositions described herein can be mutated with chemical mutagens such as ethyl methanesulfonate, methyl methanesulfonate, and ethyl nitrosourea among others. For example, if none of the microorganisms demonstrate growth over a broad range of temperatures and/or a faster recovery following exposure to sub-zero temperature as described above, the microorganisms may be mutated and optimized for the phenotype of the desired microorganism (e.g., temperature).

In other examples, a selected combination of microorganisms may exhibit growth at different temperatures and/or a minimal lag phase following exposure to different temperatures (e.g., sub-zero temperatures), light intensities, salinity, and/or pH to optimize the phenotype of the combination of microorganisms to be used in the microbial composition described herein. This method can be repeated multiple times as needed to obtain a phenotype that demonstrates a robust growth on soil under the targeted environmental conditions (e.g., attributes).

For example, combinations of microorganisms can be optimized to secrete nitrogen and carbon molecules. As described above in connection with ALE, chemical mutagenesis and/or ALE can be used to obtain a microorganism or combination of microorganisms that can secrete an amount of ammonia under nitrogen-fixing photoautotrophic conditions. In some examples, the outcome of introducing an ammonia-producing microorganism into soil includes a secretion of sunlight-dependent ammonia at a rate which can be a source of nitrogen to soil microbes and can help build the active pool of OM. In other examples, the outcome of introducing an ammonia-producing microorganism into soil includes an excessive accumulation of ammonia in soil during a non-cropping season. An excessive accumulation of ammonia in soil can potentially lead to an increased production of nitrous oxide (N₂O) (due to denitrification process). N₂O is a strong GHG typically associated with the excessive use of synthetic nitrogen fertilizers.

To avoid the generation of N₂O, the microorganisms included in a microbial composition described herein can be optimized to secrete a specific group of carbon and nitrogen species. Specifically, three groups of molecules: nucleobases and its derivatives (e.g., adenine, guanine, xanthine, cytosine, thymine, hypoxanthine etc.), aspartate-family amino acids (e.g., aspartic acid, asparagine, leucine, methionine, and threonine), and branched-chain amino acids (e.g., isoleucine, leucine, and valine). Additionally, nucleosides adenosine, inosine, guanosine, and xanthosine can be secreted. These three groups of molecules can be utilized by beneficial soil microbes (e.g., methanotroph and/or heterotrophic microorganisms) as a source of carbon and/or nitrogen.

In some examples, nucleobases are one of the metabolites produced by cyanobacterial species for the heterotrophic organisms in soil. For example, to create microorganisms that secrete nucleobases and its derivatives, chemical mutagenesis and selection (as described above in connection with ALE) using specific analogs, such as 8-azaguanine, 6-azauracil, 2-diazo-5-oxo-L-norleucine, decoyinine, 6-mercaptoguanine, etc., can be used. For example, to create microorganisms that secrete amino acids belonging to aspartate and/or branched-chain amino acids, analogs such as norleucine, S-2-aminoethyl-L-cysteine, ethionine, methyl-methionine, and hydroxynorvaline can be utilized.

### Methods of Using the Microbial Composition

In some embodiments a method can included contacting a soil, a plant, or both with any one of the microbial compositions described herein. In some examples, prior to contacting any one of the microbial compositions described herein the soil can include insufficient nitrogen species content. Optionally, in some embodiments, the method can further include determining the amount of nitrogen species in the soil prior to contact with any one of the microbial compositions described herein. In some embodiments, the method can further include determining the nitrogen species level prior to contacting the soil with any one of the microbial compositions described herein to be about 0.04 g per 100 g of the soil. The method can further include, increasing a level of nitrogen species in the soil, the method comprising contacting the soil with any one of the microbial compositions described herein. The method can further include increasing the level of nitrogen species in the soil as compared to the level of a control soil not contacted with the microbial composition. In some embodiments, the method results in the nitrogen species in the soil increasing about 25% as compared to the level of a control soil not contacted with any one of the microbial compositions described herein. In some embodiments, the method results in the nitrogen species in the soil increasing about 50% as compared to the level of a control soil not contacted with any one of the microbial compositions described herein. In some embodiments, the method results in the nitrogen species in the soil increasing about 75% as compared to the level of a control soil not contacted with any one of the microbial compositions described herein. In some embodiments, the method results in the nitrogen species in the soil increasing about 100% as compared to the level of a control soil not contacted with any one of the microbial compositions described herein.

In some embodiments a method can included contacting a soil, a plant, or both with any one of the microbial compositions described herein. In some examples, prior to contacting any one of the microbial compositions described herein the soil can include insufficient carbon species content. Optionally, in some embodiments, the method can further include determining the amount of carbon species in the soil prior to contact with any one of the microbial compositions described herein. In some embodiments, the method can further include determining the carbon species level prior to contacting the soil with any one of the microbial compositions described herein to be about 0.57 g per 100 g of the soil. The method can further include, increasing a level of carbon species in the soil, the method comprising contacting the soil with any one of the microbial compositions described herein. The method can further include increasing the level of carbon species in the soil as compared to the level of a control soil not contacted with the microbial composition. In some embodiments, the method results in the carbon species in the soil increasing about 20% as compared to the level of a control soil not contacted with any one of the microbial compositions described herein. In some embodiments, the method results in the carbon species in the soil increasing about 40% as compared to the level of a control soil not contacted with any one of the microbial compositions described herein. In some embodiments, the method results in the carbon species in the soil increasing about 60% as compared to the level of a control soil not contacted with any one of the microbial compositions described herein. In some embodiments, the method results in the carbon species in the soil increasing about 80% as compared to the level of a control soil not contacted with any one of the microbial compositions described herein.

In some embodiments a method can included contacting a soil, a plant, or both with any one of the microbial compositions described herein. In some examples, prior to contacting any one of the microbial compositions described herein the soil can include insufficient organic matter content. Optionally, in some embodiments, the method can further include determining the amount of organic matter in the soil prior to contact with any one of the microbial compositions described herein. In some embodiments, the method can further include determining the organic matter level prior to contacting the soil with any one of the microbial compositions described herein to be about 0.1 g per 100 g of the soil to about 11 g per 100 g of the soil. The method can further include, increasing a level of organic matter in the soil, the method comprising contacting the soil with any one of the microbial compositions described herein. The method can further include increasing the level of organic matter in the soil as compared to the level of a control soil not contacted with the microbial composition. In some embodiments, the method results in the organic matter in the soil increasing about 20% as compared to the level of a control soil not contacted with any one of the microbial compositions described herein. In some embodiments, the method results in the organic matter in the soil increasing about 5% to about 15% as compared to the level of a control soil not contacted with any one of the microbial compositions described herein. In some embodiments, the method results in the organic matter in the soil increasing about 10% to about 11% as compared to the level of a control soil not contacted with any one of the microbial compositions described herein. In some embodiments, the method results in the organic matter in the soil increasing about 10% to about 20% as compared to the level of a control soil not contacted with any one of the microbial compositions described herein.

In some embodiments a method can included contacting a soil, a plant, or both with any one of the microbial compositions described herein. In some examples, prior to contacting any one of the microbial compositions described herein the soil can include insufficient exopolysaccharides content. Optionally, in some embodiments, the method can further include determining the amount of exopolysaccharides in the soil prior to contact with any one of the microbial compositions described herein. In some embodiments, the method can further include determining the exopolysaccharides level prior to contacting the soil with any one of the microbial compositions described herein to be about 0.01 g per 100 g of the soil to about 1 g per 100 g of the soil. The method can further include, increasing a level of exopolysaccharides in the soil, the method comprising contacting the soil with any one of the microbial compositions described herein. The method can further include increasing the level of exopolysaccharides in the soil as compared to the level of a control soil not contacted with the microbial composition. In some embodiments, the method results in the exopolysaccharides in the soil increasing 2% to about 15% as compared to the level of a control soil not contacted with any one of the microbial compositions described herein. In some embodiments, the method results in the exopolysaccharides in the soil increasing about 5% to about 10% as compared to the level of a control soil not contacted with any one of the microbial compositions described herein. In some embodiments, the method results in the exopolysaccharides in the soil increasing about 5% as compared to the level of a control soil not contacted with any one of the microbial compositions described herein. In some embodiments, the method results in the exopolysaccharides in the soil increasing about 10% to about 20% as compared to the level of a control soil not contacted with any one of the microbial compositions described herein.

In some embodiments a method can included contacting a soil, a plant, or both with any one of the microbial compositions described herein. In some examples, prior to contacting any one of the microbial compositions described herein the soil can include insufficient potassium, iron, phosphate, and phosphorus content. Optionally, in some embodiments, the method can further include determining the amount of potassium, iron, phosphate, and phosphorus in the soil prior to contact with any one of the microbial compositions described herein. In some embodiments, the method can further include determining the potassium, iron, phosphate, and phosphorus level prior to contacting the soil with any one of the microbial compositions described herein to be about 30-80% biologically unavailable to plants. The microorganisms included in the microbial compositions described herein can solubilize the potassium, iron, phosphate, and phosphorous to an increased level of bioavailability. The method can further include, increasing a level of potassium, iron, phosphate, and phosphorus in the soil, the method comprising contacting the soil with any one of the microbial compositions described herein. The method can further include increasing the level of potassium, iron, phosphate, and phosphorus in the soil as compared to the level of a control soil not contacted with the microbial composition. In some embodiments, the method results in the potassium, iron, phosphate, and phosphorus in the soil increasing 2% to about 15% as compared to the level of a control soil not contacted with any one of the microbial compositions described herein. In some embodiments, the method results in the potassium, iron, phosphate, and phosphorus in the soil increasing about 5% to about 10% as compared to the level of a control soil not contacted with any one of the microbial compositions described herein. In some embodiments, the method results in the potassium, iron, phosphate, and phosphorus in the soil increasing about 5% as compared to the level of a control soil not contacted with any one of the microbial compositions described herein. In some embodiments, the method results in the potassium, iron, phosphate, and phosphorus in the soil increasing about 10% to about 20% as compared to the level of a control soil not contacted with any one of the microbial compositions described herein.

In some embodiments a method can included contacting a soil, a plant, or both with any one of the microbial compositions described herein. In some examples, prior to contacting any one of the microbial compositions described herein the soil can include insufficient siderophore content. Optionally, in some embodiments, the method can further include determining the amount of siderophore in the soil prior to contact with any one of the microbial compositions described herein. In some embodiments, the method can further include determining the siderophore level prior to contacting the soil with any one of the microbial compositions described to be about biologically unavailable to plants. The microorganisms included in the microbial compositions described herein can increase a level of siderophore bioavailability. The method can further include, increasing a level of siderophore in the soil, the method comprising contacting the soil with any one of the microbial compositions described herein. The method can further include increasing the level of siderophore in the soil as compared to the level of a control soil not contacted with the microbial composition. In some embodiments, the method results in the siderophore in the soil increasing 2% to about 15% as compared to the level of a control soil not contacted with any one of the microbial compositions described herein. In some embodiments, the method results in the siderophore in the soil increasing about 5% to about 10% as compared to the level of a control soil not contacted with any one of the microbial compositions described herein. In some embodiments, the method results in the siderophore in the soil increasing about 5% as compared to the level of a control soil not contacted with any one of the microbial compositions described herein. In some embodiments, the method results in the siderophore in the soil increasing about 10% to about 20% as compared to the level of a control soil not contacted with any one of the microbial compositions described herein.

In some embodiments a method can included contacting a soil, a plant, or both with any one of the microbial compositions described herein. In some examples, prior to contacting any one of the microbial compositions described herein the soil can include insufficient molecules containing carbon and nitrogen (e.g., sugars and fatty acids) content. Optionally, in some embodiments, the method can further include determining the amount of molecules containing carbon and nitrogen (e.g., sugars and fatty acids) in the soil prior to contact with any one of the microbial compositions described herein. In some embodiments, the method can further include determining the molecules containing carbon and nitrogen (e.g., sugars and fatty acids) level prior to contacting the soil with any one of the microbial compositions described to be about biologically unavailable to plants. The microorganisms included in the microbial compositions described herein can increase a level of bioavailability of molecules containing carbon and nitrogen (e.g., sugars and fatty acids). The method can further include, increasing a level of molecules containing carbon and nitrogen (e.g., sugars and fatty acids) in the soil, the method comprising contacting the soil with any one of the microbial compositions described herein. The method can further include increasing the level of molecules containing carbon and nitrogen (e.g., sugars and fatty acids) in the soil as compared to the level of a control soil not contacted with the microbial composition. In some embodiments, the method results in the molecules containing carbon and nitrogen (e.g., sugars and fatty acids) in the soil increasing 2% to about 15% as compared to the level of a control soil not contacted with any one of the microbial compositions described herein. In some embodiments, the method results in the molecules containing carbon and nitrogen (e.g., sugars and fatty acids) in the soil increasing about 5% to about 10% as compared to the level of a control soil not contacted with any one of the microbial compositions described herein. In some embodiments, the method results in the molecules containing carbon and nitrogen (e.g., sugars and fatty acids) in the soil increasing about 5% as compared to the level of a control soil not contacted with any one of the microbial compositions described herein. In some embodiments, the method results in the molecules containing carbon and nitrogen (e.g., sugars and fatty acids) in the soil increasing about 10% to about 20% as compared to the level of a control soil not contacted with any one of the microbial compositions described herein.

In some embodiments a method can included contacting a soil, a plant, or both with any one of the microbial compositions described herein. In some examples, prior to contacting any one of the microbial compositions described herein the soil can include insufficient water-holding capacity. Optionally, in some embodiments, the method can further include determining the amount of water-holding capacity in the soil prior to contact with any one of the microbial compositions described herein. In some embodiments, the method can further include determining the water-holding capacity prior to contacting the soil with any one of the microbial compositions described to be about biologically unavailable to plants. The microorganisms included in the microbial compositions described herein can increase a level of the water-holding capacity. The method can further include, increasing a level of water-holding capacity in the soil, the method comprising contacting the soil with any one of the microbial compositions described herein. The method can further include increasing the level of water-holding capacity in the soil as compared to the level of a control soil not contacted with the microbial composition. In some embodiments, the method results in the water-holding capacity in the soil increasing 2% to about 15% as compared to the level of a control soil not contacted with any one of the microbial compositions described herein. In some embodiments, the method results in the water-holding capacity in the soil increasing about 5% to about 10% as compared to the level of a control soil not contacted with any one of the microbial compositions described herein. In some embodiments, the method results in the water-holding capacity in the soil increasing about 5% as compared to the level of a control soil not contacted with any one of the microbial compositions described herein. In some embodiments, the method results in the water-holding capacity in the soil increasing about 10% to about 20% as compared to the level of a control soil not contacted with any one of the microbial compositions described herein.

In some embodiments a method can included contacting a soil, a plant, or both with any one of the microbial compositions described herein. In some examples, prior to contacting any one of the microbial compositions described herein the soil can include insufficient protection to vegetation against pathogens (e.g., pathogen protection capacity of the soil). Optionally, in some embodiments, the method can further include determining the pathogen protection capacity of the soil prior to contacting with any one of the microbial compositions described herein. In some embodiments, the method can further include determining the pathogen protection capacity of the soil prior to contacting the soil with any one of the microbial compositions described to be about biologically unavailable to plants. The microorganisms included in the microbial compositions described herein can increase a level of the pathogen protection capacity of the soil. The method can further include, increasing a level of pathogen protection capacity of the soil, the method comprising contacting the soil with any one of the microbial compositions described herein. The method can further include increasing the pathogen protection capacity of the soil as compared to the level of a control soil not contacted with the microbial composition.

In some embodiments a method can included contacting a soil, a plant, or both with any one of the microbial compositions described herein. In some examples, prior to contacting any one of the microbial compositions described herein the soil can include insufficient protection to vegetation against pests (e.g., pests (e.g., any of the exemplary pests described herein or known in the art) protection capacity of the soil). Optionally, in some embodiments, the method can further include determining the pest protection capacity of the soil prior to contacting with any one of the microbial compositions described herein. In some embodiments, the method can further include determining the pest protection capacity of the soil prior to contacting the soil with any one of the microbial compositions described to be about biologically unavailable to plants. The microorganisms included in the microbial compositions described herein can increase a level of the pest protection capacity of the soil. The method can further include, increasing a level of pest protection capacity of the soil, the method comprising contacting the soil with any one of the microbial compositions described herein. The method can further include increasing the pest protection capacity of the soil as compared to the level of a control soil not contacted with the microbial composition.

In some embodiments, the method includes contacting soil or a plant with a microbial composition (e.g., any of the microbial compositions described herein) and enriching the soil with carbon. In some embodiments, the method includes enriching the soil with at least 0.25 tons of carbon per acre (e.g., at least 0.50 tons of carbon per acre, at least 0.75 tons of carbon per acre, at least 1.0 tons of carbon per acre, at least 1.25 tons of carbon per acre, at least 1.5 tons of carbon per acre, at least 2.0 tons of carbon per acre, at least 2.5 tons of carbon per acre, at least 5.0 tons of carbon per acre, at least 10 tons of carbon per acre, at least 25 tons of carbon per acre, at least 50 tons of carbon per acre, or at least 100 tons of carbon per acre).

### Application on Non-Agricultural Land and Soil Reclamation

Also provided herein are methods of selective enrichment, isolation, and characterization of photosynthetic and non-photosynthetic microorganism(s) from soil for the specific purpose of soil reclamation as well as to improve the soil health and quality in non-agricultural land such as forestry, recreational land, horticultural land, and wet land, where the method includes (a) providing a sample comprising uncharacterized and/or uncultivated photosynthetic and non-photosynthetic microorganism(s), wherein the sample is obtained from an environmental source; (b) subjecting the soil sample to grow at a controlled temperature with or without light; (c) enriching or isolating photosynthetic and non-photosynthetic microorganism(s) having one or more of following activities: produces one or more carbon species; produces one or more nitrogen species; produces one or more molecule(s) containing carbon and nitrogen; increases soil organic matter; improves soil water-holding capacity; demonstrates growth in different soil types with or without vegetation; protects vegetation against plant pathogens; protects vegetation against pests; promotes growth of vegetation; produces molecules having one or more of insecticidal, herbicidal, anti-fungal, weed controlling, and seed germination activity; promotes root growth of vegetation; and inhibits denitrification; and (d) subjecting the photosynthetic and non-photosynthetic microorganism(s) to 16S and 18S ribosomal RNA sequencing to identify the species of enriched microorganism(s).

Also provided herein are compositions (e.g., microbial compositions) used for soil reclamation as well as to improve the soil health and quality in non-agricultural land such as forestry, recreational land, horticultural land, and wet land that include: (a) one or more photosynthetic microorganism(s); and (b) one or more agricultural adjuvant(s); wherein the microbial composition has one or more of any of the following activities: produces one or more carbon species; produces one or more nitrogen species; produces one or more molecule(s) containing carbon and nitrogen; increases soil organic matter; improves soil water-holding capacity; demonstrates growth in different soil types with or without vegetation; protects vegetation against plant pathogens; protects vegetation against pests; promotes growth of vegetation; produces molecules having one or more of insecticidal, herbicidal, anti-fungal, weed controlling, and seed germination activity; promotes root growth of vegetation; and inhibits denitrification.

Also provided herein are methods for generating a composition (e.g., a microbial composition) for use in soil reclamation as well as for improving the soil health and quality in non-agricultural land such as forestry, recreational land, horticultural land, and wet land, where the method includes: (a) providing a combination of one or more photosynthetic microorganism(s); (b) determining a level of one or more activities of the combination selected from the group consisting of: production of one or more carbon species; production of one or more nitrogen species; production of one or more molecule(s) containing carbon and nitrogen; production of organic matter; soil water-holding capacity; growth in different soil types with or without vegetation; protection of vegetation against plant pathogens; protection of vegetation against pests; promotion of growth of vegetation; production of molecules having one or more of insecticidal, herbicidal, anti-fungal, weed controlling, and seed germination activity; promotion of root growth of vegetation; and inhibition of denitrification; (c) selecting a combination having an elevated level of the one or more activities as compared to a control level(s); and (d) producing a microbial composition comprising the selected combination and one or more agricultural excipient(s).

In some embodiments, a method for soil reclamation as well as for improving the soil health and quality in non-agricultural land such as forestry, recreational land, horticultural land, and wet land includes contacting the soil with one or more of the compositions (e.g., microbial compositions) described herein, wherein the contacting increases one or more of: a level of nitrogen species, a level of carbon species, a level of organic matter, a level of exopolysaccharides, a level of solubilized potassium, iron, and phosphorus, a level of a siderophore, and/or the bioavailability of sulfur, boron, magnesium, or manganese in the soil as compared to soil not contacted with the one or more microbial compositions.

In some embodiments, a method for soil reclamation includes contacting the soil with one or more of the compositions (e.g., microbial compositions) described herein, wherein the contacting results in a decrease in the level (e.g., amount) of one or more of a pollutant, waste, sewage, metal, heavy metal, radioisotope, chemical agent, and/or biological agent.

In some embodiments, the environmental source of the soil that is to be reclaimed includes, without limitation, agricultural land, farm land, forest land, vegetable land, recreational land, pasture land, horticulture land, landfill, mountains, mining land, drilling land, and wet land.

In some embodiments, the environmental source of the soil that is to be reclaimed includes non-agricultural land. Non-limiting examples of non-agricultural land include degraded grazing land, forestry, horticulture land, wet land, degraded land that has limited ability to support growth of vegetation, recreational land, residential land, commercial land (i.e., non-farming commercial use), industrial land (i.e., non-farming industrial use), land used for transportation, or publicly used land.

In some embodiments, industrial land use includes, without limitation, land harboring (or once having harbored) factories, refineries, energy generating stations, utility stations, water- and sewage-treatment facilities, mines, smelters, mills, wells for the production of fossil fuels such as oil, coal, and natural gas, and water-holding reservoirs.

### EXAMPLES

### Example 1. Effect of a Microbial Composition Including Cyanobacteria on Organic Matter (OM), Total Nitrogen, and Total Organic Carbon in Soil

A set of experiments was performed to determine the effect a microbial composition including cyanobacteria had on OM, total organic carbon, and total nitrogen in soil. The levels of OM are depicted in FIG. 3. The levels of total organic carbon are depicted in FIG. 4. The levels of total nitrogen are depicted in FIG. 5.

### Materials and Methods

### Microbial Composition

Disclosed herein, a microbial composition can include one or more cyanobacterial species: Anabaena 33047-1+, Anabaena 33047-2+, Nostoc commune+, Nostoc calcicola+, and Nostoc longstaffi+. These cyanobacterial species were optimized using ALE for the optimal performance on different types of soil. Chemical mutagens were used to collectively optimize the functionality of all components of microbial composition for the rapid growth and adaptations to the environmental conditions on soil. Chemical mutagens and selection against specific analogs to secrete specific carbon and nitrogen containing molecules by nitrogen-fixing cyanobacteria for utilization by the heterotrophic components of the microbial composition.

### Cell Culture

Plastic cups were used to contain the soil as well as the cells for each experiment and condition. 150 g soil was transferred into respective transparent plastic cups. Cells were grown under two different conditions: “low-water”—soil was wetted with water sufficient enough to moist soil, and “high-water”—soil was submerged in water. All cups containing cyanobacterial species were grown at 30° C. under continuous light (100 μE·m⁻²·s⁻¹). After growth for 20 days, the soil in each respective cup were dried, individually ground and sent to the Soil and Forage Analysis Lab, University of Wisconsin, Madison, USA for respective measurements of OM, nitrogen and carbon. ‘+’ in front of species name denotes presence of additional microbes. Anabaena 33047, a marine isolate, and Nostoc species, soil isolates, were obtained from UTEX culture collection.

### Soil

The soil used in each of the cups was degraded. The soil used for experiments measuring the OM amount had a low OM of 0.6% (FIG. 3). The soil used for experiments measuring total organic carbon amount was 0.57 g/100 g soil (FIG. 4). The soil used for experiments measuring total nitrogen amount was 0.04 g/100 g soil (FIG. 5).

### Results

The results indicated an increase in total organic carbon, total nitrogen, and OM in the respective soil by the microbial composition. All five cyanobacterial species based microbial compositions increased OM compared to control soil albeit at different rates. In general, all cyanobacterial species growing in high-water conditions led to 33% increase OM (0.8% vs. 0.6% in control soil) in 20 days (FIG. 3). In contrast, cyanobacterial species growing in low-water condition resulted in a variable increase in OM. However, increase in OM by Nostoc longstaffi based microbial composition was the same in both low water and high water conditions.

All five cyanobacterial species based microbial compositions increased total organic carbon by 40% (FIG. 4) and total nitrogen by 100% (FIG. 5) compared to control soil. In general, increase in total organic carbon and total nitrogen was more apparent in the high-water condition compared to the low-water condition. Total organic carbon produced by Nostoc longstaffi in low-water condition soil was slightly more than the high-water condition soil. Since the amount of EPS contribute significantly to the total organic carbon, this result suggests that 5 Nostoc longstaffi produced more EPS in the low-water condition soil, which may allow it hold more water and provide platform for a better biomass production in a water-limiting condition. Nonetheless, these results clearly demonstrate the potential of cyanobacterial species based microbial composition for improving total organic carbon, total nitrogen, and OM in soil under natural conditions.

### Example 2. Effect of a Microbial Composition Including Cyanobacteria on Organic Matter (OM), Total Organic Carbon, and Total Nitrogen on Different Types of Soil

A set of experiments was performed to determine the effect a microbial composition including cyanobacteria had on OM on different types of soil. The levels of growth of microbial composition are depicted in FIG. 6 where images of day #1, Day #6, and Day 13 are shown. Results are further presented graphically in FIG. 7 for OM increase, FIG. 8 for total organic carbon, and FIG. 9 for total nitrogen.

### Materials and Methods

### Microbial Composition

In these experiments, the microbial composition can include one or more cyanobacterial species enriched from soil under nitrogen- and carbon-fixing conditions: These cyanobacterial species were optimized using ALE for the optimal performance on different types of soil. Chemical mutagens were used to collectively optimize the functionality of all components of microbial composition for the rapid growth and adaptations to the environmental conditions on soil. Chemical mutagens and selection against specific analogs to secrete specific carbon and nitrogen containing molecules by nitrogen-fixing cyanobacteria for utilization by the heterotrophic components of the microbial composition.

### Cell Culture

Plastic cups were used to contain the soil as well as the cells for each experiment and condition. About 20 g soil was transferred into respective transparent plastic cups. The degraded soil included about 0.6% OM, about 0.04% total nitrogen, and about 0.57% total organic carbon. The healthy soil included about 1.4% OM, about 0.09% total nitrogen, and about 0.9% total organic carbon content. About 20 g of soil was transferred to each cup for a total of 246 cups. About 0.1 mg (about 500 g per hectare) was added to each cup of soil. The cups were incubated in a growth chamber at about 30° C. in relatively low light (e.g., about 50 μE·m⁻²·s⁻¹).

### Results

The results indicate that the microbial composition can provide rapid OM growth in both healthy soil and degraded soil. FIG. 7 shows that multiple microbial compositions exhibited an increase in OM versus the control in both the degraded soil (about 0.1-0.4% in 13 days) and the healthy soil (about 0.1-0.3% in 13 days). FIG. 8 shows that multiple microbial compositions exhibited an increase in total organic carbon versus the control in both the degraded soil (about 18.0-46.0% increase in 13 days) and the healthy soil (about 9.0-44.0% increase in 13 days). FIG. 9 shows that multiple microbial compositions exhibited an increase in total nitrogen versus the control in both the degraded soil (about 25.0-100.0% increase in 13 days) and the healthy soil (about 11.0-44.0% increase in 13 days). These results demonstrate the potential of cyanobacterial species based microbial composition for improving total organic carbon, total nitrogen, and OM in soil under natural conditions.

### Example 3. Effect of Changing Temperatures on the Growth of a Plurality of Microbial Compositions Including Cyanobacteria

A set of experiments was performed to determine the effect of changing temperature of a microbial composition including cyanobacteria. The levels of growth are depicted in FIG. 10 where images of Day #1, Day #6, and Day #16 are shown for two examples microbial compositions including example microbial compositions #24 and #118.

### Materials and Methods

### Microbial Composition

In these experiments, the microbial composition can include one or more cyanobacterial species: enriched from soil under nitrogen- and carbon-fixing conditions. These cyanobacterial species were optimized using ALE for the optimal performance on different types of soil. Chemical mutagens were used to collectively optimize the functionality of all components of microbial composition for the rapid growth and adaptations to the environmental conditions on soil. Chemical mutagens and selection against specific analogs to secrete specific carbon and nitrogen containing molecules by nitrogen-fixing cyanobacteria for utilization by the heterotrophic components of the microbial composition.

### Cell Culture

Plastic cups were used to contain the soil as well as the cells for each experiment and condition. About 40 g soil was transferred into respective transparent plastic cups for a total of 40 cups. About 0.1 mg of each microbial composition #24 and #118 (about 500 g per hectare) was added to each cup of soil. The cups were exposed to different temperatures (−20° C., 4° C., and 37° C.) for two hours every 24 hours. The cups were incubated in growth chambers at 30° C. in relatively low light (e.g., about 50 μE·m⁻²·s⁻¹).

### Results

Results demonstrate that many of the microbial composition were able to tolerate changes in temperature both low and high, and provide the intended benefit of enriching soil with organic matter, total organic carbon, and total nitrogen. However, as can be seen from FIG. 10, not all microbial compositions are suited for the changes in temperatures. For example, the microbial composition #118 was sensitive to low temperature (−20° C.) as treatment at this temperature resulted in reduced growth of the microbial composition. These results demonstrate the potential of such strategy which can be used to identify cyanobacterial species based microbial composition that are tolerant to wide changes in temperatures and therefore, can be used for the intended benefit of improving total organic carbon, total nitrogen, and OM in soil under natural conditions.

### Example 4. Effect of Enrichment and Growth of a Plurality of Microbial Compositions Including Cyanobacteria Using Modified Burk's Medium

A set of experiments was performed to determine the effect of enrichment and growth of a plurality of microbial compositions including cyanobacteria. The levels of growth are depicted in FIG. 11.

### Materials and Methods

### Microbial Composition

In these experiments, the microbial composition can include one or more cyanobacterial species enriched from soil under nitrogen- and carbon-fixing conditions in the presence of light. FIG. 11 shows the enrichment of cyanobacterial species from 100 different soil sites that are able to fix carbon and nitrogen. These microbial compositions have been sub-cultured at least twenty times. They grow well both in liquid media and on soil under carbon and nitrogen-fixing conditions. Further, pigment color of enriched cyanobacterial species suggests the successful in enrichment of multiple species of nitrogen-fixing cyanobacteria.

### Cell Culture

Growth of enriched cyanobacteria in modified Burk's medium in the absence of carbon and nitrogen sources at 30° C. under continuous light (100 μE·m⁻² s⁻¹).

### Results

As shown in Example #3, not all soil cyanobacterial species based microbial compositions are suited for the intended benefits to improve total organic carbon, total nitrogen, and total organic carbon in soil. As soil functions are controlled by interaction of physical, chemical and biological components, it is imperative to isolated/enrich cyanobacterial species from multiple different types of soil. FIG. 11 shows the results of such enrichment that have been carried out using soils collected from more than 100 different sites. These cyanobacterial species are different as seen from different pigments, grow at different rates, and also shows difference in their tolerance to changes in temperature (FIG. 10) and moisture content (FIG. 14). Having the access to such large collections of cyanobacterial species based microbial compositions allow some to isolate such compositions that are tolerant to the natural climatic conditions as well as different types of soil to achieve the goal of increasing organic matter, total organic carbon, total nitrogen, and improved water-holding capacity in a soil.

### Example 5. Secretion of Ammonia by an Optimized Nostoc commune

A set of experiments was performed to determine the secretion of ammonia by an optimized Nostoc commune. The total ammonia secreted is depicted in a graph of FIG. 12 (A) and the rate of secretion is depicted by FIG. 12 (B).

### Materials and Methods

### Microbial Composition and Cell Culture

Chemical mutagen and selection in the presence of analogs (Methionine sulfoximine, Ethylenediamine, Methylammonium, etc.) to obtain ammonia secreting Nostoc commune under nitrogen-fixing photoautotrophic conditions. The amount of secreted ammonia was measured in the supernatant. Cells were grown in liquid nitrogen-free BG11 media at 30° C. in continuous light (100 μE·m⁻²·s⁻¹). The amount of secreted ammonia was measured enzymatically using glutamate dehydrogenase, oxoglutarate, and NADH.

### Results

Two of the strains produced a total of about 0.25 g ammonia/gCDW in 7 days. Results also indicated that the specific rate of ammonia secreted depended on growth stage (FIG. 12 graph B): the rate of ammonia production was maximal on day 4 in species 2, day 6 in species 3, and day 7 in species 1. This suggests that the mechanism resulting in ammonia secretion in the three strains is due to mutation(s) at different locus. Strain 2 produced about 100 mg/gCDW on day 4 alone highlighting the capability of this strain to produce high amount of fixed nitrogen molecules while growing photoautotrophically. Further, the total amount of ammonia secreted may have reached a steady state due to inhibition, and that production by these strains could be higher provided there is a continuous consumption of ammonia.

### Example 6. Aggregate Formation, Storage and Regrowth of Cyanobacteria

A set of experiments was performed to determine the aggregate formation, storage and regrowth of cyanobacteria Nostoc commune. Pictures of the aggregate regrowth are shown in FIG. 13.

### Materials and Methods

### Microbial Composition

Nostoc commune was used to demonstrate the robustness of cyanobacterial species. Cells were grown on N-free BG11 solid plate until it dried [FIG. 13 (A)]. The dried material containing cells was stored at −20° C., and subsequently transferred in nitrogen-free liquid BG11 medium [FIG. 13 (B)], and grown for 1 week at 30° C. in continuous light (100 μE·m⁻²·s⁻¹). Nostoc commune was also used to determine the formation of crust on soil. Such crust have ability to withstand loss of topsoil by wind and rainfall. FIG. 13 (C) is a picture of a sand crust that had formed.

### Results

Although there can be a lag period, cells nonetheless grew. Such example shows resilience of the cyanobacterial species to extended drought conditions, and provides confidence that inoculation of the microbial composition in a soil, in which there is a prolonged drought conditions, would nonetheless allow the intended benefit when there is rainfall. Similarly, this example determined the ability of cyanobacteria to form sand crust [FIG. 13 (C)]. Growth of Nostoc commune on sand led to formation of a thick crust due to the production of EPS. A water drop test, which simulates the resistance of crust aggregate to rain drop impact, showed it to be very stable. Such example provides evidence of forming soil aggregates which will prevent loss of topsoil to wind, rainfall and other physical disturbances.

### Example 7. Effect of Moisture Content on the Growth of a Plurality of Microbial Compositions Including Cyanobacteria

A set of experiments was performed to determine the effect of moisture content (water level) in soil of a microbial composition including cyanobacteria. The levels of growth are depicted in FIG. 14 where images of Day #0, Day #7, and Day #18 are shown for three examples microbial compositions including example microbial compositions #106, #107, and #123.

### Materials and Methods

### Microbial Composition

In these experiments, the microbial composition can include one or more cyanobacterial species: enriched from soil under nitrogen- and carbon-fixing conditions. These cyanobacterial species were optimized using ALE for the optimal performance on different types of soil. Chemical mutagens were used to collectively optimize the functionality of all components of microbial composition for the rapid growth and adaptations to the environmental conditions on soil. Chemical mutagens and selection against specific analogs to secrete specific carbon and nitrogen containing molecules by nitrogen-fixing cyanobacteria for utilization by the heterotrophic components of the microbial composition.

### Cell Culture

Plastic cups were used to contain the soil as well as the cells for each experiment and condition. About 40 g soil was transferred into respective transparent plastic cups for a total of 40 cups. About 0.1 mg of each microbial composition compositions #106, #107, and #123 (about 500 g per hectare) was added to each cup of soil. On day 0, few cups were provide with water whereas other cups did not had any water. On day 7, water was added to cup that did not received water on day 0. The cups were incubated in growth chambers at 30° C. in relatively low light (e.g., about 50 μE·m⁻²·s⁻¹).

### Results

Results demonstrate that many of the microbial composition were able to tolerate extreme drought conditions, and provide the intended benefit of enriching soil with organic matter, total organic carbon, and total nitrogen when they have access to moisture. By Day 7, it is clear from FIG. 14, that cups which were provided with water, there was sufficient growth of cyanobacterial species. However, those cups that did not have access to water (cups on left in the middle panel of Day #7), there was no growth of cyanobacterial species as seen from the absence of green pigments. However, when water was added to these cups on day #7, we observed growth of cyanobacterial species on day #18 establishing that these cyanobacterial species can tolerate extended period of drought. These results demonstrate the potential of such strategy which can be used to identify cyanobacterial species based microbial composition that are tolerant to extended period of drought, and therefore, can be used for the intended benefit of improving total organic carbon, total nitrogen, and OM in soil under natural conditions.

### Example 8. Field Trials—Effect of a Microbial Composition Containing Cyanobacteria on Total Organic Carbon, Total Nitrogen, and Organic Matter of Soil

A set of field trial experiments was performed to determine the effect a microbial composition containing cyanobacteria had on total organic carbon, total nitrogen, and organic matter of soil. The levels of total nitrogen are depicted in FIG. 15. The levels of total organic carbon are depicted in FIG. 16. The levels of organic matter are depicted in FIG. 17.

### Materials and Methods

### Microbial Composition

In these experiments, the microbial composition can include one or more cyanobacterial species: enriched from soil under nitrogen- and carbon-fixing conditions. These cyanobacterial species were optimized using ALE for the optimal performance on different types of soil. Chemical mutagens were used to collectively optimize the functionality of all components of microbial composition for the rapid growth and adaptations to the environmental conditions on soil. Chemical mutagens and selection against specific analogs to secrete specific carbon and nitrogen containing molecules by nitrogen-fixing cyanobacteria for utilization by the heterotrophic components of the microbial composition.

### Field Trial Conditions

In these experiments, a total of four plots were used, including one as control and three for the three MGC consortia (MGC-1, MGC-2, and MGC-3). Each plot size was about 30,000 square feet (e.g., about 0.7 acre). Soybeans were planted on each plot following the same standard procedure. About four weeks prior to planting the soybeans, about 250 grams of the microbial composition was applied to the soil. Soil samples (up to the depth of 6 inches) were collected at three different times: Sample #1: about 10 weeks post application of the microbial composition to the soil; Sample #2: about 15 weeks post application of the microbial composition to the soil; Sample #3: about 28 weeks post application of the microbial composition to the soil. A total of nine samples (e.g., nine different locations) per plot were collected (9 samples per plot; total=36 soil samples).

### Results

Results demonstrate the microbial composition was able to promote growth, and provide the intended benefit of enriching soil with nitrogen (FIG. 15), organic carbon (FIG. 16), and organic matter (FIG. 17). In addition, the results demonstrate the microbial composition was able to enrich the soil for photosynthetic microorganisms as the applied microbial composition from soil sample #1 and sample #2 was successfully recovered. These results demonstrate the potential of the enriched and optimized cyanobacterial species containing microbial composition (e.g., that include photosynthetic microorganisms) to improve total organic carbon, total nitrogen, and OM in soil under natural conditions thereby promoting vegetation (e.g., soybean) growth. Furthermore, MGC-3 was also able to improve soil tilth suggesting the positive impact of microbial composition on the soil quality.

### Example 9. Effect of Temperature on Growth of Microbial Compositions Containing Isolated Cyanobacterial Species

A set of field trial experiments was performed to determine the effect of temperature on growth of a microbial composition containing cyanobacteria. The pigment phenotypes (as indicators of growth) are depicted in FIG. 18. The levels of Chlorophyll accumulation are depicted in FIGS. 19A-19B. The levels of exopolysaccharides are depicted in FIGS. 20A-20B.

### Materials and Methods

### Microbial Composition

In these experiments, the microbial composition can include isolated cyanobacterial species. The isolated cyanobacterial species were obtained from the University of Texas, Austin (UTEX) Culture Collection. These cyanobacterial species were screened for their growth on different soil types, and effect of different temperature and moisture content.

### Results

FIG. 18 shows the growth of these strains on soil following treatments at different temperatures followed by growth at either 30° C. or 22° C. Almost all strains showed no effect of temperature treatment at either 4° C. or 37° C. for 2 hr on a daily basis whether they were grown at either 30° C. or 22° C. as the overall growth based on pigment phenotype was similar (FIG. 18). However, temperature treatment at −20° C. for 2 hr on a daily basis was found to inhibit the growth of most strains although some strains did show some growth albeit at lower level following exposure to −20° C. (for example, without limitation, Anabaena subcylindrica and Nodularia spumigena). Also, some strains showed better growth at 22° C. (e.g., Anabaena catenula) while other strains showed better growth at 30° C. (e.g., Scytonema sp.) following temperature treatment at −20° C.

Additional results demonstrate the microbial composition was able to enrich the soil for photosynthetic microorganisms as measured by an increase in total chlorophyll accumulation (FIGS. 19A-B) and EPS accumulation (FIGS. 20A-B). In particular, FIGS. 19A-B shows that some strains such as Anabaena subcylindrica had the most impressive growth following treatment at broad temperatures (−20° C., 4° C., 37° C.) following growth at either 30° C. or 22° C. For each cyanobacterium species in FIGS. 19A-B, the bars represent from left to right temperatures: control, 4° C., −20° C., and 37° C.

On the other hand, Anabaena catenula grew at both temperatures but growth following −20° C. treatment was better at 22° C. compared to growth at 30° C. FIGS. 20A-B show that the amount of EPS produced by these isolated cyanobacterial species correlated with total chlorophyll accumulation. For each cyanobacterium species in FIGS. 20A-B, the bars represent from left to right temperatures: control, 4° C., −20° C., and 37° C.

These results demonstrate the potential for ALE using temperature to collectively optimize the functionality of all components of microbial composition for the rapid growth and adaptations to the environmental conditions on soil.

### Example 10—Metagenomic Analysis of Selected Cyanobacterial Consortia

A set of experiments was performed to determine the type of organisms present in enriched microbial consortia from the soil samples as discussed in Example 2, and Example 4. We used consortia #8, 24, 27, 67, 69, 70, 99, 106, 108, 115, 116, 118 and 123 (FIG. 8 and FIG. 9). A heat map of the 16S rRNA sequencing is depicted in FIG. 21A and the key for the heat map is depicted in FIG. 21B.

### Methods

The V3 and V4 sections of the 16S rRNA were amplified with the additions of an amplicon identifier and 16S rRNA specific primers. Analysis of metagenomic data was done using QIIME2. Briefly, noisy sequences were filtered out, errors in marginal sequences corrected, chimeric sequences and singletons removed, denoised paired-end reads were joined, and then those sequences were dereplicated. Taxa assignments was implemented using the alignment-based method vsearch against the Silva database to classify the denoised data against known sequences. Only the major organisms in the legend in FIG. 21B are shown. The key in FIG. 21B is order from top to bottom in the same manner as the species appear in FIG. 21A. For example, for consortia #123 in the far right column, the #123 consortia includes about 40% of “d__Bacteria; p__Cyanobacteria; c__Cyanobacteriia; o__Oxyphotobacteria_Incertae_Sedis; f__Un known_Family;_;_.”

### Results

FIGS. 21A-B shows 16S rRNA sequencing identified presence of heterotrophic organisms in addition to the presence of photosynthetic organism. The consortia analyzed were subcultured in a simple minimal media (Burk's medium) without any carbon and nitrogen source multiple times, and therefore, the presence of multiple organisms especially the heterotrophic organisms would suggest that they are either in an associative or symbiotic relationship with the photosynthetic organisms. In the associative relationship, the carbon fixed by photosynthetic microorganisms was being channeled for the growth and maintenance of heterotrophic organisms. Additionally, heterotrophic organisms were also contributing to the growth and maintenance of photosynthetic organisms because as noted above, the consortia were sub-cultured more than 20 times, and therefore, the various members of these consortia are stable. Not surprisingly, photosynthetic microorganisms are the dominant members of these consortia.

### Example 11. Effect of ALE Using Chemical Mutagens and Temperature on Growth of Microbial Compositions Containing Cyanobacteria

A set of experiments was performed to determine the effect of temperature on growth of a microbial composition containing cyanobacteria. The pigment phenotypes (as indicators of growth) are depicted in FIG. 22.

### Materials and Methods

### Microbial Composition

In these experiments, the microbial composition can include one or more cyanobacterial species: enriched from soil under nitrogen- and carbon-fixing conditions. These cyanobacterial species were optimized using ALE for the optimal performance on different types of soil. Chemical mutagens and temperature were used to collectively optimize the functionality of all components of microbial composition for the rapid growth and adaptations to the environmental conditions on soil. The results of ALE using both chemical mutagens and temperature are depicted in FIG. 22.

Briefly, the selected cyanobacterial cells were treated with one of the three chemical mutagens [1% ethyl methanesulfonate; 1% methyl methanesulfonate, and 25 mM N-ethyl-N-nitrosourea]; following treatments and incubation for different times (15 min to 120 min), cells were washed, combined, and inoculated on soil (marked with −20° C.*). The other two cups (control and −20° C.) contain non-treated cells. Cups containing these cells were then exposed to −20° C. for 2 hr and then returned to 30° C. for growth. On days 2, 3, and 4, one cup (marked with −20° C.*) was exposed to UV-A for 30 min.

### Results

Results demonstrate the microbial composition optimized using ALE combining both chemical mutagens and temperature was able to promote growth as indicated by the pigment phenotypes (FIG. 22).

ALE was used to obtain better growth of microbial composition containing cyanobacterial species under the targeted conditions that could be attributed to either better tolerance to these underlying conditions or to the improved robustness of these cyanobacterial single isolates and photosynthetic consortia under these conditions. Therefore, only two conditions were used (−20° C. treatment and low moisture content as conditions to obtain robust strains and/or consortia). This experiment was repeated twice and although, the treated cells still demonstrate sensitivity especially to low temperature they demonstrated better growth compared to non-adapted cells (FIG. 22). In addition, these consortia were also tolerant to limited moisture. Further, long term experiments have shown that these selected cyanobacterial consortia can be stored on dry soil for more than six months at room temperature without impacting their inability to regrow when contacted with moisture.

Additionally, these results demonstrate the potential for ALE combining chemical mutagens and temperature to collectively optimize the functionality of all components of microbial composition for the rapid growth and adaptations to the environmental conditions on soil.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A method of selective enrichment, isolation, and characterization of photosynthetic and non-photosynthetic microorganism(s) from soil or water for the specific purpose of improving the health of soil and crops, the method comprising:
(a) providing a sample comprising uncharacterized and/or uncultivated photosynthetic and non-photosynthetic microorganism(s), wherein the sample is obtained from an environmental source;
(b) providing one or more micronutrients to the soil which are selected by chemical analysis of a soil and subjecting the soil sample to grow at a controlled temperature with or without light;
(c) enriching or isolating photosynthetic and non-photosynthetic microorganism(s) having one or more of following activities;
produces one or more carbon species;
produces one or more nitrogen species;
produces one or more molecule(s) containing carbon and nitrogen;
stores phosphorous in the form of polyphosphate;
increases soil organic matter;
improves soil water-holding capacity;
demonstrates growth in different soil types with or without vegetation;
protects vegetation against plant pathogens;
protects vegetation against pests;
promotes growth of vegetation;
produces molecules having one or more of insecticidal, herbicidal, anti-fungal, weed controlling, and seed germination activity;
promotes root growth of vegetation;
reduces emission of methane and/or nitrogen oxide; and
inhibits denitrification; and
(d) subjecting the photosynthetic and non-photosynthetic microorganism(s) to 16S and 18S ribosomal RNA sequencing to identify the species of enriched microorganism(s).

2.-7. (canceled)

8. A microbial composition, comprising:
(a) one or more photosynthetic microorganism(s); and
(b) one or more agricultural adjuvant(s);
wherein the microbial composition has one or more of any of the following activities:
produces one or more carbon species;
produces one or more nitrogen species;
produces one or more molecule(s) containing carbon and nitrogen;
stores phosphorous in the form of polyphosphate;
increases soil organic matter;
improves soil water-holding capacity;
demonstrates growth in different soil types with or without vegetation;
protects vegetation against plant pathogens;
protects vegetation against pests;
promotes growth of vegetation;
produces molecules having one or more of insecticidal, herbicidal, anti-fungal, weed controlling, and seed germination activity;
promotes root growth of vegetation;
reduces emission of methane and/or nitrogen oxide; and
inhibits denitrification.

9.-11. (canceled)

12. The microbial composition of claim 8, wherein the one or more photosynthetic microorganism(s) comprises a cyanobacterium.

13. The microbial composition of claim 12, wherein the cyanobacterium is a non-nitrogen fixing cyanobacterium.

14. The microbial composition of claim 12, wherein the cyanobacterium is a nitrogen-fixing cyanobacterium.

15.-16. (canceled)

17. The microbial composition of claim 8, wherein the one or more photosynthetic microorganism(s) comprises a non-cyanobacterium photosynthetic microorganism.

18. The microbial composition of claim 17, wherein the non-cyanobacterium photosynthetic microorganism does not have nitrogen-fixing activity.

19. The microbial composition of claim 17, wherein the non-cyanobacterium photosynthetic microorganism is a nitrogen-fixing bacterium.

20. (canceled)

21. The microbial composition of claim 8, wherein the one or more photosynthetic microorganism(s) comprise a eukaryotic microorganism.

22.-23. (canceled)

24. The microbial composition of claim 8, wherein the microbial composition:
produces one or both carbon species of the group consisting of sugars, fatty acids, and organic acids;
produces one or more nitrogen species from the group consisting of nitrate, urea, ammonia, ammonium, and amine(s); and/or
produces one or more molecules containing carbon and nitrogen from the group consisting of amino acids, amino sugars, nucleobases, and sesquiterpene lactones.

25.-29. (canceled)

30. The microbial composition of claim 8, wherein the microbial composition further comprises one or more heterotrophic microorganism(s) belonging to prokaryotic and/or eukaryotic groups.

31. The microbial composition of claim 30, wherein the one or more heterotrophic microorganism(s) further comprise one or more nitrogen-fixing heterotrophic microorganism(s).

32. The microbial composition of claim 30, wherein the one or more heterotrophic microorganism(s) solubilize one or more of potassium, iron, and phosphorous when the microbial composition is exposed to conditions sufficient to solubilize one or more of potassium, iron, and phosphorous.

33. (canceled)

34. The microbial composition of claim 8, wherein the one or more photosynthetic microorganism(s) or the one or more heterotrophic microorganism(s):
produce and secrete an exopolysaccharide; and the exopolysaccharide improves water-holding capacity of soil;
produce a peptide or a chemical, and the peptide or chemical improves water-holding capacity of soil;
are tolerant to biotic/abiotic conditions; and/or
are tolerant to one or more of minerals, an herbicide, and an insecticide.

35. (canceled)

36. The microbial composition of claim 8, wherein the microbial composition:
forms soil microaggregates, wherein the soil microaggregates improve the water-holding capacity of soil;
produces organic matter;
demonstrates growth in different soil types with or without vegetation;
protects vegetation against one or more plant pathogen(s) selected from the group consisting of: fungi, fungal-like organisms, bacteria, phytoplasmas, viruses, viroids, and nematodes;
promotes growth of vegetation by the production of factors comprising phytohormones and plant growth-promoting factors;
produces one or more molecules having one or more of insecticidal, herbicidal, anti-fungal, weed controlling, and seed germination activity;
promotes root growth of vegetation through modification of rhizosphere and promoting oxygenic environment around root(s);
reduces emission of methane and/or nitrogen oxide; and/or
inhibits denitrification.

37.-49. (canceled)

50. The microbial composition of claim 8, wherein the one or more photosynthetic microorganisms:
secrete nucleobases, nucleobase derivatives, or both when exposed to analogs selected from the group consisting of 8-azaguanine, 6-azauracil, 2-diazo-5-oxo-L-norleucine, decoyinine, and 6-mercaptoguanine; and/or
secrete aspartate amino acids, branched-chain amino acids or both when exposed to one or more analogs selected from the group consisting of norleucine, S-2-aminoethyl-L-cysteine, ethionine, methyl-methionine, and hydroxynorvaline.

51.-54. (canceled)

55. The microbial composition of claim 30, wherein the one or more heterotrophic microorganism(s) include fungi.

56. (canceled)

57. The microbial composition of claim 30, wherein the one or more heterotrophic microorganism(s) comprises a methanotrophic microorganism.

58. (canceled)

59. The microbial composition of claim 8, wherein the ratio of one or more photosynthetic microorganism(s) to one or more heterotrophic microorganism(s) comprises a ratio of: 10:1, 5:1, 4:1, 3:1, 2:1, 1:1, 1:2, 1:3, 1:4, 1:5, and 1:10.

60.-78. (canceled)

79. A method of generating a microbial composition, comprising:
(a) providing a combination of one or more photosynthetic microorganism(s);
(b) determining a level of one or more activities of the combination selected from the group consisting of:
production of one or more carbon species;
production of one or more nitrogen species;
production of one or more molecule(s) containing carbon and nitrogen;
stores phosphorous in the form of polyphosphate;
production of organic matter;
soil water-holding capacity;
growth in different soil types with or without vegetation;
protection of vegetation against plant pathogens;
protection of vegetation against pests;
promotion of growth of vegetation;
production of molecules having one or more of insecticidal, herbicidal, anti-fungal, weed controlling, and seed germination activity;
promotion of root growth of vegetation;
reduces emission of methane and/or nitrogen oxide; and
inhibition of denitrification;
(c) selecting a combination having an elevated level of the one or more activities as compared to a control level(s); and
(d) producing a microbial composition comprising the selected combination and one or more agricultural excipient(s).

80.-118. (canceled)

119. The method of claim 79, wherein the method further comprises, between steps (a) and (b):
contacting the combination with a chemical mutagen.

120.-150. (canceled)

151. A method comprising:
contacting soil or a plant with a microbial composition of claim 8.

152.-153. (canceled)

154. A method of increasing a level of nitrogen species in a soil, the method comprising:
contacting the soil with a microbial composition of claim 8.

155.-156. (canceled)

157. A method of increasing a level of carbon species in a soil, the method comprising:
contacting the soil with a microbial composition of claim 8.

158.-162. (canceled)

163. A method of increasing a level of exopolysaccharides in a soil, the method comprising:
contacting the soil with a microbial composition of claim 8.

164.-165. (canceled)

166. A method of increasing a level of solubilized potassium, iron, and phosphorus in a soil, the method comprising:
contacting the soil with a microbial composition of claim 8.

167.-168. (canceled)

169. A method of increasing a level of a siderophore in a soil, the method comprising:
contacting the soil with a microbial composition of claim 8.

170.-171. (canceled)

172. A method of increasing the bioavailability of sulfur, boron, magnesium, or manganese in a soil, the method comprising:
contacting the soil with a microbial composition of claim 8.

173.-174. (canceled)

175. The method of claim 1, wherein the soil or land is selected from the group consisting of: agricultural land, farm land, recreational land, degraded land, forest land, vegetable land, landfill, mountains, fresh water, and marine water.
